(19) United States
(12) Patent Application Publication
(10) Pub. No.: US 2024/0134868 A1
(43) Pub. Date: Apr. 25, 2024

(54) Software agents correcting bias in measurements of affective response

(71) Applicant: Affectomatics Ltd., Kiryat Tivon (IL)

(72) Inventors: Ari M Frank, Haifa (IL); Gil Thieberger, Kiryat Tivon (IL)

(73) Assignee: Affectomatics Ltd., Kiryat Tivon (IL)

(21) Appl. No.: 18/395,877

(22) Filed: Dec. 26, 2023

Related U.S. Application Data
(63) Continuation-in-part of application No. 17/581,929, filed on Jan. 23, 2022, now Pat. No. 11,907,234.
Application No. 17/581,929 is a continuation of application No. 15/051,892, filed on Feb. 24, 2016, now Pat. No. 11,269,891.
Application No. 15/051,892 is a continuation-in-part of application No. 14/833,035, filed on Aug. 21, 2015, now Pat. No. 10,198,505.
Application No. 15/051,892 is a continuation-in-part of application No. 15/010,412, filed on Jan. 29, 2016, now Pat. No. 10,572,679.
(60) Provisional application No. 62/040,345, filed on Aug. 21, 2014.
(60) Provisional application No. 62/040,355, filed on Aug. 21, 2014.
(60) Provisional application No. 62/040,358, filed on Aug. 21, 2014.
(60) Provisional application No. 62/109,456, filed on Jan. 29, 2015.
(60) Provisional application No. 62/185,304, filed on Jun. 26, 2015.

(51) Int. Cl. G06F 16/2457; G06F 16/23; G06F 16/335; G06F 16/904; G06F 16/9535; G06Q 10/04; G06Q 10/067; G06Q 30/0203; G06Q 30/0282

(52) U.S. Cl. CPC G06F 16/24578; G06F 16/2358; G06F 16/24573; G06F 16/24575; G06F 16/337; G06F 16/904; G06F 16/9535; G06Q 10/04; G06Q 10/067; G06Q 30/0203; G06Q 30/0282

(57) ABSTRACT

Software agents that correct biases in measurements of affective response. In one embodiment, a sensor takes a measurement of affective response of a user, where the measurement corresponds to an event in which the user has an experience. A computer generates a description of the event that includes factors characterizing the event which correspond to at least one of the following: the user, the experience, and the instantiation of the event. The computer identifies, based on the description, a certain factor characterizes the event, and computes a corrected measurement, which is different from the measurement taken by the sensor. The corrected measurement is computed by modifying the sensor values utilizing a model trained on data comprising: measurements of affective response of the user corresponding to events involving the user having various experiences, and descriptions of the events.

### CROSS-REFERENCE TO RELATED APPLICATIONS

This application is a Continuation-In-Part of U.S. application Ser. No. 17/581,929 filed on Jan. 23, 2022, which is a Continuation of U.S. application Ser. No. 15/051,892 filed on Feb. 24, 2016, now U.S. Pat. No. 11,269,891, which is a Continuation-In-Part of U.S. application Ser. No. 14/833,035, filed Aug. 21, 2015, now U.S. Pat. No. 10,198,505, which claims the benefit of U.S. Provisional Patent Application Ser. No. 62/040,345, filed on Aug. 21, 2014, and U.S. Provisional Patent Application Ser. No. 62/040,355, filed on Aug. 21, 2014, and U.S. Provisional Patent Application Ser. No. 62/040,358, filed on Aug. 21, 2014. U.S. application Ser. No. 15/051,892 is also a Continuation-In-Part of U.S. application Ser. No. 15/010,412, filed Jan. 29, 2016, now U.S. Pat. No. 10,572,679, which claims the benefit of U.S. Provisional Patent Application Ser. No. 62/109,456, filed on Jan. 29, 2015, and U.S. Provisional Patent Application Ser. No. 62/185,304, filed on Jun. 26, 2015.

### BACKGROUND

The accurate measurement of affective response is a cornerstone in understanding user engagement and satisfaction across myriad industries such as entertainment, advertising, and consumer product development. Affective response encompasses the emotional reactions of individuals to various stimuli or experiences, and is typically gauged through an array of indicators including physiological signals, behavioral cues, and self-reported emotional assessments. However, the reliability of such measurements is frequently compromised by the presence of biases, which can significantly distort the interpretation of an individual's true emotional experience.

Biases may arise from a multitude of sources. They can be deeply rooted in personal user characteristics, such as mood, physical state, or cultural background, which affect the individual's interaction with and perception of an event. The experience itself—its setting, nature, and other intrinsic attributes—can also introduce biases. For example, the affective response to a piece of music may be influenced not only by one's taste but also by the context in which the music is heard, such as in a crowded venue or a private setting.

While various factors used to describe an event, such as duration, location, or content type, are typically objective and can be consistently described and measured, biases reflecting an individual's reaction to these factors are subjective and vary widely between users. This variability underscores the importance of distinguishing between the objective nature of events and the subjective biases that affect individual responses to these events.

The presence of biases in measurements of affective response can present a significant obstacle in the aggregation and interpretation of data, particularly when constructing crowd-based scores intended to reflect a collective experience. Without accounting for individual biases, the aggregated data can lead to erroneous conclusions about the quality or appeal of an experience, reflecting the biases of the respondents rather than the intrinsic value of the experience itself.

Recognizing the impact of biases on measurements of affective response can therefore be vital for ensuring the integrity of user experience evaluations. The challenge lies in both identifying the myriad biases that can influence measurements and developing methods to isolate and remove these biases to attain a more accurate representation of a user's emotional reaction.

The need for a solution to this problem is clear: biases, if unchecked, undermine the validity of affective response data and can lead to misguided decisions based on flawed interpretations of user sentiment. Addressing this issue is crucial for researchers, product developers, and marketers alike, who rely on accurate user feedback to refine and enhance user experiences. The development of a robust framework for detecting and correcting biases in affective response measurements is thus a pressing and unmet need in the field of user experience evaluation.

### SUMMARY

Some aspects of this disclosure involve a framework in which software agents are used to collect measurements of affective response of users and correct biases in the measurements These measurements may be collected throughout the day while the users have various experiences, and may optionally be used to calculate crowd-based scores for the experiences. Rather than have the measurements include biases that may affect scores and/or decisions made based on them, embodiments described herein include novel ways in which the biases may be corrected.

One aspect of this disclosure involves a system for operating a software agent to correct a bias in a measurement of affective response of a user. The system includes a sensor, coupled to the user, that takes the measurement of affective response of the user; the measurement corresponds to an event in which the user has an experience corresponding to the event. The system also includes a computer, which generates a description of the event, which comprises factors characterizing the event which correspond to at least one of the following: the user corresponding to the event, the experience corresponding to the event, and the instantiation of the event. The computer identifies, based on the description, whether a certain factor characterizes the event. Optionally, the computer receives an indication of the certain factor from an external source. The computer computes a corrected measurement by modifying the value of the measurement based on at least some values in a model that was trained on data comprising: measurements of affective response of the user corresponding to events involving the user having various experiences, and descriptions of the events; wherein the value of the corrected measurement is different from the value of the measurement. Optionally, the computer forwards the corrected measurement, to be utilized, along with measurements of other users, to compute a score for the experience.

Another aspect of this disclosure involves a methods for operating a software to correct a bias in a measurement of affective response of a user. In one embodiment, the method includes at least the following steps: receiving the measurement of affective response of the user; wherein the measurement corresponds to an event in which the user has an experience corresponding to the event; generating a description of the event; wherein the description comprises factors characterizing the event which correspond to at least one of the following: the user corresponding to the event, the experience corresponding to the event, and the instantiation of the event; identifying, based on the description, whether a certain factor characterizes the event; and computing a corrected measurement by modifying the value of the measurement based on at least some values in a model that was trained on data comprising: measurements of affective response of the user corresponding to events involving the user having various experiences, and descriptions of the events. Optionally, the value of the corrected measurement is different from the value of the measurement.

Yet another aspect of this disclosure involves a computer-readable medium that stores instructions for implementing the method described above. Optionally, the computer-readable medium is a non-transitory computer-readable medium. In response to execution by a system including a processor and memory, the instructions cause the system to perform operations that are part of the method.

Some aspects of embodiments described in this disclosure involve systems, methods, and/or computer-readable media that enable computation of various types of crowd-based results regarding experiences users may have in their day-to-day life. Some of the types of results that may be generated by embodiments described herein include scores for experiences, rankings of experiences, alerts based on scores for experiences, and various functions that describe how affective response to an experience is expected to change with respect to various parameters (e.g., the duration of an experience, the period in which one has the experience, the environment in which one has the experience, and more).

### BRIEF DESCRIPTION OF THE DRAWINGS

The embodiments are herein described, by way of example only, with reference to the accompanying drawings. In the drawings:

FIG. 1 illustrates a system that includes sensors and user interfaces that may be utilized to compute and report a score for a location;

FIG. 2 illustrates a system configured to compute location scores;

FIG. 3 illustrates a system architecture that includes sensors and user interfaces that may be utilized to compute and report a comfort score for a certain type of vehicle;

FIG. 4 illustrates a system configured to compute scores for experiences involving traveling in vehicles of a certain type based on measurements of affective response of travelers;

FIG. 5 illustrates a system architecture that includes sensors and user interfaces that may be utilized to compute and report a satisfaction score for a certain type of electronic device;

FIG. 6 illustrates a system configured to compute a satisfaction score for a certain type of electronic device based on measurements of affective response of users;

FIG. 7 illustrates a system that includes sensors and user interfaces that may be utilized to compute and report a comfort score for a certain type of apparel item;

FIG. 8 illustrates a system configured to compute scores for experiences involving wearing apparel items of a certain type;

FIG. 9 illustrates an example of an architecture that includes sensors and user interfaces that may be utilized to compute and report crowd-based results;

FIG. 10A illustrates a user and a sensor;

FIG. 10B illustrates a user and a user interface;

FIG. 10C illustrates a user, a sensor, and a user interface;

FIG. 11 illustrates a system configured to compute scores for experiences;

FIG. 12 illustrates one embodiment of the Emotional State Estimator (ESE);

FIG. 13 illustrates one embodiment of a baseline normalizer;

FIG. 14A illustrates one embodiment of a scoring module that utilizes a statistical test module and personalized models to compute a score for an experience;

FIG. 14B illustrates one embodiment of a scoring module that utilizes a statistical test module and general models to compute a score for an experience;

FIG. 14C illustrates one embodiment in which a scoring module utilizes an arithmetic scorer in order to compute a score for an experience;

FIG. 15 illustrates a system configured to utilize comparison of profiles of users to compute personalized scores for an experience based on measurements of affective response of the users;

FIG. 16 illustrates a system configured to utilize clustering of profiles of users to compute personalized scores for an experience based on measurements of affective response of the users;

FIG. 17 illustrates a system configured to alert about affective response to an experience;

FIG. 18 illustrates a system configured to rank experiences based on measurements of affective response of users;

FIG. 19 illustrates a system configured to rank experiences using scores computed for the experiences based on measurements of affective response;

FIG. 20 illustrates a system configured to rank experiences using preference rankings determined based on measurements of affective response;

FIG. 21 illustrates one embodiment in which a machine learning-based trainer is utilized to learn a function representing an expected affective response (y) that depends on a numerical value (x);

FIG. 22 illustrates one embodiment in which a binning approach is utilized for learning function parameters;

FIG. 23 illustrates a system configured to learn a function of an aftereffect of an experience;

FIG. 24 illustrates a system configured to learn a bias model based on measurements of affective response;

FIG. 25 illustrates a system that utilizes a bias value learner to learn bias values;

FIG. 26 illustrates a system that utilizes an Emotional Response Predictor trainer (ERP trainer) to learn an ERP model;

FIG. 27 a system configured to learn a bias model involving biases of multiple users;

FIG. 28 illustrates a system configured to correct a bias in a measurement of affective response of a user using a bias value;

FIG. 29 illustrates a system configured to correct a bias in a measurement of affective response of a user using an ERP;

FIG. 30 illustrates a system in which a software agent is involved in correcting a bias in a measurement of affective response of a user;

FIG. 31 illustrates a system configured to correct a bias towards an environment in which a user has an experience;

FIG. 32 illustrates a system configured to correct a bias towards a companion to an experience;

FIG. 33 illustrates a system configured to correct a bias of a user towards a characteristic of a service provider;

FIG. 34 illustrates a system configured to compute a crowd-based result based on measurements of affective response that are corrected with respect to a bias; and

FIG. 35 illustrates a computer system architecture that may be utilized in various embodiments in this disclosure.

### DETAILED DESCRIPTION

A measurement of affective response of a user is obtained by measuring a physiological signal of the user and/or a behavioral cue of the user. A measurement of affective response may include one or more raw values and/or processed values (e.g., resulting from filtration, calibration, and/or feature extraction). Measuring affective response may be done utilizing various existing, and/or yet to be invented, measurement devices such as sensors. Optionally, any device that takes a measurement of a physiological signal of a user and/or of a behavioral cue of a user may be considered a sensor. A sensor may be coupled to the body of a user in various ways. For example, a sensor may be a device that is implanted in the user's body, attached to the user's body, embedded in an item carried and/or worn by the user (e.g., a sensor may be embedded in a smartphone, smartwatch, and/or clothing), and/or remote from the user (e.g., a camera taking images of the user). Additional information regarding sensors may be found in this disclosure at least in section 5—Sensors.

Herein, “affect” and “affective response” refer to physiological and/or behavioral manifestation of an entity's emotional state. The manifestation of an entity's emotional state may be referred to herein as an “emotional response”, and may be used interchangeably with the term “affective response”. Affective response typically refers to values obtained from measurements and/or observations of an entity, while emotional states are typically predicted from models and/or reported by the entity feeling the emotions. For example, according to how terms are typically used herein, one might say that a person's emotional state may be determined based on measurements of the person's affective response. In addition, the terms “state” and “response”, when used in phrases such as “emotional state” or “emotional response”, may be used herein interchangeably. However, in the way the terms are typically used, the term “state” is used to designate a condition which a user is in, and the term “response” is used to describe an expression of the user due to the condition the user is in and/or due to a change in the condition the user is in.

It is to be noted that as used herein in this disclosure, a “measurement of affective response” may comprise one or more values describing a physiological signal and/or behavioral cue of a user which were obtained utilizing a sensor. Optionally, this data may be also referred to as a “raw” measurement of affective response. Thus, for example, a measurement of affective response may be represented by any type of value returned by a sensor, such as a heart rate, a brainwave pattern, an image of a facial expression, etc.

Additionally, as used herein, a “measurement of affective response” may refer to a product of processing of the one or more values describing a physiological signal and/or behavioral cue of a user (i.e., a product of the processing of the raw measurements data). The processing of the one or more values may involve one or more of the following operations: normalization, filtering, feature extraction, image processing, compression, encryption, and/or any other techniques described further in the disclosure and/or that are known in the art and may be applied to measurement data. Optionally, a measurement of affective response may be a value that describes an extent and/or quality of an affective response (e.g., a value indicating positive or negative affective response such as a level of happiness on a scale of 1 to 10, and/or any other value that may be derived from processing of the one or more values).

It is to be noted that since both raw data and processed data may be considered measurements of affective response, it is possible to derive a measurement of affective response (e.g., a result of processing raw measurement data) from another measurement of affective response (e.g., a raw value obtained from a sensor). Similarly, in some embodiments, a measurement of affective response may be derived from multiple measurements of affective response. For example, the measurement may be a result of processing of the multiple measurements.

In some embodiments, a measurement of affective response may be referred to as an “affective value” which, as used in this disclosure, is a value generated utilizing a module, function, estimator, and/or predictor based on an input comprising the one or more values describing a physiological signal and/or behavioral cue of a user, which are in either a raw or processed form, as described above. As such, in some embodiments, an affective value may be a value representing one or more measurements of affective response. Optionally, an affective value represents multiple measurements of affective response of a user taken over a period of time. An affective value may represent how the user felt while utilizing a product (e.g., based on multiple measurements taken over a period of an hour while using the product), or how the user felt during a vacation (e.g., the affective value is based on multiple measurements of affective response of the user taken over a week-long period during which the user was on the vacation).

In some embodiments, measurements of affective response of a user are primarily unsolicited, i.e., the user is not explicitly requested to initiate and/or participate in the process of measuring. Thus, measurements of affective response of a user may be considered passive in the sense that it is possible that the user will not be notified when the measurements are taken, and/or the user may not be aware that measurements are being taken. Additional discussion regarding measurements of affective response and affective values may be found in this disclosure at least in section 6—Measurements of Affective Response.

Embodiments described herein may involve computing values based on measurements of affective response of users, which are referred to as “crowd-based” results. One example of a crowd-based result is a score for an experience, which is a representative value from a plurality of measurements of affective response of one or more users who had the experience. Such a value may be referred to herein as “a score for an experience”, an “experience score”, or simply a “score” for short.

In some embodiments described herein, the experience may be related to one or more locations. For example, the experience involves being at a certain location and the measurements are taken while the users are at the certain location (or shortly after that). For example, a score indicative of the quality of a stay at a hotel may be computed based on measurements of affective response of guests taken while they stayed at the hotel.

When a score is computed for a certain user or a certain group of users, such that different users or different groups of users may receive scores with different values, the score may be referred to as a “personalized score”, “personal score”, and the like. In a similar fashion, in some embodiments, experiences and/or locations corresponding to the experiences, may be ranked and/or compared based on a plurality of measurements of affective response of users who had the experiences. A form of comparison of experiences, such as an ordering of experiences (or a partial ordering of the experiences), may be referred to herein as a “ranking” of the experiences. Optionally, when a ranking is computed for a certain user or a certain group of users, such that different users or different groups of users may receive different rankings, the ranking be referred to as a “personalized ranking”, “personal ranking”, and the like.

Additionally, a score and/or ranking computed based on measurements of affective response that involve a certain type of experience may be referred to based on the type of experience. For example, a score for a location may be referred to as a “location score”, a ranking of hotels may be referred to as a “hotel ranking”, etc. Also when the score, ranking, and/or function parameters that are computed based on measurements refer to a certain type of affective response, the score, ranking, and/or function parameters may be referred to according to the type of affective response. For example, a score may be referred to as a “satisfaction score” or “comfort score”. In another example, a function that describes satisfaction from a vacation may be referred to as “a satisfaction function” or “satisfaction curve”.

Herein, when it is stated that a score, ranking, and/or function parameters are computed based on measurements of affective response, it means that the score, ranking, and/or function parameters have their value set based on the measurements and possibly other measurements of affective response and/or other types of data. For example, a score computed based on a measurement of affective response may also be computed based on other data that is used to set the value of the score (e.g., a manual rating, data derived from semantic analysis of a communication, and/or a demographic statistic of a user). Additionally, computing the score may be based on a value computed from a previous measurement of the user (e.g., a baseline affective response value described further below).

Some of the experiences described in this disclosure involve something that happens to a user and/or that the user does, which may affect the physiological and/or emotional state of the user in a manner that may be detected by measuring the affective response of the user. In particular, some of the experiences described in this disclosure involve being in a location. Additional types of experiences and characteristics of experiences are described in further detail at least in section 7—Experiences.

In some embodiments, an experience is something a user actively chooses and is aware of; for example, the user chooses to take a vacation. While in other embodiments, an experience may be something that happens to the user, of which the user may not be aware. A user may have the same experience multiple times during different periods. For example, the experience of being at school may happen to certain users every weekday except for holidays. Each time a user has an experience, this may be considered an “event”. Each event has a corresponding experience and a corresponding user (who had the corresponding experience). Additionally, an event may be referred to as being an “instantiation” of an experience and the time during which an instantiation of an event takes place may be referred to herein as the “instantiation period” of the event. That is, the instantiation period of an event is the period of time during which the user corresponding to the event had the experience corresponding to the event. Optionally, an event may have a corresponding measurement of affective response, which is a measurement of the corresponding user to having the corresponding experience (during the instantiation of the event or shortly after it). For example, a measurement of affective response of a user that corresponds to an experience of being at a location may be taken while the user is at the location and/or shortly after that time. Further details regarding experiences and events may be found at least in sections 8—Events and 9—Identifying Events.

### 1—Crowd-Based Results for Locations

Various embodiments described herein involve experiences in which a user is in a location. Herein, a discussion regarding experiences in general, e.g., scoring experiences, ranking experiences, and/or taking measurements of affective to experiences, is also applicable to certain types of experiences, such as experiences involving locations.

In some embodiments, a location may refer to a place in the physical world. A location in the physical world may occupy various areas in, and/or volumes of, the physical world. In one example, a location is a travel destination (e.g., New York). Other examples of locations that are travel destinations may include one or more of the following: continents, countries, counties, cities, resorts, neighborhoods, hotels, nature reserves, and parks. In another example, a location may be an entertainment establishment that is one or more of the following: a club, a pub, a movie theater, a theater, a casino, a stadium, and a certain concert venue. In yet another example, a location may be a place of business that is one or more of the following: a store, a booth, a shopping mall, a shopping center, a market, a supermarket, a beauty salon, a spa, a hospital, a clinic, a laundromat, a bank, a courier service office, and a restaurant.

In other embodiments, a location may refer to a virtual environment such as a virtual world and/or a virtual store (e.g., an online retailer), with at least one instantiation of the virtual environment stored in a memory of a computer. Optionally, a user is considered to be in the virtual environment by virtue of having a value stored in the memory indicating a presence of a representation of the user in the virtual environment. Optionally, different locations in virtual environment correspond to different logical spaces in the virtual environment. For example, different rooms in an inn in a virtual world may be considered different locations. In another example, different continents in a virtual world may be considered different locations. In yet another example, different sections of a virtual store and/or different stores in a virtual mall may be considered different locations.

Various embodiments described herein utilize systems whose architecture includes a plurality of sensors and a plurality of user interfaces. This architecture supports various forms of crowd-based recommendation systems in which users may receive information, such as suggestions and/or alerts, which are determined based on measurements of affective response to experiences involving locations. In some embodiments, being crowd-based means that the measurements of affective response are taken from a plurality of users, such as at least three, ten, one hundred, or more users. In such embodiments, it is possible that the recipients of information generated from the measurements may not be the same users from whom the measurements were taken.

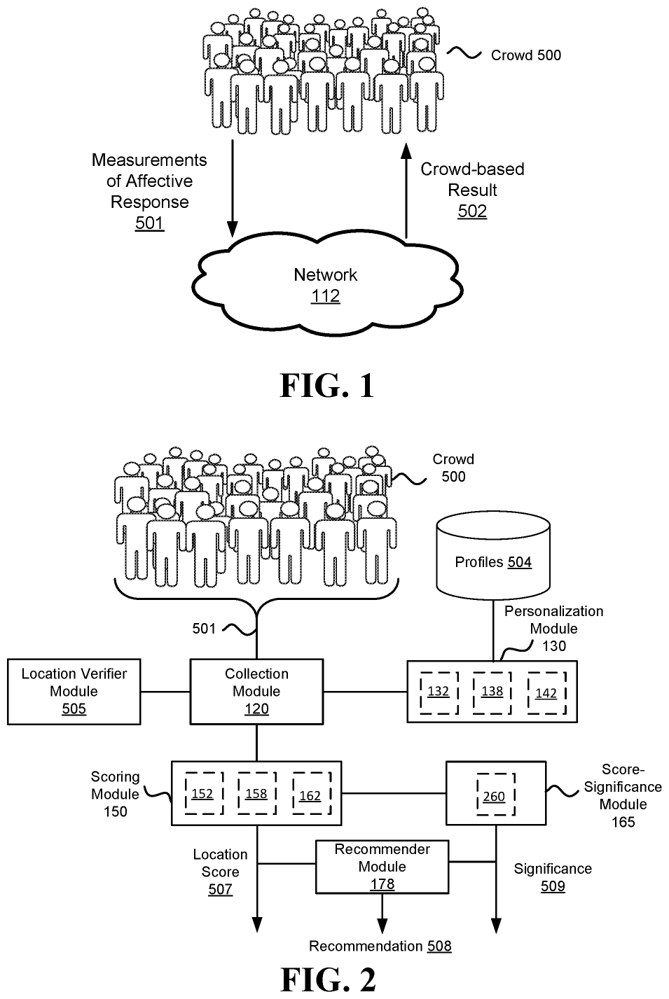

FIG. 1 illustrates a system architecture that includes sensors and user interfaces, as described above. The architecture illustrates systems in which measurements 501 of affective response of a crowd 500 of users at one or more locations may be utilized to generate crowd-based result 502.

A plurality of sensors may be used, in various embodiments described herein, to take the measurements 501 of affective response of users belonging to the crowd 500. Each sensor of the plurality of sensors may be a sensor that captures a physiological signal and/or a behavioral cue of a user. Additional details about the sensors may be found in this disclosure at least in section 5—Sensors.

In one embodiment, the measurements 501 of affective response are transmitted via a network 112. Optionally, the measurements 501 are sent to one or more servers that host modules belonging to one or more of the systems described in various embodiments in this disclosure (e.g., systems that compute scores for experiences, rank experiences, generate alerts for experiences, and/or learn parameters of functions that describe affective response).

Depending on the embodiment being considered, the crowd-based result 502 may be one or more of various types of values that may be computed by systems described in this disclosure based on measurements of affective response. For example, the crowd-based result 502 may refer to a score for a location (e.g., location score 507), a notification about affective response to location (e.g., various alerts described herein), a recommendations regarding a location, and/or a rankings of locations (e.g., ranking 580). Additionally or alternatively, the crowd-based result 502 may include, and/or be derived from, parameters of various functions learned from measurements (e.g., function parameters and/or aftereffect scores).

Additionally, it is to be noted that all location scores and various types of location scores mentioned in this disclosure (e.g., hotel scores, seat scores, restaurant scores, etc.) are types of scores for experiences. Thus various properties of scores for experiences described in this disclosure (e.g., in sections 7—Experiences and 14—Scoring) are applicable to the various types of location scores discussed herein.

FIG. 2 illustrates a system configured to compute scores for experiences involving locations, which may also be referred to herein as “location scores”. The system that computes a location score includes at least a collection module (e.g., collection module 120) and a scoring module (e.g., scoring module 150). Optionally, such a system may also include additional modules such as the personalization module 130, score-significance module 165, location verifier module 505, map-displaying module 240, and/or recommender module 178. The illustrated system includes modules that may optionally be found in other embodiments described in this disclosure. This system, like other systems described in this disclosure, includes at least a memory 402 and a processor 401. The memory 402 stores computer executable modules described below, and the processor 401 executes the computer executable modules stored in the memory 402.

In some embodiments, the collection module 120 is configured to receive the measurements 501. Optionally, the measurements 501 comprise measurements of at least ten users who were at a certain location.

In one embodiment, the measurements of the at least ten users are taken in temporal proximity to when the at least ten users were in the certain location and represent an affective response of those users to being in the certain location. Herein “temporal proximity” means nearness in time. For example, at least some of the measurements 501 are taken while users are in the certain location and/or shortly after being there. Additional discussion of what constitutes “temporal proximity” may be found at least in section 6—Measurements of Affective Response.

It is to be noted that references to the “certain location” with respect to FIG. 2 and/or the modules described therein may refer to any type of location described in this disclosure (in the physical world and/or a virtual location). Some examples of locations are illustrated in FIG. 1.

In some embodiments, each measurement from among the measurements 501 is a measurement of affective response of a user, taken utilizing a sensor coupled to the user, and comprises at least one of the following: a value representing a physiological signal of the user and a value representing a behavioral cue of the user. Optionally, a measurement of affective response, which corresponds to an event involving being at the certain location and/or having an experience at the certain location, is based on values acquired by measuring the user corresponding to the event with the sensor during at least three different non-overlapping periods while the user was at the location corresponding to the event.

In some embodiments, the system may optionally include the location verifier module 505, which is configured to determine when the user is in the location. Optionally, a measurement of affective response of a user, from among the at least ten users, is based on values obtained during periods for which the location verifier module 505 indicated that the user was at the certain location. Optionally, the location verifier module 505 may receive indications regarding the location of the user from devices carried by the user (e.g., a wearable electronic device), from a software agent operating on behalf of the user, and/or from a third party (e.g., a party which monitors the user).

The collection module 120 is also configured, in some embodiments, to forward at least some of the measurements 501 to the scoring module 150. Optionally, at least some of the measurements 501 undergo processing before they are received by the scoring module 150. Optionally, at least some of the processing is performed via programs that may be considered software agents operating on behalf of the users who provided the measurements 501. Additional information regarding the collection module 120 may be found in this disclosure at least in section 12—Crowd-Based Applications and 13—Collecting Measurements. It is to be noted that these sections, and other portions of this disclosure, describe measurements 110 of affective response to experiences (in general). The measurements 501, which are measurements of affective response involving experiences involving being in locations, may be considered a subset of the measurements 110. Thus, the teachings regarding the measurements 110 are also applicable to the measurements 501. In particular, the measurements 501 may be provided to baseline normalizer 124 and for normalization with respect to a baseline. Additionally or alternatively, the measurements 501 may be provided to Emotional State Estimator (ESE) 121, for example, in order to compute an affective value representing an emotional state of a user based on a measurement of affective response of the user.

In addition to the measurements 501, in some embodiments, the scoring module 150 may receive weights for the measurements 501 of affective response and to utilize the weights to compute the location score 507. Optionally, the weights for the measurements 501 are not all the same, such that the weights comprise first and second weights for first and second measurements from among the measurements 501 and the first weight is different from the second weight. Weighting measurements may be done for various reasons, such as normalizing the contribution of various users, computing personalized scores, and/or normalizing measurements based on the time they were taken, as described elsewhere in this disclosure.

In one embodiment, the scoring module 150 is configured to receive the measurements of affective response of the at least ten users. The scoring module 150 is also configured to compute, based on the measurements of affective response of the at least ten users, a location score 507 that represents an affective response of the users to being at the certain location and/or to having an experience at the certain location.

A scoring module, such as scoring module 150, may utilize one or more types of scoring approaches that may optionally involve one more other modules. In one example, the scoring module 150 utilizes modules that perform statistical tests on measurements in order to compute the location score 507, such as statistical test module 152 and/or statistical test module 158. In another example, the scoring module 150 utilizes arithmetic scorer 162 to compute the location score 507. Additional information regarding how the location score 507 may be computed may be found in this disclosure at least in sections 12—Crowd-Based Applications and 14—Scoring. It is to be noted that these sections, and other portions of this disclosure, describe scores for experiences (in general) such as score 164. The score 507, which is a score for an experience that involves being at a location, may be considered a specific example of the score 164. Thus, the teachings regarding the score 164 are also applicable to the score 164.

A location score, such as the location score 507, may include and/or represent various types of values. In one example, the location score comprises a value representing a quality of the location to which the location score corresponds. In another example, the location score 507 comprises a value that is at least one of the following types: a physiological signal, a behavioral cue, an emotional state, and an affective value. Optionally, the location score comprises a value that is a function of measurements of at least ten users.

In one embodiment, a location score, such as the location score 507, may be indicative of significance of a hypothesis that users who contributed measurements of affective response to the computation of the location score had a certain affective response. Optionally, experiencing the certain affective response causes changes to values of at least one of measurements of physiological signals and measurements of behavioral cues, and wherein the changes to values correspond to an increase, of at least a certain extent, in a level of at least one of the following emotions: pain, anxiety, annoyance, stress, aggression, aggravation, fear, sadness, drowsiness, apathy, anger, happiness, contentment, calmness, attentiveness, affection, and excitement. Optionally, detecting the increase, of at least the certain extent, in the level of at least one of the emotions is done utilizing an ESE.

### 2—Crowd-Based Results for Vehicles

Many people spend a lot of time traveling in vehicles. Different vehicles may provide different traveling experiences. For example, some vehicles may be more comfortable than others, better suited for long trips than others, etc. The large number of available types of vehicles to choose from often makes it difficult to make an appropriate choice of vehicle. Thus, it may be desirable to be able to assess various types of vehicles in order to be able to determine what type to choose.

Various embodiments described herein utilize systems whose architecture includes a plurality of sensors and a plurality of user interfaces. This architecture supports various forms of crowd-based recommendation systems in which users may receive information, such as suggestions and/or alerts, which are determined based on measurements of affective response of travelers traveling in vehicles. In some embodiments, being crowd-based means that the measurements of affective response are taken from a plurality of travelers, such as at least three, ten, one hundred, or more travelers. In such embodiments, it is possible that the recipients of information generated from the measurements may not be the same people from whom the measurements were taken.

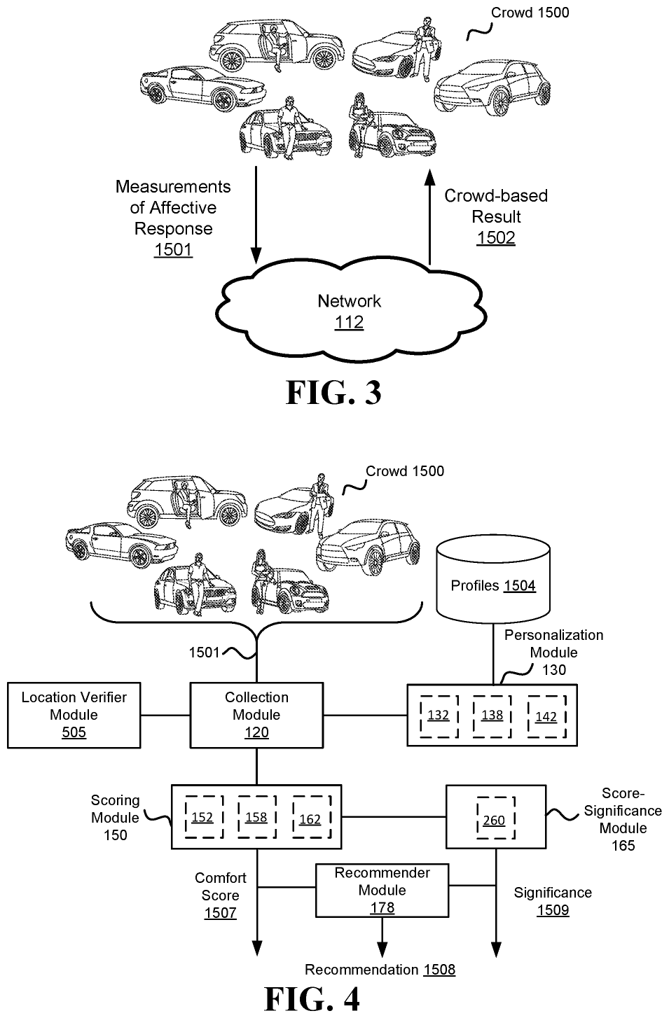

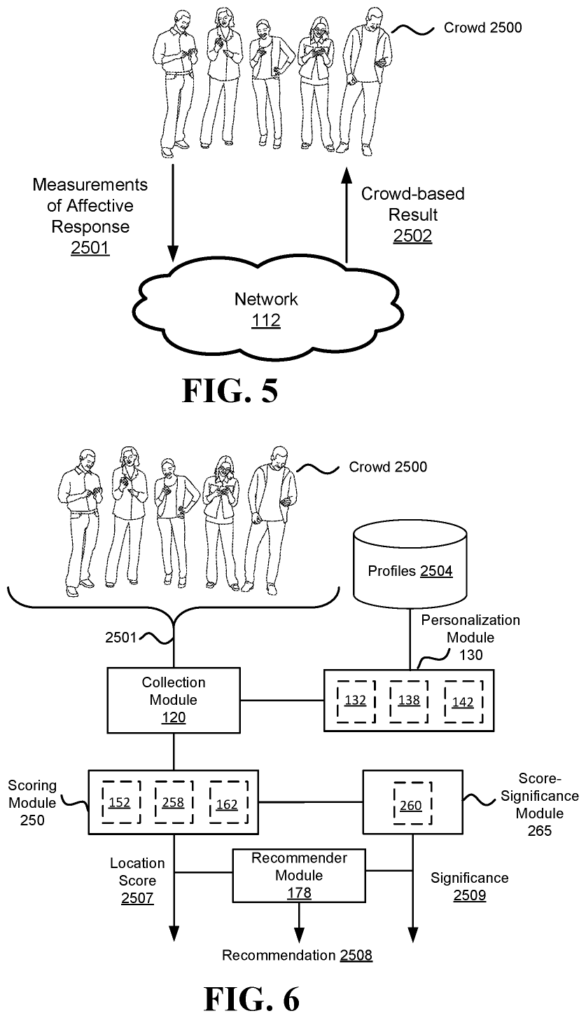

FIG. 3 illustrates a system architecture that includes sensors and user interfaces, as described above. The architecture illustrates systems in which measurements 1501 of affective response of a crowd 1500 of travelers traveling in one or more vehicles may be utilized to generate crowd-based result 1502.

It is to be noted that as used herein, a “traveler” is a user who travels in a vehicle. For example, a traveler may be a passenger and/or driver of a vehicle. Traveling in a vehicle, involves the vehicle transporting the traveler from one place to another. For example, a traveler may travel in a vehicle in order to get from one city to another city. Herein, a traveler may also be referred to herein as a “user” and these terms may be used interchangeably when an experience a user has involves traveling in a vehicle. Furthermore, various properties of users discussed in this disclosure (including how they may be measured using sensors) are applicable to users who are referred to herein as “travelers”. It is to be noted that the reference numeral 1500 is used to refer to a crowd of travelers, which are users who have a certain type of experience which involves traveling in a vehicle. Thus, the crowd 1500 may be considered to be a subset of the more general crowd 100, which refers to users having experiences in general (which include vehicle-related experiences).

A plurality of sensors may be used, in various embodiments described herein, to take the measurements 1501 of affective response of travelers belonging to the crowd 1500. Optionally, each measurement of a traveler is taken with a sensor coupled to the traveler, while the traveler travels in a vehicle. Optionally, each measurement of affective response of a traveler represents an affective response of the traveler to traveling in the vehicle. Each sensor of the plurality of sensors may be a sensor that captures a physiological signal and/or a behavioral cue of a user.

In some embodiments, the measurements 1501 of affective response may be transmitted via a network 112. Optionally, the measurements 1501 are sent to one or more servers that host modules belonging to one or more of the systems described in various embodiments in this disclosure (e.g., systems that compute scores for experiences, rank experiences, generate alerts for experiences, and/or learn parameters of functions that describe affective response).

Depending on the embodiment being considered, the crowd-based result 1502 may be one or more of various types of values that may be computed by systems described in this disclosure based on measurements of affective response of travelers in vehicles. For example, the crowd-based result 1502 may refer to a comfort score for a certain type of vehicle (e.g., comfort score 1507), a recommendation regarding vehicles, and/or a ranking of types of vehicles (e.g., ranking 1580). Additionally or alternatively, the crowd-based result 1502 may include, and/or be derived from, parameters of various functions learned from measurements (e.g., function parameters and/or aftereffect scores).

As used herein, the term “vehicle” may refer to a thing that is used to transport people and/or cargo between different locations in the physical world. Some non-limiting examples of vehicles include: cars, motorbikes, scooters, bicycles, buses, trains, airplanes, helicopters, and sub-orbital spacecraft

FIG. 4 illustrates a system configured to compute scores for experiences involving traveling in vehicles of a certain type, which may also be referred to herein as “comfort scores”. The system that computes a comfort score includes at least a collection module (e.g., collection module 120) and a scoring module (e.g., the scoring module 150 or the aftereffect scoring module 302). Optionally, such a system may also include additional modules such as the personalization module 130, score-significance module 165, location verifier module 505, and/or recommender module 178. The illustrated system includes modules that may optionally be found in other embodiments described in this disclosure. This system, like other systems described in this disclosure, includes at least a memory 402 and a processor 401. The memory 402 stores computer executable modules described below, and the processor 401 executes the computer executable modules stored in the memory 402.

In one embodiment, the collection module 120 is configured to receive the measurements 1501, which in this embodiment include measurements of at least ten travelers. Optionally, each measurement of a traveler is taken with a sensor coupled to the traveler, while the traveler travels in a vehicle of the certain type.

In some embodiments, the system may optionally include location verifier module 505, which is configured to determine when a traveler is in a vehicle and/or traveling in the vehicle. Optionally, a measurement of affective response of a traveler, from among the at least ten travelers, is based on values obtained during periods for which the location verifier module 505 indicated that the traveler was in the vehicle and/or traveling in the vehicle. Optionally, the location verifier module 505 may receive indications regarding the location of the traveler from devices carried by the traveler (e.g., a wearable electronic device), from a software agent operating on behalf of the traveler, and/or from a third party (e.g., a party which monitors the traveler).

The collection module 120 is also configured, in some embodiments, to forward at least some of the measurements 1501 to the scoring module 150. Optionally, at least some of the measurements 1501 undergo processing before they are received by the scoring module 150. Optionally, at least some of the processing is performed via programs that may be considered software agents operating on behalf of the travelers who provided the measurements 1501.

In one embodiment, the scoring module 150 is configured to receive the measurements of affective response of the at least ten travelers. The scoring module 150 is also configured to compute, based on the measurements of affective response of the at least ten travelers, a comfort score 1507 that represents an affective response of the travelers to traveling in the vehicle of the certain type.

A scoring module, such as scoring module 150, may utilize one or more types of scoring approaches that may optionally involve one more other modules. In one example, the scoring module 150 utilizes modules that perform statistical tests on measurements in order to compute the comfort score 1507, such as statistical test module 152 and/or statistical test module 158. In another example, the scoring module 150 utilizes arithmetic scorer 162 to compute the comfort score 1507. It is to be noted that these sections, and other portions of this disclosure, describe scores for experiences (in general) such as score 164. The comfort score 1507, which is a score for an experience that involves traveling in a vehicle, may be considered a specific example of the score 164.

A person's comfort can sometimes be detected via a rapid change in affective response due to a change in circumstances. For example, when a person leaves a cramped space (such as small vehicle), and goes out to the open, the extra room can trigger a positive change in the person's affective response. For example, people on long trips often stop to stretch their legs. A large difference between the affective response while in the vehicle and the affective response measured upon exiting the vehicle may be indicative of the fact that the vehicle may be uncomfortable. This change may be considered a certain type of reaction to exiting the vehicle, which may be referred to herein as an “exit effect”. Computing a score based on an “exit effect” may be done in a similar fashion to computation of a comfort scores in embodiments related to FIG. 4, with some differences as described below.

In some embodiments, a comfort score for a certain type of vehicle is computed utilizing the “exit effect”, the collection module 120 is configured to receive contemporaneous and subsequent measurements of affective response of at least ten travelers taken with sensors coupled to the travelers. Each of the at least ten travelers traveled in a vehicle of the certain type for at least five minutes before exiting the vehicle. A contemporaneous measurement of a traveler is taken while the traveler is traveling in the vehicle, and a subsequent measurement of the traveler is taken during at least one of the following periods: while the traveler exits vehicle, and at most three minutes after the traveler got out of the vehicle. Optionally, the subsequent measurement is taken at most three minutes after the contemporaneous measurement. Optionally, the higher the magnitude of the difference between a subsequent measurement of a traveler and a contemporaneous measurement of the traveler, the more uncomfortable the traveling in the vehicle of the certain type was for the traveler. In this embodiment, the scoring module 150, or another scoring module described herein (e.g., aftereffect scoring module 302), may be utilized to compute a comfort score for traveling in the vehicle of the certain type based on difference between the subsequent measurements and contemporaneous measurements. The comfort score in this embodiment may have the same properties of the comfort score 1507 described above.

In some embodiments, in order to compute a comfort score using the “exit effect”, the scoring module 150 may utilize the contemporaneous measurements of the at least ten travelers in order to normalize subsequent measurements of the at least ten travelers. Optionally, a subsequent measurement of affective response of a traveler (taken while exiting the vehicle or shortly after that) may be normalized by treating a corresponding contemporaneous measurement of affective response of the traveler as a baseline value. Optionally, a comfort score computed by such normalization of subsequent measurements represents a change in the emotional response due to exiting the vehicle (which may cause a positive change if the traveler was not comfortable in the vehicle). Optionally, normalization of a subsequent measurement with respect to a contemporaneous measurement may be performed by the baseline normalizer 124 or a different module that operates in a similar fashion.

### 3—Crowd-Based Results for Electronic Devices

Electronic devices have become an integral part of peoples' lives. There are a plethora of electronic devices that users can choose utilize. Some examples of devices include various gadgets, wearable devices, smartphones, tablets, gaming systems, augmented reality systems, and virtual reality systems. Different devices may provide different usage experiences. For example, some electronic devices may be more comfortable than others, better suited for certain tasks, and/or have better software that provides a more pleasant interaction, etc. The large number of available types of electronic devices to choose from often makes it difficult to make an appropriate choice. Thus, it may be desirable to be able to assess various types of electronic devices in order to be able to determine what type to choose.

Some aspects of embodiments described herein involve systems, methods, and/or computer-readable media that enable computation of a satisfaction score for a certain type of electronic device based on measurements of affective response of users who utilized an electronic device of the certain type. Such a score can help a user decide whether to choose a certain type of electronic device. In some embodiments, the measurements of affective response of the users are collected with one or more sensors coupled to the users. Optionally, a sensor coupled to a user may be used to obtain a value that is indicative of a physiological signal of the user (e.g., a heart rate, skin temperature, or brainwave activity) and/or indicative of a behavioral cue of the user (e.g., a facial expression, body language, or the level of stress in the user's voice). The measurements of affective response may be used to determine how users feel while utilizing an electronic device. In one example, the measurements may be indicative of the extent the users feel one or more of the following emotions: pain, anxiety, annoyance, stress, aggression, aggravation, fear, sadness, drowsiness, apathy, anger, happiness, contentment, calmness, attentiveness, affection, and excitement.

FIG. 6 illustrates a system architecture that includes sensors and user interfaces, as described above. The architecture illustrates systems in which measurements 2501 of affective response of a crowd 2500 of users utilizing one or more electronic devices may be utilized to generate crowd-based result 2502.

It is to be noted that the reference numeral 2500 is used to refer to a crowd of users, which are users who have a certain type of experience which involves utilizing an electronic device. Thus, the crowd 2500 may be considered to be a subset of the more general crowd 100, which refers to users having experiences in general (which include electronic device-related experiences). It is to be noted that the users illustrated in the figures in this disclosure with respect to the crowd 2500 include a subset of the users belonging to the crowd 2500 (5 users, each using a smartphone). It is not intended to limit the crowd 2500, which may include a different number of users (e.g., at least ten or more) who may be utilizing various electronic devices (not only smartphones).

A plurality of sensors may be used, in various embodiments described herein, to take the measurements 2501 of affective response of users belonging to the crowd 2500. Optionally, each measurement of a user is taken with a sensor coupled to the user, while the user utilizes an electronic device. Optionally, each measurement of affective response of a user represents an affective response of the user to utilizing the electronic device. Each sensor of the plurality of sensors may be a sensor that captures a physiological signal and/or a behavioral cue of a user. Additional details about the sensors may be found in this disclosure at least in section 5—Sensors. Additional discussion regarding the measurements 2501 is given below.

In some embodiments, a sensor used to measure affective response of a user to utilizing an electronic device may belong to the electronic device. For example, a smartwatch may include a heart rate sensor, and measurements of a user's heart rate, taken with the smartwatch, are used to generate a crowd-based result that involves the smartwatch (e.g., a satisfaction score for the smartwatch). In other embodiments, a sensor used to measure a user does not belong to an electronic device that is related to a crowd-based result generated based on measurements of the sensor.

In some embodiments, the measurements 2501 of affective response may be transmitted via a network 112. Optionally, the measurements 2501 are sent to one or more servers that host modules belonging to one or more of the systems described in various embodiments in this disclosure (e.g., systems that compute scores for experiences, rank experiences, generate alerts for experiences, and/or learn parameters of functions that describe affective response).

Depending on the embodiment being considered, the crowd-based result 2502 may be one or more of various types of values that may be computed by systems described in this disclosure based on measurements of affective response of users utilizing electronic devices. For example, the crowd-based result 2502 may refer to a score for a certain type of electronic device (e.g., satisfaction score 2507), a recommendation regarding electronic devices, and/or a ranking of types of electronic devices (e.g., ranking 2580). Additionally or alternatively, the crowd-based result 2502 may include, and/or be derived from, parameters of various functions learned from measurements (e.g., function parameters and/or aftereffect scores).

As used herein, the term “electronic device” may refer to any object the uses electricity to operate and/or utilizes electronic circuitry for its operation. In some examples, electronic devices may include a processor (e.g., processor 401). Some non-limiting examples of electronic devices include: phones, smartphones, laptops, tablets, smart watches, head-mounted displays, wearable electronic devices, gaming systems, desktop computers, home theatre systems, and implanted electronic devices. Some electronic devices receive input from the environment or a user utilizing them. For example, a sensor that measures the user, such as an EEG headset, may be considered an electronic device.

In one embodiment, the scoring module 150 is configured to receive the measurements of affective response of the at least ten users. The scoring module 150 is also configured to compute, based on the measurements of affective response of the at least ten users, a satisfaction score 2507 that represents an affective response of the users to utilizing electronic devices of the certain type (i.e., the affective response resulting from utilizing the electronic devices).

A satisfaction score, such as the satisfaction score 2507, may include and/or represent various types of values. In one example, the satisfaction score comprises a value representing a quality of the user experience with an electronic device of the certain type. In another example, the satisfaction score 2507 comprises a value that is at least one of the following types: a physiological signal, a behavioral cue, an emotional state, and an affective value. Optionally, the satisfaction score comprises a value that is a function of measurements of at least ten users.

A person's comfort can sometimes be detected via a rapid change in affective response due to a change in circumstances. For example, when a person stops wearing a device (such as a head-mounted display), the sudden freedom felt after removing the electronic device may cause a positive change in the person's affective response. For example, wearing a virtual reality headset for prolonged periods may become uncomfortable (e.g., due to the weight of the headset and/or due to the quality and/or frequency of the virtual reality images presented to a user). A large difference between the affective response observed while utilizing the electronic device and the affective response measured upon removal of the electronic device may be indicative of the fact that the electronic device may be uncomfortable. This change may be considered a certain type of reaction to removing the electronic device, which may be referred to herein as a “removal effect”. Computing a score based on a “removal effect” may be done in a similar fashion to computation of a satisfaction scores in embodiments related to FIG. 6, with some differences as described below. In some embodiments, a score computed based on the “removal effect” may be referred to as a “comfort score”, which may be used in this case interchangeably with the term “satisfaction score”.

In one embodiment, in which a comfort score for a certain type of electronic device is computed utilizing the “removal effect”, the collection module 120 is configured to receive contemporaneous and subsequent measurements of affective response of at least ten users taken with sensors coupled to the users. Each of the at least ten users utilized an electronic device of the certain type for at least five minutes before removing the electronic device. A contemporaneous measurement of a user is taken while the user utilizes the electronic device, and a subsequent measurement of the user is taken during at least one of the following periods: while the user removes the electronic device, and at most three minutes after the user removed the electronic device. Optionally, the subsequent measurement is taken at most three minutes after the contemporaneous measurement. Optionally, the higher the magnitude of the difference between a subsequent measurement of a user and a contemporaneous measurement of the user, the more uncomfortable utilizing the electronic device of the certain type was for the user. In this embodiment, the scoring module 150, or another scoring module described herein (e.g., aftereffect scoring module 302), may be utilized to compute a comfort score for an electronic device of the certain type based on difference between the subsequent measurements and contemporaneous measurements. The comfort score in this embodiment may have the same properties of the satisfaction score 2507 described above.

In one example, the certain type of electronic device described above is a head-mounted display that may be used to present virtual reality content, augmented reality content, and/or mixed reality content. In another example, the certain type of electronic device described above is a wearable clothing item with sensors that may be used to measure a user and/or receive commands from the user, such as a glove or a shirt with embedded sensors. In yet another example, the certain type of electronic device is a device that includes EEG sensors that may be used to monitor a user's brainwave activity.

### 4—Crowd-Based Results for Apparel

When it comes to apparel, there are a plethora of choices for users, encompassing various designs and manufacturers of clothes, footwear and accessories. Apparel can also be obtained from various sources (e.g., brick and mortar stores, online merchants, and 3D printing). Different apparel items may provide different experiences when worn; some items may be more comfortable than others and/or more durable than others. This can lead users to exhibit different degrees of satisfaction from wearing various apparel items. However, given that often users can not try on all the apparel items they are interested, or not try on any items at all in cases such as online purchases, there is a need to be able to assess various types of apparel items in order to be able to determine which items are a good choice to purchase. Some aspects of embodiments described herein involve systems, methods, and/or computer-readable media that enable computation of a satisfaction score for a certain type of apparel item based on measurements of affective response of users who wore an apparel item of the certain type.

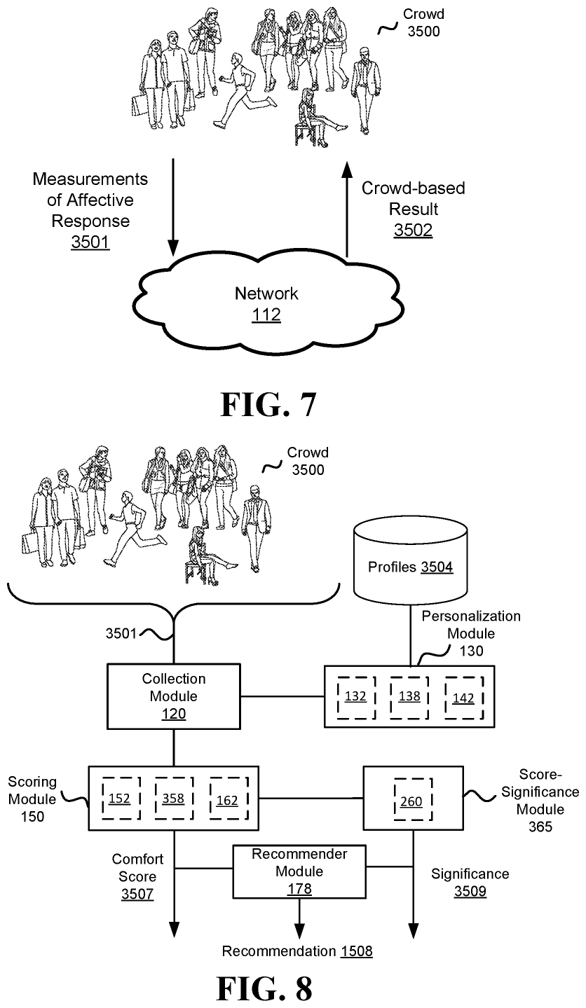

FIG. 7 illustrates a system architecture that includes sensors and user interfaces, as described above. The architecture illustrates systems in which measurements 3501 of affective response of a crowd 3500 of users utilizing one or more apparel items may be utilized to generate crowd-based result 3502, indicative of affective response to utilizing the one or more apparel items.

A plurality of sensors may be used, in various embodiments described herein, to take the measurements 3501 of affective response of users belonging to the crowd 3500. Optionally, each measurement of a user is taken with a sensor coupled to the user, while the user wears an apparel item. Optionally, each measurement of affective response of a user represents an affective response of the user to wearing the apparel item.

In some embodiments, the measurements 3501 of affective response may be transmitted via a network 112. Optionally, the measurements 3501 are sent to one or more servers that host modules belonging to one or more of the systems described in various embodiments in this disclosure (e.g., systems that compute scores for types of apparel items, rank types of apparel items, and/or learn parameters of functions that describe affective response to wearing apparel items). Depending on the embodiment being considered, the crowd-based results 3502 may be one or more of various types of values that may be computed by systems described in this disclosure based on measurements of affective response of users wearing apparel items.

As used herein, the term “apparel item” may refer to anything that may be worn by a user, including, but not limited to, the following: outerwear, underwear, tops, shirts, skirts, dresses, jackets, pants, shorts, coats, lingerie, shoes, and wearable accessories (e.g., necklaces or handbags).

In some embodiments, a measurement of affective response of a user who wears an apparel item may be taken within a minute of putting on the apparel item. Optionally, the measurement may be normalized with respect to a measurement taken before putting on the apparel item (e.g., up to five minutes before). Thus, the difference between the measurements may reflect the affective response to putting on the apparel item (referred to herein as a “putting on effect”). Optionally, some crowd-based results such as a comfort score for a certain type of apparel item may be based on the “putting on effect” observed when wearing an apparel item of the certain type.

FIG. 8 illustrates a system configured to compute scores for experiences involving wearing apparel items of a certain type, which may also be referred to herein as “comfort scores”. The system that computes a comfort score includes at least a collection module (e.g., collection module 120) and a scoring module (e.g., the scoring module 150 or the aftereffect scoring module 302). Optionally, such a system may also include additional modules such as the personalization module 130, score-significance module 165, and/or recommender module 178. The illustrated system includes modules that may optionally be found in other embodiments described in this disclosure. This system, like other systems described in this disclosure, includes at least a memory 402 and a processor 401. The memory 402 stores computer executable modules described below, and the processor 401 executes the computer executable modules stored in the memory 402.

In one embodiment, the collection module 120 is configured to receive the measurements 3501, which in this embodiment include measurements of at least ten users. Optionally, each measurement of a user is taken with a sensor coupled to the user, while the user wears an apparel item of the certain type. It is to be noted that an “apparel item of the certain type” may be an apparel item of any of the types of apparel items mentioned in this disclosure.

In one embodiment, the scoring module 150 is configured to receive the measurements of affective response of the at least ten users. The scoring module 150 is also configured to compute, based on the measurements of affective response of the at least ten users, a comfort score 3507 that represents an affective response of the users to wearing apparel items of the certain type (i.e., the affective response resulting from wearing the apparel items).

### 5—Sensors

As used herein, a sensor is a device that detects and/or responds to some type of input from the physical environment. Herein, “physical environment” is a term that includes the human body and its surroundings.

In some embodiments, a sensor that is used to measure affective response of a user may include, without limitation, one or more of the following: a device that measures a physiological signal of the user, an image-capturing device (e.g., a visible light camera, a near infrared (NIR) camera, a thermal camera (useful for measuring wavelengths larger than 2500 nm), a microphone used to capture sound, a movement sensor, a pressure sensor, a magnetic sensor, an electro-optical sensor, and/or a biochemical sensor. When a sensor is used to measure the user, the input from the physical environment detected by the sensor typically originates and/or involves the user. For example, a measurement of affective response of a user taken with an image capturing device comprises an image of the user. In another example, a measurement of affective response of a user obtained with a movement sensor typically detects a movement of the user. In yet another example, a measurement of affective response of a user taken with a biochemical sensor may measure the concentration of chemicals in the user (e.g., nutrients in blood) and/or by-products of chemical processes in the body of the user (e.g., composition of the user's breath).

Sensors used in embodiments described herein may have different relationships to the body of a user. In one example, a sensor used to measure affective response of a user may include an element that is attached to the user's body (e.g., the sensor may be embedded in gadget in contact with the body and/or a gadget held by the user, the sensor may comprise an electrode in contact with the body, and/or the sensor may be embedded in a film or stamp that is adhesively attached to the body of the user). In another example, the sensor may be embedded in, and/or attached to, an item worn by the user, such as a glove, a shirt, a shoe, a bracelet, a ring, a head-mounted display, and/or helmet or other form of headwear. In yet another example, the sensor may be implanted in the user's body, such a chip or other form of implant that measures the concentration of certain chemicals, and/or monitors various physiological processes in the body of the user. And in still another example, the sensor may be a device that is remote of the user's body (e.g., a camera or microphone).

As used herein, a “sensor” may refer to a whole structure housing a device used for detecting and/or responding to some type of input from the physical environment, or to one or more of the elements comprised in the whole structure. For example, when the sensor is a camera, the word sensor may refer to the entire structure of the camera, or just to its CMOS detector.

In some embodiments, a sensor may store data it collects and/processes (e.g., in electronic memory). Additionally or alternatively, the sensor may transmit data it collects and/or processes. Optionally, to transmit data, the sensor may use various forms of wired communication and/or wireless communication, such as Wi-Fi signals, Bluetooth, cellphone signals, and/or near-field communication (NFC) radio signals.

In some embodiments, a sensor may require a power supply for its operation. In one embodiment, the power supply may be an external power supply that provides power to the sensor via a direct connection involving conductive materials (e.g., metal wiring and/or connections using other conductive materials). In another embodiment, the power may be transmitted to the sensor wirelessly. Examples of wireless power transmissions that may be used in some embodiments include inductive coupling, resonant inductive coupling, capacitive coupling, and magnetodynamic coupling. In still another embodiment, a sensor may harvest power from the environment. For example, the sensor may use various forms of photoelectric receptors to convert electromagnetic waves (e.g., microwaves or light) to electric power. In another example, radio frequency (RF) energy may be picked up by a sensor's antenna and converted to electrical energy by means of an inductive coil. In yet another example, harvesting power from the environment may be done by utilizing chemicals in the environment. For example, an implanted (in vivo) sensor may utilize chemicals in the body of the user that store chemical energy such as ATP, sugars, and/or fats.

In some embodiments, a measurement of affective response of a user comprises, and/or is based on, a physiological signal of the user, which reflects a physiological state of the user. Following are some non-limiting examples of physiological signals that may be measured. Some of the example below include types of techniques and/or sensors that may be used to measure the signals; those skilled in the art will be familiar with various sensors, devices, and/or methods that may be used to measure these signals:

Heart Rate (HR), Heart Rate Variability (HRV), and Blood-Volume Pulse (BVP), and/or other parameters relating to blood flow, which may be determined by various means such as electrocardiogram (ECG), photoplethysmogram (PPG), and/or impedance cardiography (ICG).

Skin conductance (SC), which may be measured via sensors for Galvanic Skin Response (GSR), which may also be referred to as Electrodermal Activity (EDA).

Skin Temperature (ST) may be measured, for example, with various types of thermometers.

Brain activity and/or brainwave patterns, which may be measured with electroencephalography (EEG). Additional discussion about EEG is provided below.

Brain activity determined based on functional magnetic resonance imaging (fMRI).

Brain activity based on Magnetoencephalography (MEG).

Muscle activity, which may be determined via electrical signals indicative of activity of muscles, e.g., measured with electromyography (EMG). In one example, surface electromyography (sEMG) may be used to measure muscle activity of frontalis and corrugator supercilii muscles, indicative of eyebrow movement, and from which an emotional state may be recognized.

Eye movement, e.g., measured with electrooculography (EOG).

Blood oxygen levels that may be measured using hemoencephalography (HEG).

CO₂ levels in the respiratory gases that may be measured using capnography.

Concentration of various volatile compounds emitted from the human body (referred to as the Volatome), which may be detected from the analysis of exhaled respiratory gasses and/or secretions through the skin using various detection tools that utilize nanosensors.

Temperature of various regions of the body and/or face may be determined utilizing thermal Infra-Red (IR) cameras. For example, thermal measurements of the nose and/or its surrounding region may be utilized to estimate physiological signals such as respiratory rate and/or occurrence of allergic reactions.

In some embodiments, a measurement of affective response of a user comprises, and/or is based on, a behavioral cue of the user. A behavioral cue of the user is obtained by monitoring the user in order to detect things such as facial expressions of the user, gestures made by the user, tone of voice, and/or other movements of the user's body (e.g., fidgeting, twitching, or shaking). The behavioral cues may be measured utilizing various types of sensors. Some non-limiting examples include an image capturing device (e.g., a camera), a movement sensor, a microphone, an accelerometer, a magnetic sensor, and/or a pressure sensor. In one example, a behavioral cue may involve prosodic features of a user's speech such as pitch, volume, tempo, tone, and/or stress (e.g., stressing of certain syllables), which may be indicative of the emotional state of the user. In another example, a behavioral cue may be the frequency of movement of a body (e.g., due to shifting and changing posture when sitting, laying down, or standing). In this example, a sensor embedded in a device such as accelerometers in a smartphone or smartwatch may be used to take the measurement of the behavioral cue.

In some embodiments, a measurement of affective response of a user may be obtained by capturing one or more images of the user with an image-capturing device, such as a camera. Optionally, the one or more images of the user are captured with an active image-capturing device that transmits electromagnetic radiation (such as radio waves, millimeter waves, or near visible waves) and receives reflections of the transmitted radiation from the user. Optionally, the one or more captured images are in two dimensions and/or in three dimensions.

### 6—Measurements of Affective Response

In various embodiments, a measurement of affective response of a user comprises, and/or is based on, one or more values acquired with a sensor that measures a physiological signal and/or a behavioral cue of the user.

In some embodiments, an affective response of a user to an event is expressed as absolute values, such as a value of a measurement of an affective response (e.g., a heart rate level, or GSR value), and/or emotional state determined from the measurement (e.g., the value of the emotional state may be indicative of a level of happiness, excitement, and/or contentedness). Alternatively, the affective response of the user may be expressed as relative values, such as a difference between a measurement of an affective response (e.g., a heart rate level, or GSR value) and a baseline value, and/or a change to emotional state (e.g., a change to the level of happiness). Depending on the context, one may understand whether the affective response referred to is an absolute value (e.g., heart rate and/or level of happiness), or a relative value (e.g., change to heart rate and/or change to the level of happiness). For example, if the embodiment describes an additional value to which the measurement may be compared (e.g., a baseline value), then the affective response may be interpreted as a relative value. In another example, if an embodiment does not describe an additional value to which the measurement may be compared, then the affective response may be interpreted as an absolute value. Unless stated otherwise, embodiments described herein that involve measurements of affective response may involve values that are either absolute and/or relative.

As used herein, a “measurement of affective response” is not limited to representing a single value (e.g., scalar); a measurement may comprise multiple values. In one example, a measurement may be a vector of co-ordinates, such as a representation of an emotional state as a point on a multidimensional plane. In another example, a measurement may comprise values of multiple signals taken at a certain time (e.g., heart rate, temperature, and a respiration rate at a certain time). In yet another example, a measurement may include multiple values representing signal levels at different times. Thus, a measurement of affective response may be a time-series, pattern, or a collection of wave functions, which may be used to describe a signal that changes over time, such as brainwaves measured at one or more frequency bands. Thus, a “measurement of affective response” may comprise multiple values, each of which may also be considered a measurement of affective response. Therefore, using the singular term “measurement” does not imply that there is a single value. For example, in some embodiments, a measurement may represent a set of measurements, such as multiple values of heart rate and GSR taken every few minutes during a duration of an hour.

In some embodiments, a “measurement of affective response” may be characterized as comprising values acquired with a certain sensor or a certain group of sensors sharing a certain characteristic. Additionally or alternatively, a measurement of affective response may be characterized as not comprising, and/or not being based, on values acquired by a certain type of sensor and/or a certain group of sensors sharing a certain characteristic. For example, in one embodiment, a measurement of affective response is based on one or more values that are physiological signals (e.g., values obtained using GSR and/or EEG), and is not based on values representing behavioral cues (e.g., values derived from images of facial expressions measured with a camera). While in another embodiment, a measurement of affective response is based on one or more values representing behavioral cues and is not based on values representing physiological signals.

Following are additional examples for embodiments in which a “measurement of affective response” may be based only on certain types of values, acquired using certain types of sensors (and not others). In one embodiment, a measurement of affective response does not comprise values acquired with sensors that are implanted in the body of the user. For example, the measurement may be based on values obtained by devices that are external to the body of the user and/or attached to it (e.g., certain GSR systems, certain EEG systems, and/or a camera). In another embodiment, a measurement of affective response does not comprise a value representing a concentration of chemicals in the body such as glucose, cortisol, adrenaline, etc., and/or does not comprise a value derived from a value representing the concentration. In still another embodiment, a measurement of affective response does not comprise values acquired by a sensor that is in contact with the body of the user. For example, the measurement may be based on values acquired with a camera and/or microphone. And in yet another embodiment, a measurement of affective response does not comprise values describing brainwave activity (e.g., values acquired by EEG).

A measurement of affective response may comprise raw values describing a physiological signal and/or behavioral cue of a user. For example, the raw values are the values provided by a sensor used to measure, possibly after minimal processing, as described below. Additionally or alternatively, a measurement of affective response may comprise a product of processing of the raw values. The processing of one or more raw values may involve performing one or more of the following operations: normalization, filtering, feature extraction, image processing, compression, encryption, and/or any other techniques described further in this disclosure, and/or that are known in the art and may be applied to measurement data.

In some embodiments, processing raw values, and/or processing minimally processed values, involves providing the raw values and/or products of the raw values to a module, function, and/or predictor, to produce a value that is referred to herein as an “affective value”. As typically used herein, an affective value is a value that describes an extent and/or quality of an affective response. For example, an affective value may be a real value describing how good an affective response is (e.g., on a scale from 1 to 10), or whether a user is attracted to something or repelled by it (e.g., by having a positive value indicate attraction and a negative value indicate repulsion). In some embodiments, the use of the term “affective value” is intended to indicate that certain processing might have been applied to a measurement of affective response. Optionally, the processing is performed by a software agent. Optionally, the software agent has access to a model of the user that is utilized in order to compute the affective value from the measurement. In one example, an affective value may be a prediction of an Emotional State Estimator (ESE) and/or derived from the prediction of the ESE. In some embodiments, measurements of affective response may be represented by affective values.

It is to be noted that, though affective values are typically results of processing measurements, they may be represented by any type of value that a measurement of affective response may be represented by. Thus, an affective value may, in some embodiments, be a value of a heart rate, brainwave activity, skin conductance levels, etc.

In some embodiments, a measurement of affective response may involve a value representing an emotion (also referred to as an “emotional state” or “emotional response”). Emotions and/or emotional responses may be represented in various ways. In some examples, emotions or emotional responses may be predicted based on measurements of affective response, retrieved from a database, and/or annotated by a user (e.g., self-reporting by a user having the emotional response). In one example, self-reporting may involve analyzing communications of the user to determine the user's emotional response. In another example, self-reporting may involve the user entering values (e.g., via a GUI) that describes the emotional state of the user at a certain time and/or the emotional response of the user to a certain event. In the embodiments, there are several ways to represent emotions (which may be used to represent emotional states and emotional responses as well).

In one embodiment, emotions are represented using discrete categories. For example, the categories may include three emotional states: negatively excited, positively excited, and neutral. In another example, the categories may include emotions such as happiness, surprise, anger, fear, disgust, and sadness.

In another embodiment, emotions are represented using a multidimensional representation, which typically characterizes the emotion in terms of a small number of dimensions. In one example, emotional states are represented as points in a two-dimensional space of Arousal and Valence.

In yet another embodiment, emotions are represented using a numerical value that represents the intensity of the emotional state with respect to a specific emotion. For example, a numerical value stating how much the user is enthusiastic, interested, and/or happy. Optionally, the numeric value for the emotional state may be derived from a multidimensional space representation of emotion; for instance, by projecting the multidimensional representation of emotion to the nearest point on a line in the multidimensional space.

A measurement of affective response may be referred to herein as being positive or negative. A positive measurement of affective response, as the term is typically used herein, reflects a positive emotion indicating one or more qualities such as desirability, happiness, content, and the like, on the part of the user of whom the measurement is taken. Similarly, a negative measurement of affective response, as typically used herein, reflects a negative emotion indicating one or more qualities such as repulsion, sadness, anger, and the like on the part of the user of whom the measurement is taken. Optionally, when a measurement is neither positive nor negative, it may be considered neutral.

Various embodiments described herein involve measurements of affective response of users to having experiences. A measurement of affective response of a user to having an experience may also be referred to herein as a “measurement of affective response of the user to the experience”. In order to reflect the affective response of a user to having an experience, the measurement is typically taken in temporal proximity to when the user had the experience (so the affective response may be determined from the measurement). Herein, temporal proximity means nearness in time. Thus, stating that a measurement of affective response of a user is taken in temporal proximity to when the user has/had an experience means that the measurement is taken while the user has/had the experience and/or shortly after the user finishes having the experience. Optionally, a measurement of affective response of a user taken in temporal proximity to having an experience may involve taking at least some of the measurement shortly before the user started having the experience (e.g., for calibration and/or determining a baseline).

As used herein, a “baseline affective response value of a user” (or “baseline value of a user” when the context is clear) refers to a value that may represent a typically slowly changing affective response of the user, such as the mood of the user. Optionally, the baseline affective response value is expressed as a value of a physiological signal of the user and/or a behavioral cue of the user, which may be determined from a measurement taken with a sensor. Herein, a module that computes a baseline value may be referred to herein as a “baseline value predictor”.

In one embodiment, normalizing a measurement of affective response utilizing a baseline involves subtracting the value of the baseline from the measurement. Thus, after normalizing with respect to the baseline, the measurement becomes a relative value, reflecting a difference from the baseline. In one example, if the measurement includes a certain value, normalization with respect to a baseline may produce a value that is indicative of how much the certain value differs from the value of the baseline (e.g., how much is it above or below the baseline). In another example, if the measurement includes a sequence of values, normalization with respect to a baseline may produce a sequence indicative of a divergence between the measurement and a sequence of values representing the baseline.

In one embodiment, a baseline affective response value may be derived from one or more measurements of affective response taken before and/or after a certain event that may be evaluated to determine its influence on the user. For example, the event may involve visiting a location, and the baseline affective response value is based on a measurement taken before the user arrives at the location. In another example, the event may involve the user interacting with a service provider, and the baseline affective response value is based on a measurement of the affective response of the user taken before the interaction takes place.

In another embodiment, a baseline affective response value may correspond to a certain event, and represent an affective response the user corresponding to the event would typically have to the certain event. Optionally, the baseline affective response value is derived from one or more measurements of affective response of a user taken during previous instantiations of events that are similar to the certain event (e.g., involve the same experience and/or similar conditions of instantiation). For example, the event may involve visiting a location, and the baseline affective response value is based on measurements taken during previous visits to the location. In another example, the event may involve the user interacting with a service provider, and the baseline affective response value may be based on measurements of the affective response of the user taken while interacting with other service providers. Optionally, a predictor may be used to compute a baseline affective response value corresponding to an event. For example, such a baseline may be computed utilizing an Emotional State Estimator (ESE), as described in further detail in section 10—Predictors and Emotional State Estimators. Optionally, an approach that utilizes a database storing descriptions of events and corresponding values of measurements of affective response, such as approaches outlined in the patent publication U.S. Pat. No. 8,938,403 titled “Computing token-dependent affective response baseline levels utilizing a database storing affective responses”, may also be utilized to compute a baseline corresponding to an event.

In yet another embodiment, a baseline affective response value may correspond to a certain period in a periodic unit of time (also referred to as a recurring unit of time). Optionally, the baseline affective response value is derived from measurements of affective response taken during the certain period during the periodic unit of time. For example, a baseline affective response value corresponding to mornings may be computed based on measurements of a user taken during the mornings. In this example, the baseline will include values of an affective response a user typically has during the mornings.

There are various ways, in embodiments described herein, in which a plurality of values, obtained utilizing sensors that measure a user, can be used to produce the measurement of affective response corresponding to the event. It is to be noted that in some embodiments, the measurement of affective response simply comprises the plurality of values (e.g., the measurement may include the plurality of values in raw or minimally-processed form). However, in other embodiments, the measurement of affective response is a value that is a function of the plurality of values. There are various functions that may be used for this purpose. In one example, the function is an average of the plurality of values. In another example, the function may be a weighted average of the plurality of values, which may give different weights to values acquired at different times. In still another example, the function is implemented by a machine learning-based predictor.

In one embodiment, a measurement of affective response corresponding to an event is a value that is an average of a plurality of values obtained utilizing a sensor that measured the user corresponding to the event. Optionally, each of the plurality of values was acquired at a different time during the instantiation of the event (and/or shortly after it).

In another embodiment, a measurement of affective response corresponding to an event is a value that is a weighted average of a plurality of values obtained utilizing a sensor that measured the user corresponding to the event. Herein, a weighted average of values may be any linear combination of the values. Optionally, each of the plurality of values was acquired at a different time during the instantiation of the event (and/or shortly after it), and may be assigned a possible different weight for the computing of the weighted average.

Training an affective value scorer with a predictor involves obtaining a training set comprising samples and corresponding labels, and utilizing a training algorithm for one or more of the machine learning approaches described in section 10—Predictors and Emotional State Estimators. Optionally, each sample corresponds to an event and comprises feature values derived from one or more measurements of the user (i.e., the plurality of values mentioned above) and optionally other feature values corresponding to the additional information and/or statistics mentioned above. The label of a sample is the affective value corresponding to the event. The affective value used as a label for a sample may be generated in various ways.

### 7—Experiences

Some embodiments described herein may involve users having “experiences”. In different embodiments, “experiences” may refer to different things. In some embodiments, there is a need to identify events involving certain experiences, and/or to characterize them. For example, identifying and/or characterizing what experience a user has may be needed in order to describe an event in which a user has the experience. Having such a description is useful for various tasks. In one example, a description of an event may be used to generate a sample provided to a predictor for predicting affective response to the experience, as explained in more detail at least in section 10—Predictors and Emotional State Estimators. In another example, descriptions of events may be used to group events into sets involving the same experience (e.g., sets of events described further below in this disclosure). A grouping of events corresponding to the same experience may be useful for various tasks such as for computing a score for the experience from measurements of affective response, as explained in more detail at least in section 14—Scoring. Experiences are closely tied to events; an instance in which a user has an experience is considered an event. As such additional discussion regarding experiences is also given at least in section 8—Events.

An experience is typically characterized as being of a certain type. Below is a description comprising non-limiting examples of various categories of types of experiences to which experiences in different embodiments may correspond. This description is not intended to be a partitioning of experiences; e.g., various experiences described in embodiments may fall into multiple categories listed below. This description is not comprehensive; e.g., some experiences in embodiments may not belong to any of the categories listed below.

Location. Various embodiments described herein involve experiences in which a user is in a location. In some embodiments, a location may refer to a place in the physical world. A location in the physical world may occupy various areas in, and/or volumes of, the physical world. For example, a location may be a continent, country, region, city, park, or a business (e.g., a restaurant). In one example, a location is a travel destination (e.g., Paris). In another example, a location may be a portion of another location, such as a specific room in a hotel or a seat in a specific location in a theatre. For example, is some embodiments, being in the living room of an apartment may be considered a different experience than being in a bedroom.

Virtual Location. In some embodiments, a location may refer to a virtual environment such as a virtual world, with at least one instantiation of the virtual environment stored in a memory of a computer. Optionally, a user is considered to be in the virtual environment by virtue of having a value stored in the memory indicating the presence of a representation of the user in the virtual environment. Optionally, different locations in virtual environment correspond to different logical spaces in the virtual environment. For example, different rooms in an inn in a virtual world may be considered different locations. In another example, different continents in a virtual world may be considered different locations. In one embodiment, a user interacts with a graphical user interface in order to participate in activities within a virtual environment. In some examples, a user may be represented in the virtual environment as an avatar. Optionally, the avatar of the user may represent the presence of the user at a certain location in the virtual environment. Furthermore, by seeing where the avatar is, other users may determine what location the user is in, in the virtual environment.

Activity. In some embodiments, an experience may involve an activity that a user does. In one example, an experience involves a recreational activity (e.g., traveling, going out to a restaurant, visiting the mall, or playing games on a gaming console). In another example, an experience involves a day-to-day activity (e.g., getting dressed, driving to work, talking to another person, sleeping, and/or making dinner). In yet another example, an experience involves a work-related activity (e.g., writing an email, boxing groceries, or serving food). In still another example, an experience involves a mental activity such as studying and/or taking an exam. In still another example, an experience may involve a simple action like sneezing, kissing, or coughing.

Service Provider—In some embodiments, a social interaction a user has is with a service provider providing a service to the user. Optionally, a service provider may be a human service provider or a virtual service provider (e.g., a robot, a chatbot, a web service, and/or a software agent). In some embodiments, a human service provider may be any person with whom a user interacts (that is not the user). Optionally, at least part of an interaction between a user and a service provider may be performed in a physical location (e.g., a user interacting with a waiter in a restaurant, where both the user and the waiter are in the same room). Optionally, the interaction involves a discussion between the user and the service provider (e.g., a telephone call or a video chat). Optionally, at least part of the interaction may be in a virtual space (e.g., a user and insurance agent discuss a policy in a virtual world). Optionally, at least part of the interaction may involve a communication, between the user and a service provider, in which the user and service provider are not in physical proximity (e.g., a discussion on the phone).

Product—Utilizing a product may be considered an experience in some embodiments. A product may be any object that a user may utilize. Examples of products include appliances, clothing items, footwear, wearable devices, gadgets, jewelry, cosmetics, cleaning products, vehicles, sporting gear and musical instruments. Optionally, with respect to the same product, different periods of utilization and/or different periods of ownership of the product may correspond to different experiences. For example, wearing a new pair of shoes for the first time may be considered an event of a different experience than an event corresponding to wearing the shoes after owning them for three months.

Environment—Spending time in an environment characterized by certain environmental conditions may also constitute an experience in some embodiments. Optionally, different environmental conditions may be characterized by a certain value or range of values of an environmental parameter. In one example, being in an environment in which the temperature is within a certain range corresponds to a certain experience (e.g., being in temperatures lower than 45° F. may be considered an experience of being in the cold and being in temperatures higher than 90° F. may be considered being in a warm environment). In another example, environments may be characterized by a certain range of humidity, a certain altitude, a certain level of pressure (e.g., expressed in atmospheres), and/or a certain level of felt gravity (e.g., a zero-G environment). In yet another example, being in an environment that is exposed to a certain level of radiation may be considered an experience (e.g., exposure to certain levels of sun light, Wi-Fi transmissions, electromagnetic fields near power lines, and/or cellular phone transmissions).

The examples above describe some of the occurrences that may be considered an “experience” a user has in embodiments described in this disclosure. However, in this disclosure, not everything may be considered an experience that happens to a user, for which a crowd-based result may be generated (e.g., a score for the experience). The following are examples of things that are not considered an experience in this disclosure.

### 8—Events

When a user has an experience, this defines an “event”. An event may be characterized according to certain attributes. For example, every event may have a corresponding experience and a corresponding user (who had the corresponding experience). An event may have additional corresponding attributes that describe the specific instantiation of the event in which the user had the experience. Examples of such attributes may include the event's duration (how long the user had the experience in that instantiation), the event's starting and/or ending time, and/or the event's location (where the user had the experience in that instantiation).

An event may be referred to as being an “instantiation” of an experience and the time during which an instantiation of an event takes place may be referred to herein as the “instantiation period” of the event. This relationship between an experience and an event may be considered somewhat conceptually similar to the relationship in programming between a class and an object that is an instantiation of the class. The experience may correspond to some general attributes (that are typically shared by all events that are instantiations of the experience), while each event may have attributes that correspond to its specific instantiation (e.g., a certain user who had the experience, a certain time the experience was experienced, a certain location the certain user had the experience, etc.) Therefore, when the same user has the same experience but at different times, these may be considered different events (with different instantiations periods). For example, a user eating breakfast on Sunday, Feb. 1, 2015 is a different event than the user eating breakfast on Monday, Feb. 2, 2015.

In some embodiments, an event may have a corresponding measurement of affective response, which is a measurement of the user corresponding to the event, to having the experience corresponding to the event. The measurement corresponding to an event is taken during a period corresponding to the event; for example, during the time the user corresponding to the event had the experience corresponding to the event, or shortly after that. Optionally, a measurement corresponding to an event reflects the affective response corresponding to the event, which is the affective response of the user corresponding to the event to having the experience corresponding to the event. Thus, a measurement of affective response corresponding to an event typically comprises, and/or is based on, one or more values measured during the instantiation period of the event and/or shortly after it, as explained in more detail at least in section 6—Measurements of Affective Response.

It is to be noted that when a user has multiple experiences simultaneously, e.g., mini-events discussed below, the same measurement of affective response may correspond to multiple events corresponding to the multiple experiences.

Descriptions of events are used in various embodiments in this disclosure. Typically, a description of an event may include values related to a user corresponding to the event, an experience corresponding to the event, and/or details of the instantiation of the event (e.g., the duration, time, location, and/or conditions of the specific instantiation of the event). Optionally, a description of an event may be represented as feature vector comprising feature values. Additionally or alternatively, a description of an event may include various forms of data such as images, audio, video, transaction records, and/or other forms of data that describe aspects of the user corresponding to the event, the experience corresponding to the event, and/or the instantiation of the event. Additionally, in some embodiments, a description of an event includes, and/or may be used to derive, factors of events, as discussed in more detail at least in section 21—Factors of Events.

A description of a user includes values describing aspects of the user. Optionally, the description may be represented as a vector of feature values. Additionally or alternatively, a description of a user may include data such as images, audio, and/or video that includes the user. In some embodiments, a description of a user contains values that relate to general attributes of the user, which are often essentially the same for different events corresponding to the same user, possibly when having different experiences. Examples of such attributes may include demographic information about the user (e.g., age, education, residence, etc.). Additionally or alternatively, the description may include portions of a profile of the user. The profile may describe various details of experiences the user had, such as details of places in the real world or virtual worlds the user visited, details about activities the user participated in, and/or details about content the user consumed. Optionally, the description of the user may include values obtained from modeling the user, such as bias values corresponding to biases the user has (bias values are discussed in more detail in section 22—Bias Values).

A description of an experience includes values describing aspects of the experience. Optionally, the description of the experience may be represented as a vector of feature values. Typically, the description of the experience contains values that relate to general attributes of the experience, which are often essentially the same for different events corresponding to the same experience, possibly even when it is experienced at different times and/or by different users. Examples of such information may include attributes related to the type of experience, such as its typical location, cost, difficulty, etc.

In some embodiments, in order to gather this information, a software agent may actively access various databases that include records about the user on behalf of whom the software agent operates. For example, such databases may be maintained by entities that provide experiences to users and/or aggregate information about the users, such as content providers (e.g., search engines, video streaming services, gaming services, and/or hosts of virtual worlds), communication service providers (e.g., internet service providers and/or cellular service providers), e-commerce sites, and/or social networks.

In one embodiment, a first software agent acting on behalf of a first user may contact a second software agent, acting on behalf of a second user, in order to receive information about the first user that may be collected by the second software agent (e.g., via a device of the second user). For example, the second software agent may provide images of the first user that the first software agent may analyze in order to determine what experience the first user is having.

### 9—Identifying Events

In some embodiments, an event annotator, such as the event annotator 701, is used to identify an event, such as determining who the user corresponding to the event is, what experience the user had, and/or certain details regarding the instantiation of the event. Optionally, the event annotator generates a description of the event.

Identifying events may involve utilizing information of one or more of various types of information and/or from one or more of various sources of information, as described below. This information may be used to provide context that can help identify at least one of the following: the user corresponding to the event, the experience corresponding to the event, and/or other properties corresponding to the event (e.g., characteristics of the instantiation of the experience involved in the event and/or situations of the user that are relevant to the event). Optionally, at least some of the information is collected by a software agent that monitors a user on behalf of whom it operates (as described in detail elsewhere in this disclosure). Optionally, at least some of the information is collected by a software agent that operates on behalf of an entity that is not the user corresponding to the event, such as a software agent of another user that shares the experience corresponding to the event with the user, is in the vicinity of the user corresponding to the event when the user has the experience corresponding to the event, and/or is in communication with the user corresponding to the event. Optionally, at least some of the information is collected by providers of experiences. Optionally, at least some of the information is collected by third parties that monitor the user corresponding to the event and/or the environment corresponding to the event. Following are some examples of types of information and/or information sources that may be used; other sources may be utilized in some embodiments in addition to, or instead of, the examples given below.

Location information. Data about a location a user is in and/or data about the change in location of the user (such as the velocity of the user and/or acceleration of the user) may be used in some embodiments to determine what experience the user is having. Optionally, the information may be obtained from a device of the user (e.g., the location may be determined by GPS). Optionally, the information may be obtained from a vehicle the user is in (e.g., from a computer related to an autonomous vehicle the user is in). Optionally, the information may be obtained from monitoring the user; for example, via cameras such as CCTV and/or devices of the user (e.g., detecting signals emitted by a device of the user such as Wi-Fi, Bluetooth, and/or cellular signals). In some embodiments, a location of a user may refer to a place in a virtual world, in which case, information about the location may be obtained from a computer that hosts the virtual world and/or may be obtained from a user interface that presents information from the virtual world to the user.

Images and other sensor information. Images taken from a device of a user, such as a smartphone or a wearable device such as a smart watch or a head-mounted augmented or virtual reality glasses may be analyzed to determine various aspects of an event. For example, the images may be used to determine what experience the user is having (e.g., exercising, using a certain product, or speaking to a certain person). Additionally or alternatively, images may be used to determine where a user is, and a situation of the user, such as whether the user is alone and/or with company. Additionally or alternatively, detecting who the user is with may be done utilizing transmissions of devices of the people the user is with (e.g., Wi-Fi or Bluetooth signals their devices transmit).

Information about objects and/or devices in the vicinity of a user may be used to determine what experience a user is having. Knowing what objects and/or devices are in the vicinity of a user may provide context relevant to identifying the experience. For example, if a user packs fishing gear in the car, it means that the user will likely be going fishing while if the user puts a mountain bike on the car, it is likely the user is going biking Information about the objects and/or devices in the vicinity of a user may come from various sources. In one example, at least some of this information is provided actively by objects and/or devices that transmit information identifying their presence. For example, the objects or devices may transmit information via Wi-Fi or Bluetooth signals. Optionally, some of the objects and/or devices may be connected via the Internet (e.g., as part of the Internet of Things).

Information derived from communications of a user (e.g., email, text messages, voice conversations, and/or video conversations) may be used, in some embodiments, to provide context and/or to identify experiences the user has, and/or other aspects of events. These communications may be analyzed, e.g., using semantic analysis in order to determine various aspects corresponding to events, such as what experience a user has, a situation of a user (e.g., the user's mood and/or state of mind).

A user's calendar that lists activities the user had in the past and/or will have in the future may provide context and/or to identify experiences the user has. Optionally, the calendar includes information such as a period, location, and/or other contextual information for at least some of the experiences the user had or will have.

Information in various accounts maintained by a user (e.g., digital wallets, bank accounts, or social media accounts) may be used to provide context, identify events, and/or certain aspects of the events. Information on those accounts may be used to determine various aspects of events such as what experiences the user has (possibly also determining when, where, and with whom), situations the user is in at the time (e.g., determining that the user is in a new relationship and/or after a breakup).

In some embodiments, a robotic helper may provide information about experiences a user it is interacting with has. For example, a smart refrigerator may provide information about what food a user consumed. A masseuse robot may provide information of periods when it operated to give a massage, and identify whose user settings were used. In another example, an entertainment center may provide information regarding what content it provided the user and at what time (e.g., the name and time certain songs were streamed in a user's home audio system).

The term “feature values” is typically used herein to represent data that may be provided to a machine learning-based predictor. Thus, a description of an event may be converted to feature values in order to be used to identify events, as described in this section. Typically, but necessarily, feature values may be data that can be represented as a vector of numerical values (e.g., integer or real values), with each position in the vector corresponding to a certain feature. However, in some embodiments, feature values may include other types of data, such as text, images, and/or other digitally stored information.

In some embodiments, the event annotator 701 utilizes the sources of information mentioned above in order to identify events users have (e.g., identify the type of experience). Additionally or alternatively, the event annotator 701 may be utilized to identify aspects of events, referred to herein as “factors of events”. Each of these aspects may relate to the user corresponding to the event, the experience corresponding to the event, and/or the instantiation of the event. Factors of the events are described in more detail at least in section 21—Factors of Events. It is to be noted that the feature values mentioned in this section, which may be utilized to identify events, may themselves be factors of events and/or derived from factors of events (e.g., when factors of events appear in a description of an event).

Given an unlabeled sample, the event annotator may assign the unlabeled sample one or more corresponding labels, each label identifying an experience the user had. Optionally, the event annotator may provide values corresponding to the confidence and/or probability that the user had the experiences identified by at least some of the one or more labels.

In one embodiment, the one or more labels assigned by the event annotator are selected from a subset of a larger set of possible labels. Thus, the event annotator only considers a subset of the experiences for a certain sample. Optionally, the subset is selected based on some of the information received by the event annotator. In one example, a location described in the sample may be used to determine a subset of likely experiences for that location. Similarly, the time of the day or the day of the week may be used to determine a certain subset of likely experiences. In another example, a situation of the user corresponding to a sample (e.g., alone vs. with company, in a good mood vs. bad mood) may also be used to select a subset of the experiences that are most relevant. In yet another example, the objects and/or devices with the user may be used to select the subset. In still another example, external information such as billing information or a user's calendar may be used to select the subset (e.g., the information may indicate that the user had a certain experience on a given day, but not the exact time).

### 10—Predictors and Emotional State Estimators

In some embodiments, a module that receives a query that includes a sample (e.g., a vector including one or more feature values) and computes a label for that sample (e.g., a class identifier or a numerical value), is referred to as a “predictor” and/or an “estimator”. Optionally, a predictor and/or estimator may utilize a model to assign labels to samples. In some embodiments, a model used by a predictor and/or estimator is trained utilizing a machine learning-based training algorithm. Optionally, when a predictor and/or estimator return a label that corresponds to one or more classes that are assigned to the sample, these modules may be referred to as “classifiers”.

The terms “predictor” and “estimator” may be used interchangeably in this disclosure. Thus, a module that is referred to as a “predictor” may receive the same type of inputs as a module that is called an “estimator”, it may utilize the same type of machine learning-trained model, and/or produce the same type of output. However, as commonly used in this disclosure, the input to an estimator typically includes values that come from measurements, while a predictor may receive samples with arbitrary types of input. For example, a module that identifies what type of emotional state a user was likely in based on measurements of affective response of the user, is referred to herein as an Emotional State Estimator (ESE), while a module that predicts the likely emotional response of a user to an event is referred to herein as an Emotional Response Predictor (ERP). Additionally, a model utilized by an ESE and/or an ERP may be referred to as an “emotional state model” and/or an “emotional response model”.

A sample provided to a predictor and/or an estimator in order to receive a label for it may be referred to as a “query sample” or simply a “sample”. A value returned by the predictor and/or estimator, which it computed from a sample given to it as an input, may be referred to herein as a “label”, a “predicted value”, and/or an “estimated value”. A pair that includes a sample and a corresponding label may be referred to as a “labeled sample”. A sample that is used for the purpose of training a predictor and/or estimator may be referred to as a “training sample” or simply a “sample”. Similarly, a sample that is used for the purpose of testing a predictor and/or estimator may be referred to as a “testing sample” or simply a “sample”. In typical embodiments, samples used by the same predictor and/or estimator for various purposes (e.g., training, testing, and/or a query) are assumed to have a similar structure (e.g., similar dimensionality) and are assumed to be generated in a similar process (e.g., they undergo the same type of preprocessing).

In some embodiments, a sample for a predictor and/or estimator includes one or more feature values. Optionally, at least some of the feature values are numerical values (e.g., integer and/or real values). Optionally, at least some of the feature values may be categorical values that may be represented as numerical values (e.g., via indices for different categories). Optionally, the one or more feature values comprised in a sample may be represented as a vector of values. Various preprocessing, processing, and/or feature extraction techniques known in the art may be used to generate the one or more feature values comprised in a sample. Additionally, in some embodiments, samples may contain noisy or missing values. There are various methods known in the art that may be used to address such cases.

Predictors and estimators may utilize, in various embodiments, different types of models in order to compute labels for query samples. A plethora of machine learning algorithms is available for training different types of models that can be used for this purpose. Some of the algorithmic approaches that may be used for creating a predictor and/or estimator include classification, clustering, function prediction, regression, and/or density estimation. Those skilled in the art can select the appropriate type of model and/or training algorithm depending on the characteristics of the training data (e.g., its dimensionality or the number of samples), and/or the type of value used as labels (e.g., a discrete value, a real value, or a multidimensional value).

In one example, classification methods like Support Vector Machines (SVMs), Naive Bayes, nearest neighbor, decision trees, logistic regression, and/or neural networks can be used to create a model for predictors and/or estimators that predict discrete class labels. In another example, methods like SVMs for regression, neural networks, linear regression, logistic regression, and/or gradient boosted decision trees can be used to create a model for predictors and/or estimators that return real-valued labels, and/or multidimensional labels. In yet another example, a predictor and/or estimator may utilize clustering of training samples in order to partition a sample space such that new query samples can be placed in one or more clusters and assigned labels according to the clusters to which they belong. In a somewhat similar approach, a predictor and/or estimator may utilize a collection of labeled samples in order to perform nearest neighbor classification (in which a query sample is assigned a label according to one or more of the labeled samples that are nearest to it when embedded in some space).

In some embodiments, data used to generate a sample may be extensive and be represented by many values (e.g., high-dimensionality data). Having samples that are high-dimensional can lead, in some cases, to a high computational load and/or reduced accuracy of predictors and/or estimators that handle such data. Thus, in some embodiments, as part of preprocessing, samples may undergo one or more forms of dimensionality reduction and/or feature selection. For example, dimensionality reduction may be attained utilizing techniques such as principal component analysis (PCA), linear discriminant analysis (LDA), and/or canonical correlation analysis (CCA). In another example, dimensionality reduction may be achieved using random projections and/or locality-sensitive hashing. In still another example, a certain subset of the possible features may be selected to be used by a predictor and/or estimator, such as by various filter, wrapper, and/or embedded feature selection techniques known in the art.

When a model contains parameters that are used to compute a label, such as in the examples above, the terms “model”, “predictor”, and/or “estimator” (and derivatives thereof) may at times be used interchangeably herein. Thus, for example, language reciting “a model that predicts” or “a model used for estimating” is acceptable. Additionally, phrases such as “training a predictor” and the like may be interpreted as training a model utilized by the predictor. Furthermore, when a discussion relates to parameters of a predictor and/or an estimator, this may be interpreted as relating to parameters of a model used by the predictor and/or estimator.

In some embodiments, when an ERP and/or ESE is trained on data from multiple users, which includes information describing specific details in the sample, such as details about a user, an experience, and/or an instantiation of an event related to a sample, it may be considered a “generalizable” ERP and/or ESE. Herein, generalizability in the context of ERPs and ESEs may be interpreted as being able to learn from data regarding certain users and/or experiences, and apply those teachings to other users and/or experiences (not encountered in training data). Thus, for example, a generalizable ERP may be able to make “generalized” predictions for samples were not encountered in the training data (“general” samples).

In one embodiment, an ERP may be considered a generalizable ERP if on average, it makes predictions for samples that are not part of the training set used to train the ERP with accuracy that does not fall significantly from the accuracy of predictions made by the ERP with samples that are part of the training set. This may be considered equivalent to saying that with a generalizable ERP the training error does not fall significantly from the training error (e.g., due to the overfitting in the training being unsubstantial).

In some embodiments, when a predictor and/or an estimator (e.g., an ESE), is trained on data collected from multiple users, its predictions of emotional states and/or response may be considered predictions corresponding to a representative user. It is to be noted that the representative user may in fact not correspond to an actual single user, but rather correspond to an “average” of a plurality of users.

It is to be noted that in this disclosure, referring to a module (e.g., a predictor, an estimator, an event annotator, etc.) and/or a model as being “trained on” data means that the data is utilized for training of the module and/or model. Thus, expressions of the form “trained on” may be used interchangeably with expressions such as “trained with”, “trained utilizing”, and the like.

In other embodiments, when a model used by a predictor and/or estimator (e.g., an ESE and/or an ERP), is trained primarily on data involving a certain user, the predictor and/or estimator may be referred to as being a “personalized” or “personal” for the certain user. Herein, being trained primarily on data involving a certain user means that at least 50% of the training weight is given to samples involving the certain user and/or that the training weight given to samples involving the certain user is at least double the training weight given to the samples involving any other user. Optionally, training data for training a personalized ERP and/or ESE for a certain user is collected by a software agent operating on behalf of the certain user. Use by the software agent may, in some embodiments, increase the privacy of the certain user, since there is no need to provide raw measurements that may be more revealing about the user than predicted emotional responses. Additionally or alternatively, this may also increase the accuracy of predictions for the certain user, since a personalized predictor is trained on data reflecting specific nature of the certain user's affective responses.

the discussion about predictors.

In some embodiments, the space of features (e.g., factors of events) that may be included in samples provided to an ERP may be large and/or sparse. For example, a large set of features may be utilized, each describing a certain aspect of an event (e.g., a property of an object, an element of content, an image property, etc.). In order to improve computation efficiency and/or accuracy of predictions of the ERP, some embodiments, involve utilization of one or more feature selection and/or dimensionality reduction techniques that are applicable to predictors.

In some embodiments, a sample for an ERP may include one or more feature values that describe a baseline value of the user corresponding to the event to which the sample corresponds. Optionally, the baseline affective response value may be derived from a measurement of affective response of the user (e.g., an earlier measurement taken before the instantiation of the event) and/or it may be a predicted value (e.g., computed based on measurements of other users and/or a model for baseline affective response values). Optionally, the baseline is a situation-specific baseline, corresponding to a certain situation the user corresponding to the event is in when having the experience corresponding to the event.

In some embodiments, the baseline value may be utilized to better predict the affective response of the user corresponding to the event to the experience corresponding to the event. For example, knowing an initial (baseline) state of the user can assist in determining the final state of the user after having the experience corresponding to the event. Furthermore, a user may react differently to an experience based on his/her state when having the experience. For example, when calm, a user may react favorably to certain experiences (e.g., speaking to a certain person or doing a certain chore). However, if the user is agitated even before having an experience, the user's response might be quite different to the experience. For example, the user may get extremely upset from dealing with the person (whom he reacts favorably to when calm) or be very impatient and angry when performing the chore (which does not happen when the user is calm). Such differences in the response to the same experience may depend on the emotional and/or physiological state of the user, which may be determined, at least to some extent from a baseline value.

In some embodiments, an ERP may serve as a predictor of measurement values corresponding to events, such as a predictor of a baseline affective response value corresponding to an event. Optionally, a sample received by the ERP may comprise certain feature values that describe general attributes of the event. For example, such general attributes may include features related to the user, a situation of the user, and/or attributes related to the experience corresponding to the event in general (e.g., the type of experience). Optionally, the sample does not contain certain feature values that describe specifics of the instantiation of the event (e.g., details regarding the quality of the experience the user had). Thus, a prediction made based on general attributes, and not specific attributes, may describe an expected baseline level; specific details of the instantiation (e.g., related to the quality of the experience in the instantiation of the event) may cause a deviation from the predicted baseline level.

A predictor and/or an estimator that receives a query sample that includes features derived from a measurement of affective response of a user, and returns a value indicative of an emotional state corresponding to the measurement, may be referred to as a predictor and/or estimator of emotional state based on measurements, an Emotional State Estimator, and/or an ESE. Optionally, an ESE may receive additional values as input, besides the measurement of affective response, such as values corresponding to an event to which the measurement corresponds. Optionally, a result returned by the ESE may be indicative of an emotional state of the user that may be associated with a certain emotion felt by the user at the time such as happiness, anger, and/or calmness, and/or indicative of level of emotional response, such as the extent of happiness felt by the user. Additionally or alternatively, a result returned by an ESE may be an affective value, for example, a value indicating how well the user feels on a scale of 1 to 10.

In some embodiments, when a predictor and/or an estimator (e.g., an ESE), is trained on data collected from multiple users, its predictions of emotional states and/or response may be considered predictions corresponding to a representative user. It is to be noted that the representative user may in fact not correspond to an actual single user, but rather correspond to an “average” of a plurality of users.

In some embodiments, a label returned by an ESE may represent an affective value. In particular, in some embodiments, a label returned by an ESE may represent an affective response, such as a value of a physiological signal (e.g., skin conductance level, a heart rate) and/or a behavioral cue (e.g., fidgeting, frowning, or blushing). In other embodiments, a label returned by an ESE may be a value representing a type of emotional response and/or derived from an emotional response. For example, the label may indicate a level of interest and/or whether the response can be classified as positive or negative (e.g., “like” or “dislike”). In another example, a label may be a value between 0 and 10 indicating a level of how much an experience was successful from a user's perspective (as expressed by the user's affective response).

In one embodiment, in addition to a measurement of affective response of a user, an ESE may receive as input a baseline affective response value corresponding to the user. Optionally, the baseline affective response value may be derived from another measurement of affective response of the user (e.g., an earlier measurement) and/or it may be a predicted value (e.g., based on measurements of other users and/or a model for baseline affective response values). Accounting for the baseline affective response value (e.g., by normalizing the measurement of affective response according to the baseline), may enable the ESE, in some embodiments, to more accurately estimate an emotional state of a user based on the measurement of affective response.

In some embodiments, an ESE may receive as part of the input (in addition to a measurement of affective response), additional information comprising feature values related to the user, experience and/or event to which the measurement corresponds. Optionally, additional information is derived from a description of an event to which the measurement corresponds.

In one embodiment, a personalized ESE for a certain user may be utilized to interpret measurements of affective response of the certain user. Optionally, the personalized ESE is utilized by a software agent operating on behalf of the certain user to better interpret the meaning of measurements of affective response of the user. For example, a personalized ESE may better reflect the personal tendencies, idiosyncrasies, unique behavioral patterns, mannerisms, and/or quirks related to how a user expresses certain emotions. By being in position in which it monitors a user over long periods of time, in different situations, and while having different experiences, a software agent may be able to observe affective responses of “its” user (the user on behalf of whom it operates) when the user expresses various emotions. Thus, the software agent can learn a model describing how the user expresses emotion, and use that model for personalized ESE that might, in some cases, “understand” its user better than a “general” ESE trained on data obtained from multiple users.

Training a personalized ESE for a user may require acquiring appropriate training samples. These samples typically comprise measurements of affective response of the user (from which feature values may be extracted) and labels corresponding to the samples, representing an emotional response the user had when the measurements were taken. Inferring what emotional state the user was in, at a certain time measurements were taken, may be done in various ways.

In one embodiment, labels representing emotional states may be self-reported by a user stating how the user feels at the time (e.g., on a scale of 1 to 10). For example, a user may declare how he or she is feeling, select an image representing the emotion, and/or provide another form of rating for his or her feelings. Optionally, the user describes his or her emotional state after being prompted to do so by the software agent. In another embodiment, labels representing emotional states may be determined by an annotator that observes the user's behavior and/or measurements of affective response of the user. Optionally, the annotator may be a software agent that utilizes one or more predictors and/or estimators, such as ESEs. In still another embodiment, labels representing emotional states may be derived from communications of the user. For example, semantic analysis may be used to determine the meaning of what the user says, writes, and/or communicates in other ways (e.g., via emojis and/or gestures).

One approach, which may be used in some embodiments, for addressing the task of obtaining labeled samples for training a personalized predictor and/or estimator is to use a form of bootstrapping. In one example, a software agent (or another module) that is tasked with training a personalized ESE for a certain user may start off by utilizing a general ESE to determine emotional states of the user. These labeled samples may be added to a pool of training samples used to train the personalized ESE. As the body of labeled samples increases in size, the estimator trained on them will begin to represent the particular characteristics of how the user expresses emotions. Eventually, after a sufficiently large body of training samples is generated, it is likely that the personalized ESE will perform better than a general ESE on the task of identifying the emotional state of the user based on measurements of the affective response of the user.

### 11—Software Agents

As used herein, “software agent” may refer to one or more computer programs that operate on behalf of an entity. For example, an entity may be a person, a group of people, an institution, a computer, and/or computer program (e.g., an artificial intelligence). Software agents may be sometimes referred to by terms including the words “virtual” and/or “digital”, such as “virtual agents”, “virtual helpers”, “digital assistants”, and the like. In this disclosure, software agents are typically referred to by the reference numeral 108, which may be used to represent the various forms of software agents described below.

In some embodiments, a software agent acting on behalf of an entity is implemented, at least in part, via a computer program that is executed with the approval of the entity. The approval to execute the computer program may be explicit, e.g., a user may initiate the execution of the program (e.g., by issuing a voice command, pushing an icon that initiates the program's execution, and/or issuing a command via a terminal and/or another form of a user interface with an operating system). Additionally or alternatively, the approval may be implicit, e.g., the program that is executed may be a service that is run by default for users who have a certain account and/or device (e.g., a service run by an operating system of the device). Optionally, explicit and/or implicit approval for the execution of the program may be given by the entity by accepting certain terms of service and/or another form of contract whose terms are accepted by the entity.

In some embodiments, a software agent operating on behalf of an entity is implemented, at least in part, via a computer program that is executed in order to advance a goal of the entity, protect an interest of the entity, and/or benefit the entity. In one example, a software agent may seek to identify opportunities to improve the well-being of the entity, such as identifying and/or suggesting activities that may be enjoyable to a user, recommending food that may be a healthy choice for the user, and/or suggesting a mode of transportation and/or route that may be safe and/or time saving for the user. In another example, a software agent may protect the privacy of the entity it operates on behalf of, for example, by preventing the sharing of certain data that may be considered private data with third parties. In another example, a software agent may assess the risk to the privacy of a user that may be associated with contributing private information of the user, such as measurements of affective response, to an outside source. Optionally, the software agent may manage the disclosure of such data, as described in more detail elsewhere in this disclosure.

In some embodiments, a software agent operating on behalf of a user, such as the software agent 108, may utilize a crowd-based result generated based on measurements of affective response of multiple users, such as the measurements 110. The crowd-based result may comprise one or more of the various types of results described in this disclosure, such as a score for an experience, a ranking of experiences, and/or parameters of a function learned based on measurements of affective response. Optionally, the crowd-based result is generated by one of the modules described herein, which utilize measurements of multiple users to compute the result, such as the scoring module 150, the ranking module 220, and/or other modules. Optionally, the software agent utilizes the crowd-based result in order to suggest an experience to the user (e.g., a vacation destination, a restaurant, or a movie to watch), enroll the user in an experience (e.g., an activity), and/or decline (on behalf of the user) participation in a certain experience. It is to be noted that, in some embodiments, the crowd-based result may be based on a measurement of affective response contributed by the user (in addition to other users), while in other embodiments, the crowd-based result may be generated based on measurements that do not include a measurement of affective response of the user.

A software agent may operate with at least some degree of autonomy, in some of the embodiments described herein, and may be capable of making decisions and/or taking actions in order to achieve a goal of the entity of behalf of whom it operates, protect an interest of the entity, and/or benefit the entity. Optionally, a computer program executed to implement the software agent may exhibit a certain degree of autonomous behavior; for example, it may perform certain operations without receiving explicit approval of the entity on behalf of whom it operates each time it performs the certain operations. Optionally, these actions fall within the scope of a protocol and/or terms of service that are approved by the entity.

A software agent may function as a virtual assistant and/or “virtual wingman” that assists a user by making decisions on behalf of a user, making suggestions to the user, and/or issuing warnings to the user. Optionally, the software agent may make the decisions, suggestions, and/or warnings based on a model of the users' biases. Optionally, the software agent may make decisions, suggestions, and/or warnings based on crowd-based scores for experiences. In one example, the software agent may suggest to a user certain experiences to have (e.g., to go biking in the park), places to visit (e.g., when on a vacation in an unfamiliar city), and/or content to select. In another example, the software agent may warn a user about situations that may be detrimental to the user or to the achievement of certain goals of the user. For example, the agent may warn about experiences that are bad according to crowd-based scores, suggest the user take a certain route to avoid traffic, and/or warn a user about excessive behavior (e.g., warn when excessive consumption of alcohol is detected when the user needs to get up early the next day). In still another example, the software agent may make decisions for the user on behalf of whom it operates and take actions accordingly, possibly without prior approval of the user. For example, the software agent may make a reservation for a user (e.g., to a restaurant), book a ticket (e.g., that involves traveling a certain route that is the fastest at the time), and/or serve as a virtual secretary, which filters certain calls to the user (e.g., sending voicemail) and allows others to get through to the user.

In some embodiments, depending on settings and/or a protocol that governs the operation of the software agent, the software agent may be active (i.e., autonomous) or passive when it comes to interacting with a user on behalf of whom it operates.

Implementation of a software agent may involve executing one or more programs on a processor that belongs to a device of a user, such as a processor of a smartphone of the user or a processor of a wearable and/or implanted device of the user. Additionally or alternatively, the implementation of a software agent may involve execution of at least one or more programs on a processor that is remote of a user, such as a processor belonging to a cloud-based server.

As befitting this day and age, users may interact with various devices and/or services that involve computers. A non-limiting list of examples may include various computers (e.g., wearables, handled devices, and/or servers on the cloud), entertainment systems (e.g., gaming systems and/or media players), appliances (e.g., connected via Internet of Things), vehicles (e.g., autonomous vehicles), and/or robots (e.g., service robots). Interacting with each of the services and/or devices may involve programs that communicate with the user and may operate on behalf of the user. As such, in some embodiments, a program involved in such an interaction is considered a software agent operating on behalf of a user. Optionally, the program may interact with the user via different interfaces and/or different devices. For example, the same software agent may communicate with a user via a robot giving the user a service, via a vehicle the user is traveling in, via a user interface of an entertainment system, and/or via a cloud-based service that utilizes a wearable display and sensors as an interface.

In some embodiments, different programs that operate on behalf of a user and share data and/or have access to the same models of the user may be considered instantiations of the same software agent. Optionally, different instantiations of a software agent may involve different methods of communication with the user. Optionally, different instantiations of a software agent may have different capabilities and/or be able to obtain data from different sources.

In some embodiments, information about events that may be used to compute scores and/or model users is provided, at least in part, by software agents operating on behalf of the users. Optionally, the software agents may operate according to a protocol set by the users and/or approved by the users. Such a protocol may govern various aspects that involve user privacy, such as aspect concerning what data is collected about a user and the user's environment, under what conditions and limitations the data is collected, how the data is stored, and/or how the data is shared with other parties and for what purposes.

In some embodiments, a software agent may provide an entity that computes scores for experiences from measurements of affective response with information related to events. Optionally, information related to an event, which is provided by the software agent, identifies at least one of the following values: the user corresponding to the event, the experience corresponding to the event, a situation the user was in when the user had the experience, and a baseline value of the user when the user had the experience. Additionally or alternatively, the software agent may provide a measurement of affective response corresponding to the event (i.e., a measurement of the user corresponding to the event to having an experience corresponding to the event, taken during the instantiation of the event or shortly after that). In some embodiments, information provided by a software agent operating on behalf of a user, which pertains to the user, may be considered part of a profile of the user.

In some embodiments, a software agent may operate based on a certain protocol that involves aspects such as the type of monitoring that may be performed by the software, the type of data that is collected, how the data is retained, and/or how it is utilized.

The protocol according to which a software agent operates may dictate various restrictions related to the monitoring of users. For example, the restrictions may dictate the identity of users that may be monitored by a software agent. In one example, an agent may be restricted to provide information only about users that gave permission for this action. Optionally, these users are considered users on behalf of whom the software agent operates.

The protocol may dictate what type of information may be provided by the software agent to another entity, such as an entity that uses the information to compute crowd-based results such as scores for experiences. For example, the software agent may be instructed to provide information related to only certain experiences. Optionally, the extent of the information the software agent monitors and/or collects might be greater than the extent of the information the software agent provides.

In some embodiments, the protocol may dictate what use may be made with the data a software agent provides. For example, what scores may be computed (e.g., what type of values), and what use may be made with the scores (e.g., are they disclosed to the public or are they restricted to certain entities such as market research firms). In other embodiments, the protocol may dictate certain policies related to data retention.

The discussion above described examples of aspects involved in a software agents operation that may be addressed by a protocol. Those skilled in the art will recognize that there may be various other aspects involving collection of data by software agents, retention of the data, and/or usage of data, that were not described above, but may be nonetheless implemented in various embodiments.

In one embodiment, the software agent provides information as a response to a request. For example, the software agent may receive a request for a measurement of the user on behalf whom it operates. In another example, the request is a general request sent to multiple agents, which specifies certain conditions.

In one embodiment, the software agent may provide information automatically. Optionally, the nature of the automatic providing of information is dictated by the policy according to which the software agent operates. In one example, the software agent may periodically provide measurements along with context information (e.g., what experience the user was having at the time and/or information related to the situation of the user at the time). In another example, the software agent provides information automatically when the user has certain types of experiences (e.g., when driving, eating, or exercising).

A software agent may be utilized for training a personalized ESE of a user on behalf of whom the software agent operates. For example, the software agent may monitor the user and at times query the user to determine how the user feels (e.g., represented by an affective value on a scale of 1 to 10). After a while, the software agent may have a model of the user that is more accurate at interpreting “its” user than a general ESE. Additionally, by utilizing a personalized ESE, the software agent may be better capable of integrating multiple values (e.g., acquired by multiple sensors and/or over a long period of time) in order to represent how the user feels at the time using a single value (e.g., an affective value on a scale of 1 to 10). For example, a personalized ESE may learn model parameters that represent weights to assign to values from different sensors and/or weights to assign to different periods in an event (e.g., the beginning, middle or end of the experience), in order to be able to produce a value that more accurately represents how the user feels (e.g., on the scale of 1 to 10). In another example, a personalized ESE may learn what weight to assign to measurements corresponding to mini-events in order to generate an affective value that best represents how the user felt to a larger event that comprises the mini-events.

Modeling users (e.g., learning various user biases) may involve, in some embodiments, accumulation of large quantities of data about users that may be considered private. Thus, some users may be reluctant to provide such information to a central entity in order to limit the ability of the central entity to model the users. Additionally, providing the information to a central entity may put private information of the users at risk due to security breaches like hacking. In such cases, users may be more comfortable, and possibly be more willing to provide data, if the modeling is done and/or controlled by them. Thus, in some embodiments, the task of modeling the users, such as learning biases of the users, may be performed, at least in part, by software agents operating on behalf of the users. Optionally, the software agent may utilize some of the approaches described above in this disclosure, to model user biases.

In some embodiments, modeling biases involves utilizing values of biases towards the quality of an experience, which may be used to correct for effects that involve the quality of the experience at a certain time. Optionally, such values are computed from measurements of affective response of multiple users (e.g., they may be crowd-based scores). Thus, in some embodiments, a software agent operating on behalf of a user may not be able to learn the user's biases towards experience quality with sufficient accuracy on its own, since it may not have access to measurements of affective response of other users. Optionally, in these embodiments, the software agent may receive values describing quality of experience from an external source, such as entity that computes scores for experiences. Optionally, the values received from the external source may enable an agent to compute a normalized measurement value from a measurement of affective response of a user to an experience. Optionally, the normalized value may better reflect the biases of the user (which are not related to the quality of the experience). Therefore, learning biases from normalized measurements may produce more accurate estimates of the user's biases. In these embodiments, knowing the score given to an experience may help to interpret the user's measurements of affective response.

The scenario described above may lead to cooperative behavior between software agents, each operating on behalf of a user, and an entity that computes scores for experiences based on measurements of affective response of the multiple users on behalf of whom the agents operate. In order to compute more accurate scores, it may be preferable, in some embodiments, to remove certain biases from the measurements of affective response used to compute the score. This task may be performed by a software agents, which can utilize a model of a user on behalf of whom it operates, in order to generate an unbiased measurement of affective response for an experience. However, in order to better model the user, the software agent may benefit from receiving values of the quality of experiences to which the measurements correspond. Thus, in some embodiments, there is a “give and take” reciprocal relationship between software agents and an entity that computes scores, in which the software agents provide measurements of affective response from which certain (private) user biases were removed. The entity that computes the score utilizes those unbiased measurements to produce a score that is not affected by some of the users' biases (and as such, better represents the quality of the experience). This score, which is computed based on measurements of multiple users is provided back to the agents in the form of an indicator of the quality of the experience the user had, which in turn may be used by the software agents to better model the users. Optionally, this process may be repeated multiple times in order to refine the user models (e.g., to obtain more accurate values of user biases held by the agents), and in the same time compute more accurate scores. Thus, the joint modeling of users and experiences may be performed in a distributed way in which the private data of individual users is not stored together and/or exposed to a central entity.

### 12—Crowd-Based Applications

Various embodiments described herein utilize systems whose architecture includes a plurality of sensors and a plurality of user interfaces. This architecture supports various forms of crowd-based recommendation systems in which users may receive information, such as suggestions and/or alerts, which are determined based on measurements of affective response collected by the sensors. In some embodiments, being crowd-based means that the measurements of affective response are taken from a plurality of users, such as at least three, ten, one hundred, or more users. In such embodiments, it is possible that the recipients of information generated from the measurements may not be the same users from whom the measurements were taken.

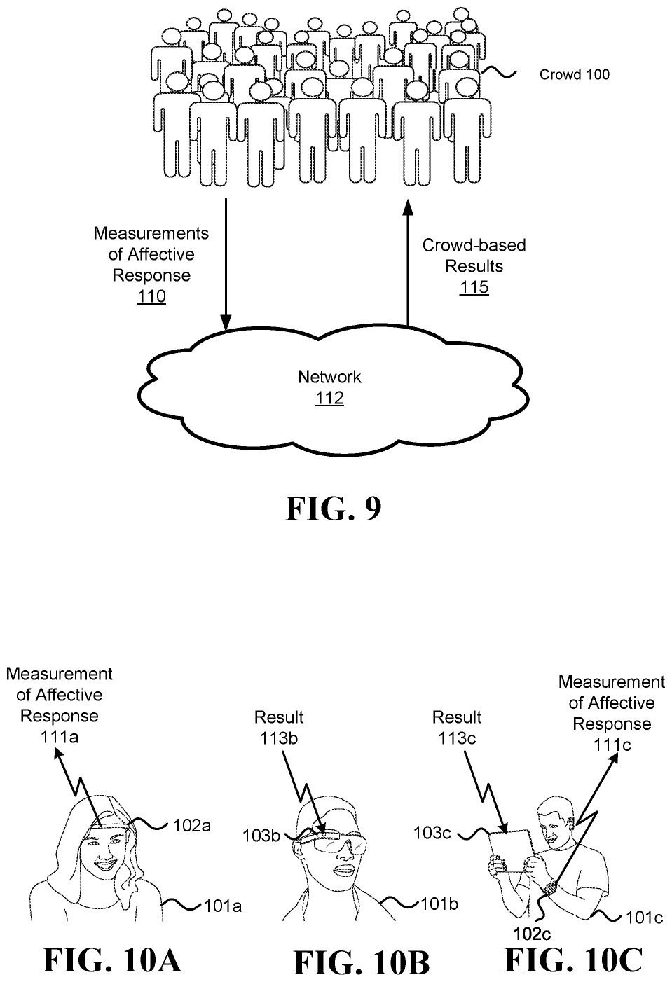

FIG. 9 illustrates one embodiment of an architecture that includes sensors and user interfaces, as described above. The crowd 100 of users comprises at least some individual users with sensors coupled to them. For example, FIG. 10A and FIG. 10C illustrate cases in which a sensor is coupled to a user. The sensors take the measurements 110 of affective response, which are transmitted via a network 112. Optionally, the measurements 110 are sent to one or more servers that host modules belonging to one or more of the systems described in various embodiments in this disclosure (e.g., systems that compute scores for experiences, rank experiences, generate alerts for experiences, and/or learn parameters of functions that describe affective response).

A plurality of sensors may be used, in various embodiments described herein, to take the measurements of affective response of the plurality of users. Each of the plurality of sensors (e.g., the sensor 102a) may be a sensor that captures a physiological signal and/or a behavioral cue. Optionally, a measurement of affective response of a user is typically taken by a specific sensor related to the user (e.g., a sensor attached to the body of the user and/or embedded in a device of the user). Optionally, some sensors may take measurements of more than one user (e.g., the sensors may be cameras taking images of multiple users). Optionally, the measurements taken of each user are of the same type (e.g., the measurements of all users include heart rate and skin conductivity measurements). Optionally, different types of measurements may be taken from different users. For example, for some users the measurements may include brainwave activity captured with EEG and heart rate, while for other users the measurements may include only heart rate values.

The network 112 represents one or more networks used to carry the measurements 110 and/or crowd-based results 115 computed based on measurements. It is to be noted that the measurements 110 and/or crowd-based results 115 need not be transmitted via the same network components. Additionally, different portions of the measurements 110 (e.g., measurements of different individual users) may be transmitted using different network components or different network routes. In a similar fashion, the crowd-based results 115 may be transmitted to different users utilizing different network components and/or different network routes.

Herein, a network, such as the network 112, may refer to various types of communication networks, including, but not limited to, a local area network (LAN), a wide area network (WAN), Ethernet, intranet, the Internet, a fiber communication network, a wired communication network, a wireless communication network, and/or a combination thereof.

In some embodiments, the measurements 110 of affective response are transmitted via the network 112 to one or more servers. Each of the one or more servers includes at least one processor and memory. Optionally, the one or more servers are cloud-based servers. Optionally, some of the measurements 110 are stored and transmitted in batches (e.g., stored on a device of a user being measured). Additionally or alternatively, some of the measurements are broadcast within seconds of being taken (e.g., via Wi-Fi transmissions). Optionally, some measurements of a user may be processed prior to being transmitted (e.g., by a device and/or software agent of the user). Optionally, some measurements of a user may be sent as raw data, essentially in the same form as received from a sensor used to measure the user. Optionally, some of the sensors used to measure a user may include a transmitter that may transmit measurements of affective response, while others may forward the measurements to another device capable of transmitting them (e.g., a smartphone belonging to a user).

Depending on the embodiment being considered, the crowd-based results 115 may include various types of values that may be computed by systems described in this disclosure based on measurements of affective response. For example, the crowd-based results 115 may refer to scores for experiences (e.g., score 164), notifications about affective response to experiences (e.g., notification 188 or notification 210), recommendations regarding experiences (e.g., recommendation 179 or recommendation 215), and/or various rankings of experiences (e.g., ranking 232, ranking 254). Additionally or alternatively, the crowd-based results 115 may include, and/or be derived from, parameters of various functions learned from measurements (e.g., function parameters 288, aftereffect scores 294, function parameters 317, or function parameters 326, to name a few).

In some embodiments, the various crowd-based results described above and elsewhere in this disclosure, may be presented to users (e.g., through graphics and/or text on display, or presented by a software agent via a user interface). Additionally or alternatively, the crowd-based results may serve as an input to software systems (e.g., software agents) that make decisions for a user (e.g., what experiences to book for the user and/or suggest to the user). Thus, crowd-based results computed in embodiments described in this disclosure may be utilized (indirectly) by a user via a software agent operating on behalf of a user, even if the user does not directly receive the results or is even aware of their existence.

In some embodiments, the crowd-based results 115 that are computed based on the measurements 110 include a single value or a single set of values that is provided to each user that receives the results 115. In such a case, the crowd-based results 115 may be considered general crowd-based results, since each user who receives a result computed based on the measurements 110 receives essentially the same thing. In other embodiments, the crowd-based results 115 that are computed based on the measurements 110 include various values and/or various sets of values that are provided to users that receive the crowd-based results 115. In this case, the results 115 may be considered personalized crowd-based results, since a user who receives a result computed based on the measurements 110 may receive a result that is different from the result received by another user. Optionally, personalized results are obtained utilizing an output produced by personalization module 130.

An individual user 101, belonging to the crowd 100, may contribute a measurement of affective response to the measurements 110 and/or may receive a result from among the various types of the crowd-based results 115 described in this disclosure. This may lead to various possibilities involving what users contribute and/or receive in an architecture of a system such as the one illustrated in FIG. 9.

In some embodiments, at least some of the users from the crowd 100 contribute measurements of affective response (as part of the measurements 110), but do not receive results computed based on the measurements they contributed. An example of such a scenario is illustrated in FIG. 10A, where a user 101a is coupled to a sensor 102a (which in this illustration measures brainwave activity via EEG) and contributes a measurement 111a of affective response, but does not receive a result computed based on the measurement 111a.

In a somewhat reverse situation to the one described above, in some embodiments, at least some of the users from the crowd 100 receive a result from among the crowd-based results 115, but do not contribute any of the measurements of affective response used to compute the result they receive. An example of such a scenario is illustrated in FIG. 10B, where a user 101b is coupled to a user interface 103b (which in this illustration are augmented reality glasses) that presents a result 113b, which may be, for example, a score for an experience. However, in this illustration, the user 101b does not provide a measurement of affective response that is used for the generation of the result 113b.

And in some embodiments, at least some of the users from the crowd 100 contribute measurements of affective response (as part of the measurements 110), and receive a result, from among the crowd-based results 115, computed based on the measurements they contributed. An example of such a scenario is illustrated in FIG. 10C, where a user 101c is coupled to a sensor 102c (which in this illustration is a smartwatch that measures heart rate and skin conductance) and contributes a measurement 111c of affective response. Additionally, the user 101c has a user interface 103c (which in this illustration is a tablet computer) that presents a result 113c, which may be for example a ranking of multiple experiences generated utilizing the measurement 111c that the user 101c provided.

A “user interface”, as the term is used in this disclosure, may include various components that may be characterized as being hardware, software, and/or firmware. In some examples, hardware components may include various forms of displays (e.g., screens, monitors, virtual reality displays, augmented reality displays, hologram displays), speakers, scent generating devices, and/or haptic feedback devices (e.g., devices that generate heat and/or pressure sensed by the user). In other examples, software components may include various programs that render images, video, maps, graphs, diagrams, augmented annotations (to appear on images of a real environment), and/or video depicting a virtual environment. In still other examples, firmware may include various software written to persistent memory devices, such as drivers for generating images on displays and/or for generating sound using speakers. In some embodiments, a user interface may be a single device located at one location, e.g., a smart phone and/or a wearable device. In other embodiments, a user interface may include various components that are distributed over various locations. For example, a user interface may include both certain display hardware (which may be part of a device of the user) and certain software elements used to render images, which may be stored and run on a remote server.

It is to be noted that, though FIG. 10A to FIG. 10C illustrate cases in which users have a single sensor device coupled to them and/or a single user interface, the concepts described above in the discussion about FIG. 10A to FIG. 10C may be naturally extended to cases where users have multiple sensors coupled to them (of the various types described in this disclosure or others) and/or multiple user interfaces (of the various types described in this disclosure or others).

Additionally, it is to be noted that users may contribute measurements at one time and receive results at another (which were not computed from the measurements they contributed). Thus, for example, the user 101a in FIG. 10A might have contributed a measurement to compute a score for an experience on one day, and received a score for that experience (or another experience) on her smartwatch (not depicted) on another day. Similarly, the user 101b in FIG. 10B may have sensors embedded in his clothing (not depicted) and might be contributing measurements of affective response to compute a score for an experience the user 101b is having, while the result 113b that the user 101b received, is not based on any of the measurements the user 101b is currently contributing.

In this disclosure, a crowd of users is often designated by the reference numeral 100. The reference numeral 100 is used to designate a general crowd of users. Typically, a crowd of users in this disclosure includes at least three users, but may include more users. For example, in different embodiments, the number of users in the crowd 100 falls into one of the following ranges: 3 to 9, 10 to 24, 25-99, 100-999, 1000-9999, 10000-99999, 100000-1000000, and more than one million users. Additionally, the reference numeral 100 is used to designate users having a general experience, which may involve one or more instances of the various types of experiences described in this disclosure. For example, the crowd 100 may include users that are at a certain location, users engaging in a certain activity, and/or users utilizing a certain product.

When a crowd is designated with another reference numeral (other than 100), this typically signals that the crowd has a certain characteristic. A different reference numeral for a crowd may be used when describing embodiments that involve specific experiences. For example, in an embodiment that describes a system that ranks experiences, the crowd may be referred to by the reference numeral 100. However, in an embodiment that describes ranking of locations, the crowd may be designated by another reference numeral, since in this embodiment, the users in the crowd have a certain characteristic (they are at locations), rather than being a more general crowd of users who are having one or more experiences, which may be any of the experiences described in this disclosure.

In a similar fashion, measurements of affective response are often designated by the reference numeral 110. The reference numeral 110 is used to designate measurements of affective response of users belonging to the crowd 100. Thus, the reference numeral 110 is typically used to designate measurements of affective response in embodiments that involve users having one or more experiences, which may possibly be any of the experiences described in this disclosure.

The user interfaces are configured to receive data, via the network 112, describing the score computed based on the measurements 110. Optionally, the score 164 represents the affective response of the at least ten users to having the certain experience. The user interfaces are configured to report the score to at least some of the users belonging to the crowd 100. Optionally, at least some users who are reported the score 164 via user interfaces are users who contributed measurements to the measurements 110 which were used to compute the score 164. Optionally, at least some users who are reported the score 164 via user interfaces are users who did not contribute to the measurements 110. It is to be noted that stating that a score is computed based on measurements, such as the statement above mentioning “the score computed based on the measurements 110”, is not meant to imply that all of the measurements 110 are used in the computation of the score. When a score is computed based on measurements it means that at least some of the measurements, but not necessarily all of the measurements, are used to compute the score.

Reporting a result computed based on measurements of affective response, such as the score 164, via a user interface may be done in various ways in different embodiments. In one embodiment, the score is reported by presenting, on a display of a device of a user (e.g., a smartphone's screen, augmented reality glasses) an indication of the score 164 and/or the certain experience. For example, the indication may be a numerical value, a textual value, an image, and/or video. Optionally, the indication is presented as an alert issued if the score reaches a certain threshold. Optionally, the indication is given as a recommendation generated by a recommender module such as the recommender module 178. In another embodiment, the score 164 may be reported via a voice signal and/or a haptic signal (e.g., via vibrations of a device carried by the user). In some embodiments, reporting the score 164 to a user is done by a software agent operating on behalf of the user, which communicates with the user via a user interface.

In some embodiments, along with presenting information, e.g. about a score such as the score 164, the user interfaces may present information related to the significance of the information, such as a significance level (e.g., p-value, q-value, or false discovery rate), information related to the number of users and/or measurements (the sample size) which were used for determining the information, and/or confidence intervals indicating the variability of the data.

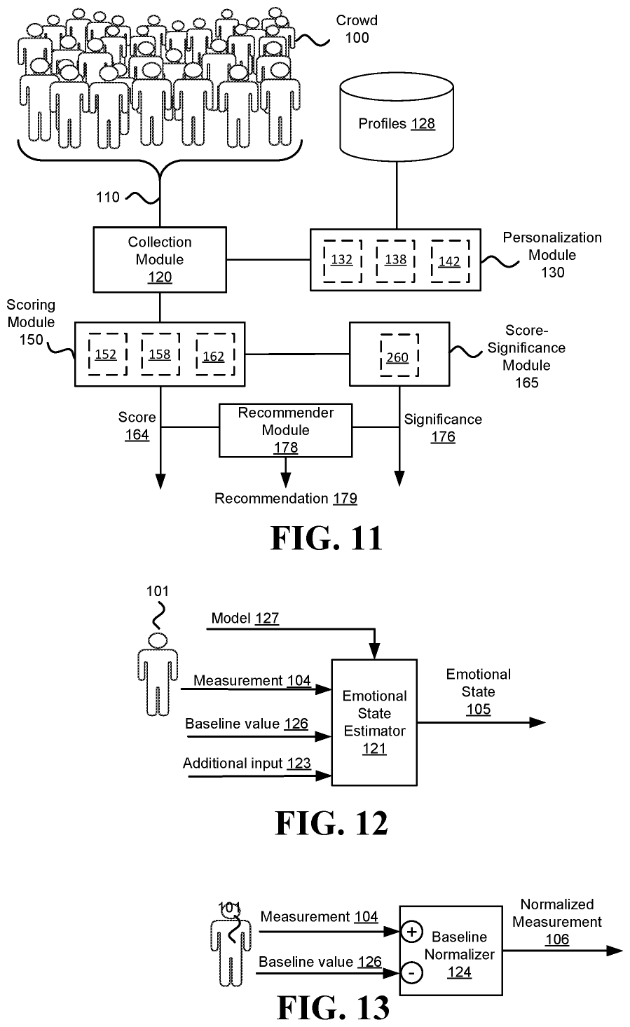

FIG. 11 illustrates a system configured to compute scores for experiences. The system illustrated in FIG. 11 is an exemplary embodiment of a system that may be utilized to compute crowd-based results 115 from the measurements 110, as illustrated in FIG. 9. While the system illustrated in FIG. 11 describes a system that computes scores for experiences, the teachings in the following discussion, in particular the roles and characteristics of various modules, may be relevant to other embodiments described herein involving generation of other types of crowd-based results (e.g., ranking, alerts, and/or learning parameters of functions).

In one embodiment, a system that computes a score for an experience, such as the one illustrated in FIG. 11, includes at least a collection module (e.g., collection module 120) and a scoring module (e.g., scoring module 150). Optionally, such a system may also include additional modules such as the personalization module 130, score-significance module 165, and/or recommender module 178. The illustrated system includes modules that may optionally be found in other embodiments described in this disclosure. This system, like other systems described in this disclosure, includes at least a memory 402 and a processor 401. The memory 402 stores computer executable modules described below, and the processor 401 executes the computer executable modules stored in the memory 402.

The collection module 120 is configured to receive the measurements 110. Optionally, at least some of the measurements 110 may be processed in various ways prior to being received by the collection module 120. For example, at least some of the measurements 110 may be compressed and/or encrypted.

The collection module 120 is also configured to forward at least some of the measurements 110 to the scoring module 150. Optionally, at least some of the measurements 110 undergo processing before they are received by the scoring module 150. Optionally, at least some of the processing is performed via programs that may be considered software agents operating on behalf of the users who provided the measurements 110.

The scoring module 150 is configured to receive at least some of the measurements 110 of affective response from the crowd 100 of users, and to compute a score 164 based on the measurements 110. At least some of the measurements 110 may correspond to a certain experience, i.e., they are measurements of at least some of the users from the crowd 100 taken in temporal proximity to when those users had the certain experience and represent the affective response of those users to the certain experience. Herein “temporal proximity” means nearness in time. For example, at least some of the measurements 110 are taken while users are having the certain experience and/or shortly after that. Additional discussion of what constitutes “temporal proximity” may be found at least in section 6—Measurements of Affective Response.

A scoring module, such as scoring module 150, may utilize one or more types of scoring approaches that may optionally involve one more other modules. In one example, the scoring module 150 utilizes modules that perform statistical tests on measurements in order to compute the score 164, such as statistical test module 152 and/or statistical test module 158. In another example, the scoring module 150 utilizes arithmetic scorer 162 to compute the score 164.

In one embodiment, the score 164 may be provided to the recommender module 178, which may utilize the score 164 to generate recommendation 179, which may be provided to a user (e.g., by presenting an indication regarding the experience on a user interface used by the user). Optionally, the recommender module 178 is configured to recommend the experience for which the score 164 is computed, based on the value of the score 164, in a manner that belongs to a set comprising first and second manners, as described below. When the score 164 reaches a threshold, the experience is recommended in the first manner, and when the score 164 does not reach the threshold, the experience is recommended in the second manner, which involves a weaker recommendation than a recommendation given when recommending in the first manner.

References to a “threshold” herein typically relate to a value to which other values may be compared. For example, in this disclosure scores are often compared to threshold in order to determine certain system behavior (e.g., whether to issue a notification or not based on whether a threshold is reached). When a threshold's value has a certain meaning it may be given a specific name based on the meaning. For example, a threshold indicating a certain level of satisfaction of users may be referred to as a “satisfaction-threshold” or a threshold indicating a certain level of well-being of users may be referred to as “wellness-threshold”, etc.

Usually, a threshold is considered to be reached by a value if the value equals the threshold or exceeds it. Similarly, a value does not reach the threshold (i.e., the threshold is not reached) if the value is below the threshold. However, some thresholds may behave the other way around, i.e., a value above the threshold is considered not to reach the threshold, and when the value equals the threshold, or is below the threshold, it is considered to have reached the threshold. The context in which the threshold is presented is typically sufficient to determine how a threshold is reached (i.e., from below or above). In some cases when the context is not clear, what constitutes reaching the threshold may be explicitly stated. Typically, but not necessarily, if reaching a threshold involves having a value lower than the threshold, reaching the threshold will be described as “falling below the threshold”.

Herein, any reference to a “threshold” or to a certain type of threshold (e.g., satisfaction-threshold, wellness-threshold, and the like), may be considered a reference to a “predetermined threshold”. A predetermined threshold is a fixed value and/or a value determined at any time before performing a calculation that compares a score with the predetermined threshold. Furthermore, a threshold may also be considered a predetermined threshold when the threshold involves a value that needs to be reached (in order for the threshold to be reached), and logic used to compute the value is known before starting the computations used to determine whether the value is reached (i.e., before starting the computations to determine whether the predetermined threshold is reached). Examples of what may be considered the logic mentioned above include circuitry, computer code, and/or steps of an algorithm.

In one embodiment, the manner in which the recommendation 179 is given may also be determined based on a significance computed for the score 164, such as significance 176 computed by score-significance module 165. Optionally, the significance 176 refers to a statistical significance of the score 164, which is computed based on various characteristics of the score 164 and/or the measurements used to compute the score 164. Optionally, when the significance 176 is below a predetermined significance level (e.g., a p-value that is above a certain value) the recommendation is made in the second manner.

A recommender module, such as the recommender module 178 or other recommender modules described in this disclosure (e.g., recommender modules designated by reference numerals 214, 235, 267, 343, or others), is a module that is configured to recommend an experience based on the value of a crowd-based result computed for the experience. For example, recommender module 178 is configured to recommend an experience based on a score computed for the experience based on measurements of affective response of users who had the experience.

Depending on the value of the crowd-based result computed for an experience, a recommender module may recommend the experience in various manners. In particular, the recommender module may recommend an experience in a manner that belongs to a set including first and second manners. Typically, in this disclosure, when a recommender module recommends an experience in the first manner, the recommender provides a stronger recommendation for the experience, compared to a recommendation for the experience that the recommender module provides when recommending in the second manner. Typically, if the crowd-based result indicates a sufficiently strong (or positive) affective response to an experience, the experience is recommended the first manner. Optionally, if the result indicates a weaker affective response to an experience, which is not sufficiently strong (or positive), the experience is recommended in the second manner.

In some embodiments, a recommender module, such as the recommender module 178, is configured to recommend an experience via a display of a user interface. In such embodiments, recommending an experience in the first manner may involve one or more of the following: (i) utilizing a larger icon to represent the experience on a display of the user interface, compared to the size of the icon utilized to represent the experience on the display when recommending in the second manner; (ii) presenting images representing the experience for a longer duration on the display, compared to the duration during which images representing the experience are presented when recommending in the second manner; (iii) utilizing a certain visual effect when presenting the experience on the display, which is not utilized when presenting the experience on the display when recommending the experience in the second manner; and (iv) presenting certain information related to the experience on the display, which is not presented when recommending the experience in the second manner.

In some embodiments, a recommender module, such as the recommender module 178, is configured to recommend an experience to a user by sending the user a notification about the experience. In such embodiments, recommending an experience in the first manner may involve one or more of the following: (i) sending the notification to a user about the experience at a higher frequency than the frequency the notification about the experience is sent to the user when recommending the experience in the second manner; (ii) sending the notification to a larger number of users compared to the number of users the notification is sent to when recommending the experience in the second manner; and (iii) on average, sending the notification about the experience sooner than it is sent when recommending the experience in the second manner.

In some embodiments, significance of a score, such as the score 164, may be computed by the score-significance module 165. Optionally, significance of a score, such as the significance 176 of the score 164, may represent various types of values derived from statistical tests, such as p-values, q-values, and false discovery rates (FDRs). Additionally or alternatively, significance may be expressed as ranges, error-bars, and/or confidence intervals.

### 13—Collecting Measurements

Various embodiments described herein include a collection module, such as the collection module 120, which is configured to receive measurements of affective response of users. In embodiments described herein, measurements received by the collection module, which may be the measurements 110 and/or measurements of affective response designated by another reference numeral (e.g., the measurements 501, 1501, 2501, or 3501), may be forwarded to other modules to produce a crowd-based result (e.g., scoring module 150, ranking module 220, function learning module 280, and the like).

The collection module 120 may receive and/or provide to other modules measurements collected over various time frames. For example, in some embodiments, measurements of affective response provided by the collection module to other modules (e.g., scoring module 150, ranking module 220, etc.), are taken over a certain period that extends for at least an hour, a day, a month, or at least a year. For example, when the measurements extend for a period of at least a day, they include at least a first measurement and a second measurement, such that the first measurement is taken at least 24 hours before the second measurement is taken. In other embodiments, at least a certain portion of the measurements of affective response utilized by one of the other modules to compute crowd-based results are taken within a certain period of time. For example, the certain portion may include times at which at least 25%, at least 50%, or at least 90% of the measurements were taken. Furthermore, in this example, the certain period of time may include various windows of time, spanning periods such as at most one minute, at most 10 minutes, at most 30 minutes, at most an hour, at most 4 hours, at most a day, or at most a week.

In some embodiments, the collection module 120 may be considered a module that organizes and/or pre-processes measurements to be used for computing crowd-based results. Optionally, the collection module 120 has an interface that allows other modules to request certain types of measurements, such as measurements involving users who had a certain experience, measurements of users who have certain characteristics (e.g., certain profile attributes), measurements taken during certain times, and/or measurements taken utilizing certain types of sensors and/or operation parameters. Optionally, the collection module 120 may be implemented as a module and/or component of other modules described in this disclosure, such as scoring modules and/ranking modules. For example, in some embodiments, when measurements of affective response are forwarded directly to a module that computes a score or some other crowd-based result, the interface of that module that receives the measurements may be considered to be the collection module 120 or to be part of the collection module 120.

There are various ways in which the collection module may receive the measurements of affective response. Following are some examples of approaches that may be implemented in embodiments described herein.

In one embodiment, the collection module receives at least some of the measurements directly from the users of whom the measurements are taken. In one example, the measurements are streamed from devices of the users as they are acquired (e.g., a user's smartphone may transmit measurements acquired by one or more sensors measuring the user). In another example, a software agent operating on behalf of the user may routinely transmit descriptions of events, where each event includes a measurement and a description of a user and/or an experience the user had.

In another embodiment, the collection module is configured to retrieve at least some of the measurements from one or more databases that store measurements of affective response of users. Optionally, the one or more databases are part of the collection module. In one example, the one or more databases may involve distributed storage (e.g., cloud-based storage). In another example, the one or more databases may involve decentralized storage (e.g., utilizing blockchain-based systems). Optionally, the collection module submits to the one or more databases queries involving selection criteria which may include: a type of an experience, a location the experience took place, a timeframe during which the experience took place, an identity of one or more users who had the experience, and/or one or more characteristics corresponding to the users or to the experience. Optionally, the measurements comprise results returned from querying the one or more databases with the queries.

In yet another embodiment, the collection module is configured to receive at least some of the measurements from software agents operating on behalf of the users of whom the measurements are taken. In one example, the software agents receive requests for measurements corresponding to events having certain characteristics. Based on the characteristics, a software agent may determine whether the software agent has, and/or may obtain, data corresponding to events that are relevant to the query.

After receiving a request, a software agent operating on behalf of a user may determine whether to provide information to the collection module and/or to what extent to provide information to the collection module.

A software agent may provide data in various forms. In one embodiment, the software agent may provide raw measurement values. Additionally or alternatively, the software agent may provide processed measurement values, processed in one or more ways as explained above. In some embodiments, in addition to measurements, the software agent may provide information related to events corresponding to the measurements, such as characteristics of the user corresponding to an event, characteristics of the experience corresponding to the event, and/or specifics of the instantiation of the event.

In one embodiment, providing measurements by a software agent involves transmitting, by a device of the user, measurements and/or other related data to the collection module. For example, the transmitted data may be stored on a device of a user (e.g., a smartphone or a wearable computer device). In another embodiment, providing measurements by a software agent involves transmitting an address, an authorization code, and/or an encryption key that may be utilized by the collection module to retrieve data stored in a remote location, and/or with the collection module. In yet another embodiment, providing measurements by the software agent may involve transmitting instructions to other modules or entities that instruct them to provide the collection module with the measurements.

FIG. 12 illustrates one embodiment of the Emotional State Estimator (ESE) 121. In FIG. 12, the user 101 provides a measurement 104 of affective response to the ESE 121. Optionally, the ESE 121 may receive other inputs such as a baseline affective response value 126 and/or additional inputs 123 which may include contextual data about the measurement e.g., a situation the user was in at the time and/or contextual information about the experience to which the measurement 104 corresponds. Optionally, the ESE 121 may utilize model 127 in order to estimate the emotional state 105 of the user 101 based on the measurement 104. Optionally, the model 127 is a general model, e.g., which is trained on data collected from multiple users. Alternatively, the model 127 may be a personal model of the user 101, e.g., trained on data collected from the user 101. Additional information regarding how emotional states may be estimated and/or represented as affective values may be found in this disclosure at least in Section 6—Measurements of Affective Response.

FIG. 13 illustrates one embodiment of the baseline normalizer 124. In this embodiment, the user 101 provides a measurement 104 of affective response and the baseline affective response value 126, and the baseline normalizer 124 computes the normalized measurement 106.

In one embodiment, normalizing a measurement of affective response utilizing a baseline affective response value involves subtracting the baseline affective response value from the measurement. Thus, after normalizing with respect to the baseline, the measurement becomes a relative value, reflecting a difference from the baseline. In another embodiment, normalizing a measurement with respect to a baseline involves computing a value based on the baseline and the measurement such as an average of both (e.g., geometric or arithmetic average).

In some embodiments, a baseline affective response value of a user refers to a value that may represent an affective response of the user under typical conditions. Optionally, a baseline affective response value of a user, that is relevant to a certain time, is obtained utilizing one or more measurements of affective response of the user taken prior to a certain time. For example, a baseline corresponding to a certain time may be based on measurements taken during a window spanning a few minutes, hours, or days prior to the certain time. Additionally or alternatively, a baseline affective response value of a user may be predicted utilizing a model trained on measurements of affective response of the user and/or other users. In some embodiments, a baseline affective response value may correspond to a certain situation, and represent a typical affective response of a user when in the certain situation. Additional discussion regarding baselines, how they are computed, and how they may be utilized may be found in section 6—Measurements of Affective Response, and elsewhere in this disclosure.

In some embodiments, processing of measurements of affective response, performed by the software agent 108 and/or the collection module 120, may involve weighting and/or selection of the measurements. For example, at least some of the measurements 110 may be weighted such that the measurements of each user have the same weight (e.g., so as not to give a user with many measurements more influence on the computed score). In another example, measurements are weighted according to the time they were taken, for instance, by giving higher weights to more recent measurements (thus enabling a result computed based on the measurements 110 to be more biased towards the current state rather than an historical one). Optionally, measurements with a weight that is below a threshold and/or have a weight of zero, are not forwarded to other modules in order to be utilized for computing crowd-based results.

### 14—Scoring

Various embodiments described herein may include a module that computes a score for an experience based on measurements of affective response of users who had the experience (e.g., the measurements may correspond to events in which users have the experience). Examples of scoring modules include scoring module 150, dynamic scoring module 180, and aftereffect scoring module 302.

When measurements of affective response correspond to a certain experience, e.g., they are taken while and/or shortly after users have the certain experience, a score computed based on the measurements may be indicative of an extent of the affective response users had to the certain experience. For example, measurements of affective response of users taken while the users were at a certain location may be used to compute a score that is indicative of the affective response of the users to being in the certain location. Optionally, the score may be indicative of the quality of the experience and/or of the emotional response users had to the experience (e.g., the score may express a level of enjoyment from having the experience).

In one embodiment, a score for an experience that is computed by a scoring module, such as the score 164, may include a value representing a quality of the experience as determined based on the measurements 110. Optionally, the score includes a value that is at least one of the following: a physiological signal, a behavioral cue, an emotional state, and an affective value. Optionally, the score includes a value that is a function of measurements of at least five users. Optionally, the score is indicative of the significance of a hypothesis that the at least five users had a certain affective response. In one example, the certain affective response is manifested through changes to values of at least one of the following: measurements of physiological signals, and measurements of behavioral cues.

In one embodiment, a score for an experience that is computed based on measurements of affective response is a statistic of the measurements. For example, the score may be the average, mean, and/or mode of the measurements. In other examples, the score may take the form of other statistics, such as the value of a certain percentile when the measurements are ordered according to their values.

In another embodiment, a score for an experience that is computed from measurements of affective response is computed utilizing a function that receives an input comprising the measurements of affective response, and returns a value that depends, at least to some extent, on the value of the measurements. Optionally, the function according to which the score is computed may be non-trivial in the sense that it does not return the same value for all inputs. Thus, it may be assumed that a score computed based on measurements of affective response utilizes at least one function for which there exist two different sets of inputs comprising measurements of affective response, such that the function produces different outputs for each set of inputs. Depending on the characteristics of the embodiments, various functions may be utilized to compute scores from measurements of affective response; the functions may range from simple statistical functions, as mentioned above, to various arbitrary arithmetic functions (e.g., geometric or harmonic means), and possibly complex functions that involve statistical tests such as likelihood ratio test, computations of p-values, and/or other forms of statistical significance.

In yet another embodiment, a function used to compute a score for an experience based on measurements of affective response involves utilizing a machine learning-based predictor that receives as input measurements of affective response and returns a result that may be interpreted as a score. The objective (target value) computed by the predictor may take various forms, possibly extending beyond values that may be interpreted as directly stemming from emotional responses, such as a degree the experience may be considered “successful” or “profitable”.

In one embodiment, a score for an experience that is computed based on measurements of affective response is obtained by providing the measurements as input to a computer program that may utilize the measurements and possibly other information in order to generate an output that may be utilized, possibly after further processing, in order to generate the score. Optionally, the other information may include information related to the users from whom the measurements were taken and/or related to the events to which the measurements correspond. Optionally, the computer program may be run as an external service, which is not part of the system that utilizes the score. Thus, the system may utilize the score without possessing the actual logic and/or all the input values used to generate the score. For example, the score may be generated by an external “expert” service that has proprietary information about the users and/or the events, which enables it to generate a value that is more informative about the affective response to an experience to which the measurements correspond.

Scores computed based on measurements of affective response may represent different types of values. The type of value a score represents may depend on various factors such as the type of measurements of affective response used to compute the score, the type of experience corresponding to the score, the application for which the score is used, and/or the user interface on which the score is to be presented.

In one embodiment, a score for an experience that is computed from measurements of affective response may be expressed in the same units as the measurements. Furthermore, a score for an experience may be expressed as any type of affective value that is described herein. In one example, the measurements may represent a level of happiness, and the score too may represent a level of happiness, such as the average of the measurements. In another example, if the measurements represent sizes or extents of smiles of users, the score too may represent a size of a smile, such as the median size of smile determined from the measurements. In still another example, if the measurements represent a physiological value, such as heart rates (or changes to heart rates), the score too may be expressed in the same terms (e.g., it may be the average change in the users' heart rates).

In another embodiment, a score for an experience may be expressed in units that are different from the units in which the measurements of affective response used to compute it are expressed. Optionally, the different units may represent values that do not directly convey an affective response (e.g., a value indicating qualities such as utility, profit, and/or a probability). Optionally, the score may represent a numerical value corresponding to a quality of an experience (e.g., a value on a scale of 1 to 10, or a rating of 1 to 5 stars). Optionally, the score may represent a numerical value representing a significance of a hypothesis about the experience (e.g., a p-value of a hypothesis that the measurements of users who had the experience indicate that they enjoyed the experience).

In yet another embodiment, a score for an experience may represent a typical and/or average extent of an emotional response of the users who contributed measurements used to compute the score. Optionally, the emotional response corresponds to an increase or decrease in the level of at least one of the following: pain, anxiety, annoyance, stress, aggression, aggravation, fear, sadness, drowsiness, apathy, anger, happiness, contentment, calmness, attentiveness, affection, and excitement.

In some embodiments, a measurement of affective response of a user that is used to compute a crowd-based result corresponding to the experience (e.g., a score for an experience or a ranking of experiences) may be considered “contributed” by the user to the computation of the crowd-based result. Similarly, in some embodiments, a user whose measurement of affective response is used to compute a crowd-based result may be considered as a user who contributed the measurement to the result. Optionally, the contribution of a measurement may be considered an action that is actively performed by the user (e.g., by prompting a measurement to be sent) and/or passively performed by the user (e.g., by a device of the user automatically sending data that may also be collected automatically). Optionally, the contribution of a measurement by a user may be considered an action that is done with the user's permission and/or knowledge (e.g., the measurement is taken according to a policy approved by the user), but possibly without the user being aware that it is done. For example, a measurement of affective response may be taken in a manner approved by the user, e.g., the measurement may be taken according to certain terms of use of a device and/or service that were approved by the user, and/or the measurement is taken based on a configuration or instruction of the user. Furthermore, even though a user may not be consciously aware that the measurement was taken, used for the computation of a crowd-based result like a score, and/or that the result was disclosed, in some embodiments, that measurement of affective response is considered contributed by the user.

Disclosing a crowd-based result such as a score for an experience may involve, in some embodiments, providing information about the result to a third party, such as a value of a score, and/or a statistic computed from the result (e.g., an indication of whether a score reaches a certain threshold). Optionally, a score for an experience that is disclosed to a third party or likely to be disclosed to a third party may be referred to as a “disclosed score”, a “disclosed crowd-based score”, and the like. Optionally, disclosing a crowd-based result may be referred herein as “forwarding” the result. For example, disclosing a score for an experience may be referred to herein as “forwarding” the score. Optionally, a “third party” may refer to any entity that does not have the actual values of measurements of affective response used to compute a crowd-based result from the measurements.

In addition to providing a value corresponding to a crowd-based result such as a score for an experience, or instead of providing the value, in some embodiments, disclosing the result may involve providing information related to the crowd-based result and/or the computation of the crowd-based result. In one example, this information may include one or more of the measurements of affective response used to compute the crowd-based result, and/or statistics related to the measurements (e.g., the number of users whose measurements were used, or the mean and/or variance of the measurements). In another example, the information may include data identifying one or more of the users who contributed measurements of affective response used to compute the crowd-based result and/or statistics about those users (e.g., the number of users, and/or a demographic breakdown of the users).

In order to compute a score, scoring modules may utilize various types of scoring approaches. One example of a scoring approach involves generating a score from a statistical test, such as the scoring approach used by the statistical test module 152 and/or statistical test module 158. Another example of a scoring approach involves generating a score utilizing an arithmetic function, such as a function that may be employed by the arithmetic scorer 162.

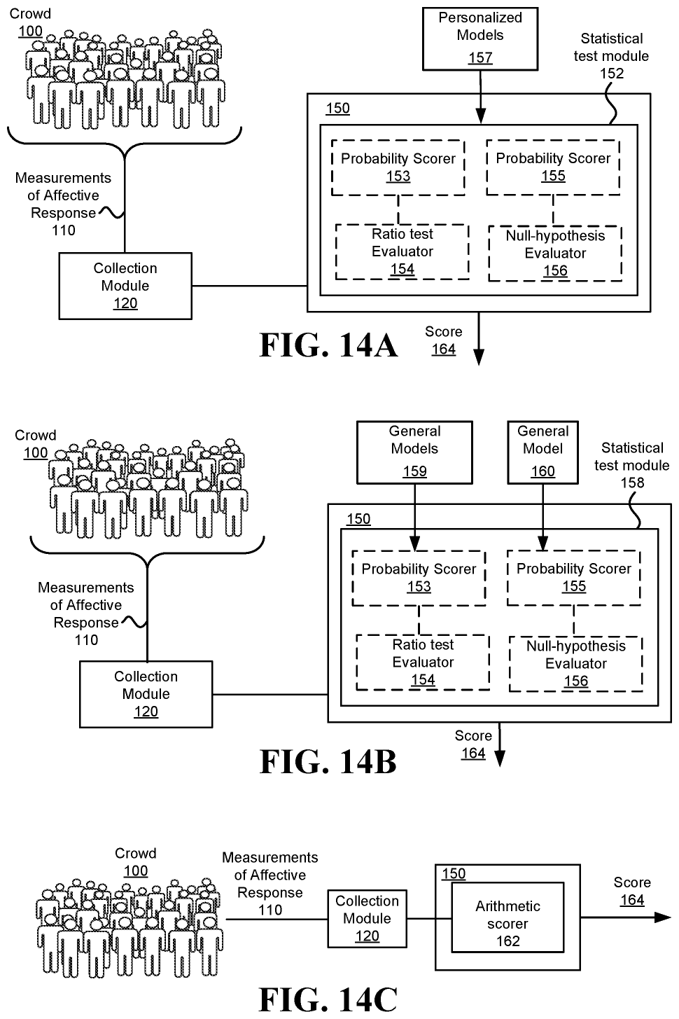

FIG. 14A and FIG. 14B each illustrates one embodiment in which a scoring module (scoring module 150 in the illustrated embodiments) utilizes a statistical test module to compute a score for an experience (score 164 in the illustrated embodiments). In FIG. 14A, the statistical test module is statistical test module 152, while in FIG. 14B, the statistical test module is statistical test module 158. The statistical test modules 152 and 158 include similar internal components, but differ based on models they utilize to compute statistical tests. The statistical test module 152 utilizes personalized models 157 while the statistical test module 158 utilizes general models 159 (which include a first model and a second model).

In one embodiment, a personalized model of a user is trained on data comprising measurements of affective response of the user. It thus may be more suitable to interpret measurements of the user. For example, it may describe specifics of the characteristic values of the user's affective response that may be measured when the user is in certain emotional states. Optionally, a personalized model of a user is received from a software agent operating on behalf of the user. Optionally, the software agent may collect data used to train the personalized model of the user by monitoring the user. Optionally, a personalized model of a user is trained on measurements taken while the user had various experiences, which may be different than the experience for which a score is computed by the scoring module in FIG. 14A. Optionally, the various types of experiences include experience types that are different from the experience type of the experience whose score is being computed by the scoring module. In contrast to a personalized model, a general model, such as a model from among the general models 159, is trained on data collected from multiple users and may not even be trained on measurements of any specific user whose measurement is used to compute a score.

In some embodiments, the statistical test modules 152 and 158 each may perform at least one of two different statistical tests in order to compute a score based on a set of measurements of users: a hypothesis test, and a test involving rejection of a null hypothesis.

In some embodiments, performing a hypothesis test utilizing statistical test module 152, is done utilizing a probability scorer 153 and a ratio test evaluator 154. The probability scorer 153 is configured to compute for each measurement of a user, from among the users who provided measurements to compute the score, first and second corresponding values, which are indicative of respective first and second probabilities of observing the measurement based on respective first and second personalized models of the user. Optionally, the first and second personalized models of the users are from among the personalized models 157. Optionally, the first and second personalized models are trained on data comprising measurements of affective response of the user taken when the user had positive and non-positive affective responses, respectively. For example, the first model might have been trained on measurements of the user taken while the user was happy, satisfied, and/or comfortable, while the second model might have been trained on measurements of affective response taken while the user was in a neutral emotional state or a negative emotional state (e.g., angry, agitated, uncomfortable). Optionally, the higher the probability of observing a measurement based on a model, the more it is likely that the user was in the emotional state corresponding to the model.

The ratio test evaluator 154 is configured to determine the significance level for a hypothesis based on a ratio between a first set of values comprising the first value corresponding to each of the measurements, and a second set of values comprising the second value corresponding to each of the measurements. Optionally, the hypothesis supports an assumption that, on average, the users who contributed measurements to the computation of the score had a positive affective response to the experience.

In some embodiments, performing a hypothesis test utilizing statistical test module 158, is done in a similar fashion to the description given above for performing the same test with the statistical test module 152, but rather than using the personalized models 157, the general models 159 are used instead. When using the statistical test module 158, the probability scorer 153 is configured to compute for each measurement of a user, from among the users who provided measurements to compute the score, first and second corresponding values, which are indicative of respective first and second probabilities of observing the measurement based on respective first and second models belonging to the general models 159. Optionally, the first and second models are trained on data comprising measurements of affective response of users taken while the users had positive and non-positive affective responses, respectively.

The ratio test evaluator 154 is configured to determine the significance level for a hypothesis based on a ratio between a first set of values comprising the first value corresponding to each of the measurements, and a second set of values comprising the second value corresponding to each of the measurements. Optionally, the hypothesis supports an assumption that, on average, the users who contributed measurements to the computation of the score had a positive affective response to the experience. Optionally, the non-positive affective response is a manifestation of a neutral emotional state or a negative emotional state. Thus, if the measurements used to compute the score are better explained by the first model from the general models 159 (which corresponds to the positive emotional response), then the ratio computed by the ratio test evaluator 154 will be positive.

In one embodiment, the hypothesis is a supposition and/or proposed explanation used for evaluating the measurements of affective response. By stating that the hypothesis supports an assumption, it is meant that according to the hypothesis, the evidence (e.g., the measurements of affective response and/or baseline affective response values) exhibit values that correspond to the supposition and/or proposed explanation.

In one embodiment, the ratio test evaluator 154 utilizes a log-likelihood test to determine, based on the first and second sets of values, whether the hypothesis should be accepted and/or the significance level of accepting the hypothesis.

In some embodiments, performing a statistical test that involves rejecting a null hypothesis utilizing statistical test module 152, is done utilizing a probability scorer 155 and a null-hypothesis evaluator 156. The probability scorer 155 is configured to compute, for each measurement of a user, from among the users who provided measurements to compute the score, a probability of observing the measurement based on a personalized model of the user. Optionally, the personalized model of the user is trained on training data comprising measurements of affective response of the user taken while the user had a certain affective response. Optionally, the certain affective response is manifested by changes to values of at least one of the following: measurements of physiological signals, and measurements of behavioral cues. Optionally, the changes to the values are manifestations of an increase or decrease, to at least a certain extent, in a level of at least one of the following emotions: happiness, contentment, calmness, attentiveness, affection, tenderness, excitement, pain, anxiety, annoyance, stress, aggression, fear, sadness, drowsiness, apathy, and anger.

The null-hypothesis evaluator 156 is configured to determine the significance level for a hypothesis based on probabilities computed by the probability scorer 155 for the measurements of the users who contributed measurements for the computation of the score.

The probability scorer 155 is configured to compute, for each measurement of a user, from among the users who provided measurements to compute the score, a probability of observing the measurement based on the general model 160. Optionally, the general model 160 is trained on training data comprising measurements of affective response of users taken while the users had the certain affective response.

The null-hypothesis evaluator 156 is configured to determine the significance level for a hypothesis based on probabilities computed by the probability scorer 155 for the measurements of the users who contributed measurements for the computation of the score. Optionally, the hypothesis is a null hypothesis that supports an assumption that the users of whom the measurements were taken had the certain affective response when their measurements were taken, and the significance level corresponds to a statistical significance of rejecting the null hypothesis.

FIG. 14C illustrates one embodiment in which a scoring module utilizes the arithmetic scorer 162 in order to compute a score for an experience. The arithmetic scorer 162 receives measurements of affective response from the collection module 120 and computes the score 164 by applying one or more arithmetic functions to the measurements. Optionally, the arithmetic function is a predetermined arithmetic function. For example, the logic of the function is known prior to when the function is applied to the measurements. Optionally, a score computed by the arithmetic function is expressed as a measurement value which is greater than the minimum of the measurements used to compute the score and lower than the maximum of the measurements used to compute the score. In one embodiment, applying the predetermined arithmetic function to the measurements comprises computing at least one of the following: a weighted average of the measurements, a geometric mean of the measurements, and a harmonic mean of the measurements. In another embodiment, the predetermined arithmetic function involves applying mathematical operations dictated by a machine learning model (e.g., a regression model). In some embodiments, the predetermined arithmetic function applied by the arithmetic scorer 162 is executed by a set of instructions that implements operations performed by a machine learning-based predictor that receives the measurements used to compute a score as input.

### 15—Personalization

The crowd-based results generated in some embodiments described in this disclosure may be personalized results. In particular, when scores are computed for experiences, e.g., by various systems such as illustrated in FIG. 11, the same set of measurements may, in some embodiments, be used to compute different scores for different users. For example, in one embodiment, a score computed by a scoring module 150 may be considered a personalized score for a certain user and/or for a certain group of users. Optionally, the personalized score is generated by providing the personalization module 130 with a profile of the certain user (or a profile corresponding to the certain group of users). The personalization module 130 compares a provided profile to profiles from among the profiles 128, which include profiles of at least some of the users belonging to the crowd 100, in order to determine similarities between the provided profile and the profiles of at least some of the users belonging to the crowd 100. Based on the similarities, the personalization module 130 produces an output indicative of a selection and/or weighting of at least some of the measurements 110. By providing the scoring module 150 with outputs indicative of different selections and/or weightings of measurements from among the measurements 110, it is possible that the scoring module 150 may compute different scores corresponding to the different selections and/or weightings of the measurements 110, which are described in the outputs.

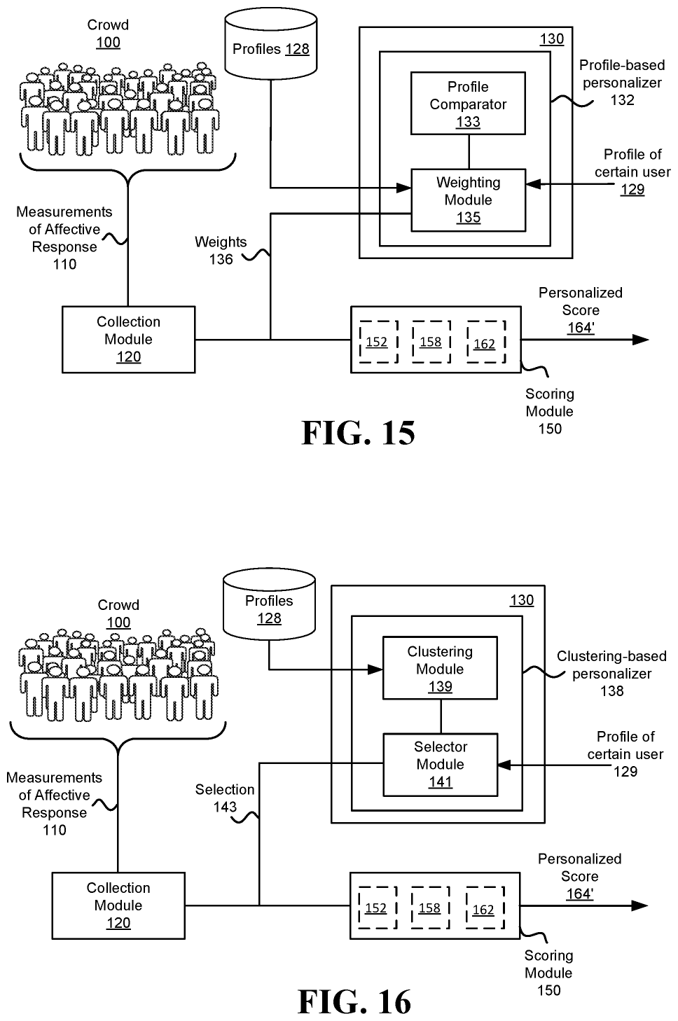

FIG. 15 illustrates a system configured to utilize comparison of profiles of users to compute personalized scores for an experience based on measurements of affective response of the users who have the experience. The system includes at least the collection module 120, the personalization module 130, and the scoring module 150. In this embodiment, the personalization module 130 utilizes profile-based personalizer 132 which comprises profile comparator 133 and weighting module 135.

The collection module 120 is configured to receive measurements 110 of affective response, which in this embodiment include measurements of at least ten users. Each measurement of a user, from among the measurements of the at least ten users, corresponds to an event in which the user has the experience. It is to be noted that the discussion below regarding the measurements of at least ten users is applicable to other numbers of users, such as at least five users.

The profile comparator 133 is configured to compute a value indicative of an extent of a similarity between a pair of profiles of users. Optionally, a profile of a user includes information that describes one or more of the following: an indication of an experience the user had, a demographic characteristic of the user, a genetic characteristic of the user, a static attribute describing the body of the user, a medical condition of the user, an indication of a content item consumed by the user, and a feature value derived from semantic analysis of a communication of the user. The profile comparator 133 does not return the same result when comparing various pairs of profiles. For example, there are at least first and second pairs of profiles, such that for the first pair of profiles, the profile comparator 133 computes a first value indicative of a first similarity between the first pair of profiles, and for the second pair of profiles, the profile comparator 133 computes a second value indicative of a second similarity between the second pair of profiles.

The weighting module 135 is configured to receive a profile 129 of a certain user and the profiles 128, which comprise profiles of the at least ten users and to generate an output that is indicative of weights 136 for the measurements of the at least ten users. Optionally, the weight for a measurement of a user, from among the at least ten users, is proportional to a similarity computed by the profile comparator 133 between a pair of profiles that includes the profile of the user and the profile 129, such that a weight generated for a measurement of a user whose profile is more similar to the profile 129 is higher than a weight generated for a measurement of a user whose profile is less similar to the profile 129. The weighting module 135 does not generate the same output for all profiles of certain users that are provided to it. That is, there are at least a certain first user and a certain second user, who have different profiles, for which the weighting module 135 produces respective first and second outputs that are different. Optionally, the first output is indicative of a first weighting for a measurement from among the measurements of the at least ten users, and the second output is indicative of a second weighting, which is different from the first weighting, for the measurement from among the measurements of the at least ten users.

Herein, a weight of a measurement determines how much the measurement's value influences a value computed based on the measurement. For example, when computing a score based on multiple measurements that include first and second measurements, if the first measurement has a higher weight than the second measurement, it will not have a lesser influence on the value of the score than the influence of the second measurement on the value of the score. Optionally, the influence of the first measurement on the value of the score will be greater than the influence of the second measurement on the value of the score.

The scoring module 150 is configured to compute a score 164′, for the experience, for the certain user based on the measurements and weights 136, which were computed based on the profile 129 of the certain user. In this case, the score 164′ may be considered a personalized score for the certain user.

When computing scores, the scoring module 150 takes into account the weightings generated by the weighting module 135 based on the profile 129. That is, it does not compute the same scores for all weightings (and/or outputs that are indicative of the weightings). In particular, at least for the certain first user and the certain second user, who have different profiles and different outputs generated by the weighting module 135, the scoring module computes different scores. Optionally, when computing a score for the certain first user, a certain measurement has a first weight, and when computing a score for the certain second user, the certain measurement has a second weight that is different from the first weight.

In one embodiment, the scoring module 150 may utilize the weights 136 directly by weighting the measurements used to compute a score. For example, if the score 164′ represents an average of the measurements, it may be computed using a weighted average instead of a regular arithmetic average. In another embodiment, the scoring module 150 may end up utilizing the weights 136 indirectly. For example, the weights may be provided to the collection module 120, which may determine based on the weights, which of the measurements 110 should be provided to the scoring module 150. In one example, the collection module 120 may provide only measurements for which associated weights determined by weighting module 135 reach a certain minimal weight.

There are various ways in which profile comparator 133 may compute similarities between profiles. Optionally, the profile comparator 133 may utilize a procedure that evaluates pairs of profiles independently to determine the similarity between them. Alternatively, the profile comparator 133 may utilize a procedure that evaluates similarity between multiple profiles simultaneously (e.g., produce a matrix of similarities between all pairs of profiles).

In one embodiment, profiles of users are represented as vectors of values that include at least some of the information in the profiles. In this embodiment, the profile comparator 133 may determine similarity between profiles by using a measure such as a dot product between the vector representations of the profiles, the Hamming distance between the vector representations of the profiles, and/or using a distance metric such as Euclidean distance between the vector representations of the profiles.

In another embodiment, profiles of users may be clustered by the profile comparator 133 into clusters using one or more clustering algorithms that are known in the art (e.g., k-means, hierarchical clustering, or distribution-based Expectation-Maximization). Optionally, profiles that fall within the same cluster are considered similar to each other, while profiles that fall in different clusters are not considered similar to each other. Optionally, a profile of a first user that falls into the same cluster to which the profile of a certain user belongs is given a higher weight than a profile of a second user, which falls into a different cluster than the one to which the profile of the certain user belongs. Optionally, the higher weight given to the profile of the first user means that a measurement of the first user is given a higher weight than a measurement of the second user, when computing a personalized score for the certain user.

In yet another embodiment, the profile comparator 133 may determine similarity between profiles by utilizing a predictor trained on data that includes samples and their corresponding labels. Each sample includes feature values derived from a certain pair of profiles of users, and the sample's corresponding label is indicative of the similarity between the certain pair of profiles.

FIG. 16 illustrates a system configured to utilize clustering of profiles of users to compute personalized scores for an experience based on measurements of affective response of the users. The system includes at least the collection module 120, the personalization module 130, and the scoring module 150. In this embodiment, the personalization module 130 utilizes clustering-based personalizer 138 which comprises clustering module 139 and selector module 141.

The collection module 120 is configured to receive measurements 110 of affective response, which in this embodiment include measurements of at least ten users. Each measurement of a user, from among the measurements of the at least ten users, corresponds to an event in which the user has an experience.

The clustering module 139 is configured to receive the profiles 128 of the at least ten users, and to cluster the at least ten users into clusters based on profile similarity, with each cluster comprising a single user or multiple users with similar profiles. Optionally, the clustering module 139 may utilize the profile comparator 133 in order to determine similarity between profiles. There are various clustering algorithms known in the art which may be utilized by the clustering module 139 to cluster users. Some examples include hierarchical clustering, partition-based clustering (e.g., k-means), and clustering utilizing an Expectation-Maximization algorithm. In one embodiment, each user may belong to a single cluster, while in another embodiment, each user may belong to multiple clusters (soft clustering). In the latter example, each user may have an affinity value to at least some clusters, where an affinity value of a user to a cluster is indicative of how strongly the user belongs to the cluster. Optionally, after performing a sot clustering of users, each user is assigned to a cluster to which the user has a strongest affinity.

The selector module 141 is configured to receive a profile 129 of a certain user, and based on the profile, to select a subset comprising at most half of the clusters of users. Optionally, the selection of the subset is such that, on average, the profile 129 is more similar to a profile of a user who is a member of a cluster in the subset, than it is to a profile of a user, from among the at least ten users, who is not a member of any of the clusters in the subset.

In one example, the selector module 141 selects the cluster to which the certain user has the strongest affinity (e.g., the profile 129 of the certain user is most similar to a profile of a representative of the cluster, compared to profiles of representatives of other clusters). In another example, the selector module 141 selects certain clusters for which the similarity between the profile of the certain user and profiles of representatives of the certain clusters is above a certain threshold. And in still another example, the selector module 141 selects a certain number of clusters to which the certain user has the strongest affinity (e.g., based on similarity of the profile 129 to profiles of representatives of the clusters).

Additionally, the selector module 141 is also configured to select at least eight users from among the users belonging to clusters in the subset. Optionally, the selector module 141 generates an output that is indicative of a selection 143 of the at least eight users. For example, the selection 143 may indicate identities of the at least eight users, or it may identify cluster representatives of clusters to which the at least eight users belong. It is to be noted that instead of selecting at least eight users, a different minimal number of users may be selected such as at least five, at least ten, and/or at least fifty different users.

Herein, a cluster representative represents other members of the cluster. The cluster representative may be one of the members of the cluster chosen to represent the other members or an average of the members of the cluster (e.g., a cluster centroid). In the latter case, a measurement of the representative of the cluster may be obtained based on a function of the measurements of the members it represents (e.g., an average of their measurements).

It is to be noted that the selector module 141 does not generate the same output for all profiles of certain users that are provided to it. That is, there are at least a certain first user and a certain second user, who have different profiles, for which the selector module 141 produces respective first and second outputs that are different. Optionally, the first output is indicative of a first selection of at least eight users from among the at least ten users, and the second output is indicative of a second selection of at least eight users from among the at least ten users, which is different from the first selection. For example, the first selection may include a user that is not included in the second selection.

The selection 143 may be provided to the collection module 120 and/or to the scoring module 150. For example, the collection module 120 may utilize the selection 143 to filter, select, and/or weight measurements of certain users, which it forwards to the scoring module 150. As explained below, the scoring module 150 may also utilize the selection 143 to perform similar actions of selecting, filtering and/or weighting measurements from among the measurements of the at least ten users which are available for it to compute the score 164′.

The scoring module 150 is configured to compute a score 164′, for the experience, for the certain user based on the measurements of the at least eight users. In this case, the score 164′ may be considered a personalized score for the certain user. When computing the scores, the scoring module 150 takes into account the selections generated by the selector module 141 based on the profile 129. In particular, at least for the certain first user and the certain second user, who have different profiles and different outputs generated by the selector module 141, the scoring module 150 computes different scores.

It is to be noted that the scoring module 150 may compute the score 164′ based on the selection 143 in various ways. In one example, the scoring module 150 may utilize measurements of the at least eight users in a similar way to the way it computes a score based on measurements of at least ten users. However, in this case it would leave out measurements of users not in the selection 143, and only use the measurements of the at least eight users. In another example, the scoring module 150 may compute the score 164′ by associating a higher weight to measurements of users that are among the at least eight users, compared to the weight it associates with measurements of users from among the at least ten users who are not among the at least eight users. In yet another example, the scoring module 150 may compute the score 164′ based on measurements of one or more cluster representatives of the clusters to which the at least eight users belong.

### 16—Alerts

In some embodiments, scores computed for an experience may be dynamic, i.e., they may change over time. In one example, scores may be computed utilizing a “sliding window” approach, and use measurements of affective response that were taken during a certain period of time. In another example, measurements of affective response may be weighted according to the time that has elapsed since they were taken. Such a weighting typically, but not necessarily, involves giving older measurements a smaller weight than more recent measurements when used to compute a score. In some embodiments, it may be of interest to determine when a score reaches a threshold and/or passes (e.g., by exceeding the threshold or falling below the threshold), since that may signify a certain meaning and/or require taking a certain action, such as issuing a notification about the score. Issuing a notification about a value of a score reaching and/or exceeding a threshold may be referred to herein as “alerting” and/or “dynamically alerting”.

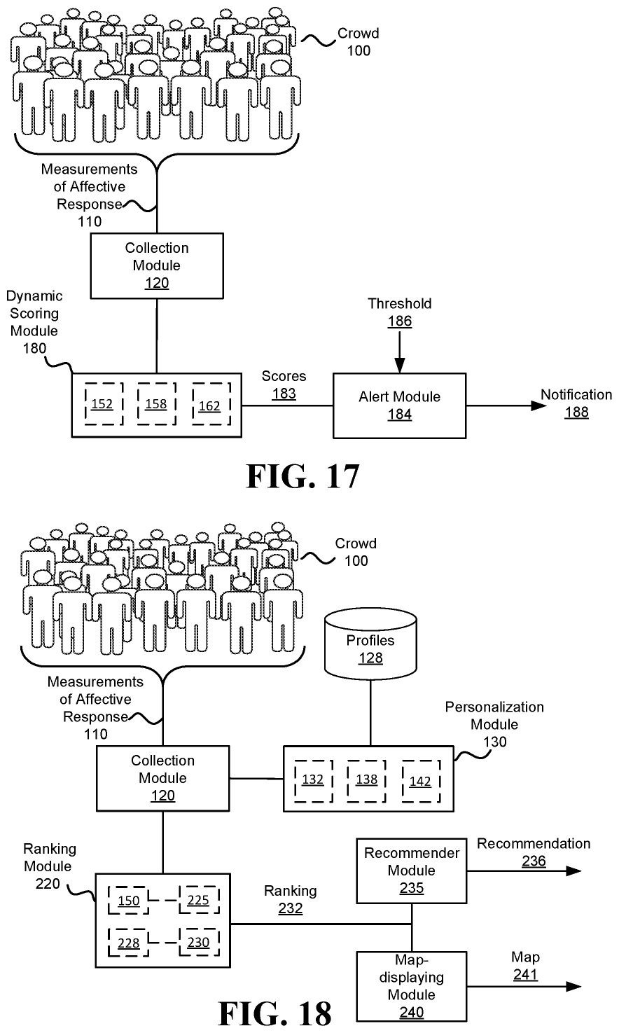

FIG. 17 illustrates a system configured to alert about affective response to an experience. The system includes at least the collection module 120, the dynamic scoring module 180, and an alert module 184. It is to be noted that the experience to which the embodiment illustrated in FIG. 17 relates, as well as other embodiments involving an experience in this disclosure, may be any experience mentioned in this disclosure. In particular, the experience may involve being in the location 512 and/or engaging in an activity in the location 512.

The collection module 120 is configured to receive measurements 110 of affective response of users to the experience. Optionally, a measurement of affective response of a user to the experience is based on at least one of the following values: (i) a value acquired by measuring the user, with a sensor coupled to the user, while the user has the experience, and (ii) a value acquired by measuring the user with the sensor up to one minute after the user had the experience. Optionally, each of the measurements comprises at least one of the following: a value representing a physiological signal of the user and a value representing a behavioral cue of the user.

In one embodiment, the dynamic scoring module 180 is configured to compute scores 183 for the experience based on the measurements 110. The dynamic scoring module may utilize similar modules to the ones utilized by scoring module 150. For example, the dynamic scoring module may utilize the statistical test module 152, the statistical test module 158, and/or the arithmetic scorer 162. The scores 183 may comprise various types of values, similarly to scores for experiences computed by other modules in this disclosure, such as scoring module 150.

The alert module 184 is a module that evaluates scores (e.g., the scores 183) in order to determine whether to issue an alert in the form of a notification (e.g., notification 188). In one example, if a score for the experience, from among the scores 183, which corresponds to a certain time, reaches a threshold 186, the alert module 184 may forward the notification 188. The notification 188 is indicative of the score for the experience reaching the threshold, and is forwarded by the alert module no later than a second period after the certain time. Optionally, both the first and the second periods are shorter than twelve hours. In one example, the first period is shorter than four hours and the second period is shorter than two hours. In another example, both the first and the second periods are shorter than one hour.

The alert module 184 is configured to operate in such a way that it has dynamic behavior, that is, it is not configured to always have a constant behavior, such as constantly issue alerts or constantly refrain from issuing alerts. In particular, for a certain period of time that includes times to which individual scores from the scores 183 correspond, there are at least a certain first time t₁ and a certain second time t₂, such that a score corresponding to t₁ does not reach the threshold 186 and a score corresponding to t₂ reaches the threshold 186. Additionally, t₂>t₁, and the score corresponding to t₂ is computed based on at least one measurement taken after t₁.

In some embodiments, when t₁ and t₂ denote different times to which scores correspond, and t₂ is after t₁, the difference between t₂ and t₁ may be fixed. In one example, this may happen when scores for experiences may be computed periodically, after elapsing of a certain period. For example, a new score is computed every minute, every ten minutes, every hour, or every day. In other embodiments, the difference between t₂ and t₁ is not fixed. For example, a new score may be computed after a certain condition is met (e.g., a sufficiently different composition of users who contribute measurements to computing a score is obtained). In one example, a sufficiently different composition means that the size of the overlap between the set of users who contributed measurements to computing the score S₁ corresponding to t₁ and the set of users who contributed measurements to computing the score S₂ corresponding to t₂ is less than 90% of the size of either of the sets. In other examples, the overlap may be smaller, such as less than 50%, less than 15%, or less than 5% of the size of either of the sets.

Forwarding a notification may be done in various ways. Optionally, forwarding a notification is done by providing a user a recommendation, such as by utilizing the recommender module 178. In one example, the notification is sent to a device of a user that includes a user interface that presents information to the user (e.g., a screen and/or a speaker). In such a case, the notification may include a text message, an icon, a sound effect, speech, and/or video. In another example, the notification may be information sent to a software agent operating on behalf of a user, which may make a decision on behalf of the user, based on the notification, possibly without providing the user with an indication that the notification was received. For example, the software agent may instruct an autonomous vehicle to transport the user to a certain location for which a notification indicated that there is a good ambiance at the location. In this example, the user may have requested to go to someplace fun in town, and the software agent selects a place based on current estimates of how much fun people are having at different venues.

It is to be noted that forwarding a notification to a user may not guarantee that the user becomes aware of the notification. For example, a software agent operating on behalf of the user may decide not to make the user aware of the notification.

### 17—Ranking Experiences

In various embodiments, experiences (also referred to as a “plurality of experiences”) may be ranked based on measurements of affective response of users. The results of this action are referred to as a ranking of the experiences. A ranking is an ordering of at least some of the experiences, which is indicative of preferences of the users towards those experiences and/or is indicative of the extent of emotional response of the users to those experiences.

A module that ranks experiences may be referred to as a “ranking module” and/or a “ranker”. The ranking module be referred to as “generating” or “computing” a ranking (when referring to creation of a ranking, these terms may be used interchangeably). Thus, stating that a module is configured to rank experiences (and/or to rank experiences of a certain type) is equivalent to stating that the module is configured to generate a ranking of the experiences (and/or to generate a ranking of the experiences of the certain type). When the experiences being ranked are of a certain type, the ranker and/or ranking module may be referred to based on the type of experience being ranked (e.g., a location ranker, content ranking module, etc.).

FIG. 18 illustrates a system configured to rank experiences based on measurements of affective response of users. The system includes at least the collection module 120 and a ranking module, such as the ranking module 220, the dynamic ranking module 250, or the aftereffect ranking module 300. It is to be noted that while the system described below includes the ranking module 220, the principles described below are applicable, mutatis mutandis, to embodiments in which other ranking modules are used. For example, the different approaches to ranking described below are applicable to other embodiments that involve ranking of experiences, such as embodiments that include the dynamic ranking module 250 or the aftereffect ranking module 300. Furthermore, the discussion below describes principles involve in ranking that is done based on measurements of affective response to experiences; these principles may be applied to ranking modules that are used to evaluate when to have an experience, by ranking times to have the experience, as done by the ranking module 333 and the aftereffect ranking module 334.

The embodiment illustrated in FIG. 18, like other systems described in this disclosure, may be realized via a computer, such as the computer 400, which includes at least a memory 402 and a processor 401. The memory 402 stores computer executable modules described below, and the processor 401 executes the computer executable modules stored in the memory 402. It is to be noted that the experiences to which the embodiment illustrated in FIG. 18 relates, as well as other embodiments involving experiences in this disclosure, may be any experiences mentioned in this disclosure (e.g., the experiences may be of any of the types of experiences mentioned in section 7—Experiences). In particular, the experiences may involve being in any of the locations and/or involve engaging in an activity in any of the locations mentioned in this disclosure.

The collection module 120 is configured to receive the measurements of affective response, which in some embodiments, are measurements 110 of affective response of users belonging to the crowd 100 to experiences. Optionally, a measurement of affective response of a user to an experience, from among the experiences, is based on at least one of the following values: (i) a value acquired by measuring the user, with a sensor coupled to the user, while the user has the experience, and (ii) a value acquired by measuring the user, with a sensor coupled to the user, at most one hour after the user had the experience. A measurement of affective response of a user to an experience may also be referred to herein as a “measurement of a user who had an experience”. The collection module 120 is also configured to forward at least some of the measurements 110 to the ranking module 220. Optionally, at least some of the measurements 110 undergo processing before they are received by the ranking module 220. Optionally, at least some of the processing is performed via programs that may be considered software agents operating on behalf of the users who provided the measurements 110.

In one embodiment, measurements received by the ranking module 220 include measurements of affective response of users to the experiences. Optionally, for each experience from among the experiences, the measurements received by the ranking module 220 include measurements of affective response of at least five users to the experience.

Herein, when a first experience is ranked higher than a second experience, it typically means that the first experience is to be preferred over the second experience. In one example, this may mean that a score computed for the first experience is higher than a score computed for the second experience. In another example, this may mean that more users prefer the first experience to the second experience, and/or that measurements of users who had the first experience are more positive than measurements of users who had the second experience.

There are different approaches to ranking experiences, which may be utilized in some embodiments described herein. These approaches may be used by any of the ranking modules described herein, such as ranking module 220, dynamic ranking module 250, aftereffect ranking module 300, the ranking module 333, or the aftereffect ranking module 334 (which ranks times at which to have an experience). The discussion below explains the approaches to ranking using the ranking module 220 as an exemplary ranking module, however, the teachings below are applicable to other ranking modules as well, such as the ranking modules listed above.

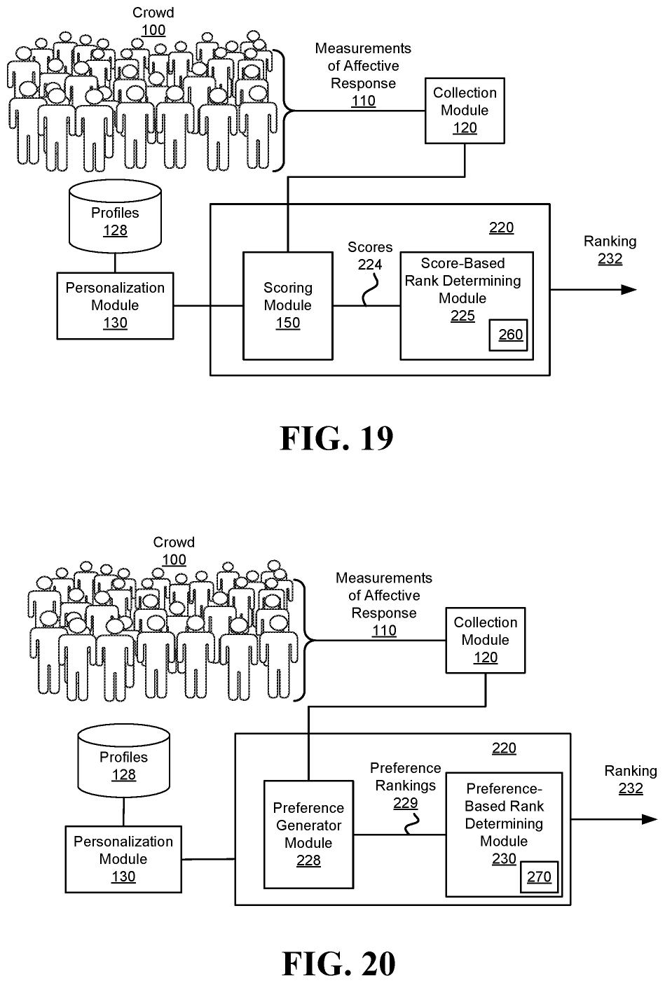

In some embodiments, experiences may be ranked based on scores computed for the experiences. In such embodiments, the ranking module 220 may include the scoring module 150 and a score-based rank determining module 225. Ranking experiences using these modules is described in more detail in the discussion related to FIG. 19. In other embodiments, experiences may be ranked based on preferences generated from measurements. In such embodiments, an alternative embodiment of the ranking module 220 includes preference generator module 228 and preference-based rank determining module 230.

In some embodiments, when experiences that are ranked correspond to locations, the map-displaying module 240 may be utilized to present a ranking and/or recommendation based on a ranking to a user. In one example, an experience corresponding to a location involves participating in a certain activity at the location. In another example, an experience corresponding to a location simply involves spending time at the location. Optionally, map 241 may display an image describing the locations and annotations describing at least some of the experiences and their respective ranks.

Following is a discussion of two different approaches that may be used to rank experiences based on measurements of affective response. The first approach relies on computing scores for the experiences based on the measurements, and ranking the experiences based on the scores. The second approach relies on determining preference rankings directly from the measurements, and determining a ranking of the experiences using a preference-based algorithmic approach, such as a method that satisfies the Condorcet criterion (as described further below). It is to be noted that these are not the only approaches for ranking experiences that may be utilized in embodiments described herein; rather, these two approaches are non-limiting examples presented in order to illustrate how ranking may be performed in some embodiments. In other embodiments, other approaches to ranking experiences based on measurements of affective response may be employed, such as hybrid approaches that utilize concepts from both the scoring-based and preference-based approaches to ranking described below.

In some embodiments, ranking experiences may be done utilizing a scoring module, such as the scoring module 150, the dynamic scoring module 180, and/or aftereffect scoring module 302. For each of the experiences being ranked, the scoring module computes a score for the experience based on measurements of users to the experience (i.e., measurements corresponding to events involving the experience). Optionally, each score for an experience is computed based on measurements of at least a certain number of users, such as at least 3, at least 5, at least 10, at least 100, or at least 1000 users. Optionally, at least some of the measurements have corresponding weights that are utilized by the scoring module to compute the scores for the experiences.

FIG. 19 illustrates a system configured to rank experiences using scores computed for the experiences based on measurements of affective response. The figure illustrates one alternative embodiment for the ranking module 220, in which the ranking module 220 includes the scoring module 150 and the score-based rank determining module 225. It is to be noted that this embodiment involves scoring module 150; in other embodiments, other scoring modules such as the dynamic scoring module 180 or the aftereffect scoring module 302 may be used to compute the scores according to which the experiences are ranked.

The scoring module 150 is configured, in one embodiment, to compute scores 224 for the experiences. For each experience from among the experiences, the scoring module 150 computes a score based on the measurements of the at least five users who had the experience (i.e., the measurements were taken while the at least five users had the experience and/or shortly after that time).

The score-based rank determining module 225 is configured to rank the experiences based on the scores 224 computed for the experiences, such that a first experience is ranked higher than a second experience when the score computed for the first experience is higher than the score computed for the second experience. In some cases experiences may receive the same rank, e.g., if they have the same score computed for them, or the significance of the difference between the scores is below a threshold.

In one embodiment, the score-based rank determining module 225 utilizes score-difference evaluator module 260 which is configured to determine significance of a difference between scores of third and fourth experiences. Optionally, the score-difference evaluator module 260 utilizes a statistical test involving the measurements of the users who had the third and fourth experiences in order to determine the significance. Optionally, the score-based rank determining module 225 is also configured to give the same rank to the third and fourth experiences when the significance of the difference is below the threshold.

FIG. 20 illustrates a system configured to rank experiences using preference rankings determined based on measurements of affective response. The figure illustrates on alternative embodiment for the ranking module 220, in which the ranking module 220 includes preference generator module 228 and preference-based rank determining module 230.

The preference generator module 228 is configured to generate a plurality of preference rankings 229 for the experiences. Optionally, each preference ranking is determined based on a subset of the measurements 110, and comprises a ranking of at least two of the experiences, such that one of the at least two experiences is ranked ahead of another experience from among the at least two experiences. In one example, a subset of measurements may include measurements corresponding to events, with each event involving an experience from among the experiences. Optionally, the measurements in the subset are given in the form of affective values and/or may be converted to affective values, such as ratings on a numerical scale, from which an ordering (or partial ordering) of the two or more experiences may be established.

In some embodiments, measurements of affective response used by the preference generator module 228 to generate preference rankings may have corresponding weights. Optionally, the weights are utilized in order to generate the preference ranking from a subset of measurements by establishing an order (or partial order) between experiences such that a first experience is ranked in a preference ranking ahead of a second experience and the weighted average of the measurements in the subset corresponding to the first experience is higher than the weighted average of the measurements in the subset corresponding to the second experience.

Given two or more preference rankings, each involving some, but not necessarily all the experiences being ranked, the preference rankings may be consolidated in order to generate a ranking of the experiences. In some embodiments, the two or more preference rankings are consolidated to a ranking of experiences by a preference-based rank determining module, such as the preference-based rank determining module 230. There are various approaches known in the art that may be used by the preference-based rank determining module to generate the ranking of the experiences from the two or more preference rankings. Some of these approaches may be considered Condorcet methods and/or methods that satisfy the Condorcet criterion.

Various Condorcet methods that are known in the art, which may be utilized in some embodiments, are described in Hwang et al., “Group decision making under multiple criteria: methods and applications”, Vol. 281, Springer Science & Business Media, 2012. Generally speaking, when a Condorcet method is used to rank experiences based on preference rankings, it is expected to satisfy at least the Condorcet criterion. A method that satisfies the Condorcet criterion ranks a certain experience higher than each experience belonging to a set of other experiences, if, for each other experience belonging to the set of other experiences, the number of preference rankings that rank the certain experience higher than the other experience is larger than the number of preference rankings that rank the other experience higher than the certain experience.

### 18—Learning Function Parameters

Some embodiments in this disclosure involve functions whose targets (codomains) include values representing affective response to an experience. Herein, parameters of such functions are typically learned based on measurements of affective response. These functions typically describe a relationship between affective response related to an experience and a parametric value. In one example, the affective response related to an experience may be the affective response of users to the experience (e.g., as determined by measurements of the users taken with sensors while the users had the experience). In another example, the affective response related to the experience may be an aftereffect of the experience (e.g., as determined by prior and subsequent measurements of the users taken with sensors before and after the users had the experience, respectively).

In embodiments described in this disclosure, a function whose target includes values representing affective response is characterized by one or more values of parameters (referred to as the “function parameters” and/or the “parameters of the function”). These parameters are learned from measurements of affective response of users. Optionally, the parameters of a function may include values of one or more models that are used to implement (i.e., compute) the function. Herein, “learning a function” refers to learning the function parameters that characterize the function.

Learning a function based on measurements of affective response may be done, in some embodiments described herein, by a function learning module, such as function learning module 280 or a function learning module denoted by another reference numeral.

The data provided to the function learning module in order to learn parameters of a function typically comprises training samples of the form (x,y), where y is derived from a measurement of affective response and x is the corresponding domain value (e.g., x may be a duration of the experience to which the measurement corresponds). Since the value y in a training sample (x,y) is derived from a measurement of affective response (or may simply be a measurement of affective response that was not further processed), it may be referred to herein as “a measurement”. It is to be noted that since data provided to the function learning module in embodiments described herein typically comes from multiple users, the function that is learned may be considered a crowd-based result.

In one example, a sample (x,y) provided to the function learning module represents an event in which a user stayed at a hotel. In this example, x may represent the number of days a user stayed at the hotel (i.e., the duration), and y may be an affective value indicating how much the user enjoyed the stay at the hotel (e.g., y may be based on measurements of the user obtained at multiple times during the stay). In this example, the function learning module may learn parameters of a function that describes the enjoyment level from staying at the hotel as a function of the duration of the stay.

In some embodiments, the function learning module utilizes an algorithm for training a predictor to learn the parameters of a function of the form ƒ(x)=y. Learning such parameters is typically performed by machine learning-based trainer 286, which typically utilizes a training algorithm to train a model for a machine learning-based predictor used predicts target values of the function (“y”) for different domain values of the function (“x”). Section 10—Predictors and Emotional State Estimators, includes additional information regarding various approaches known in the art that may be utilized to train a machine learning-based predictor to compute a function of the form ƒ(x)=y. Some examples of predictors that may be used for this task include regression models, neural networks, nearest neighbor predictors, support vector machines for regression, and/or decision trees.

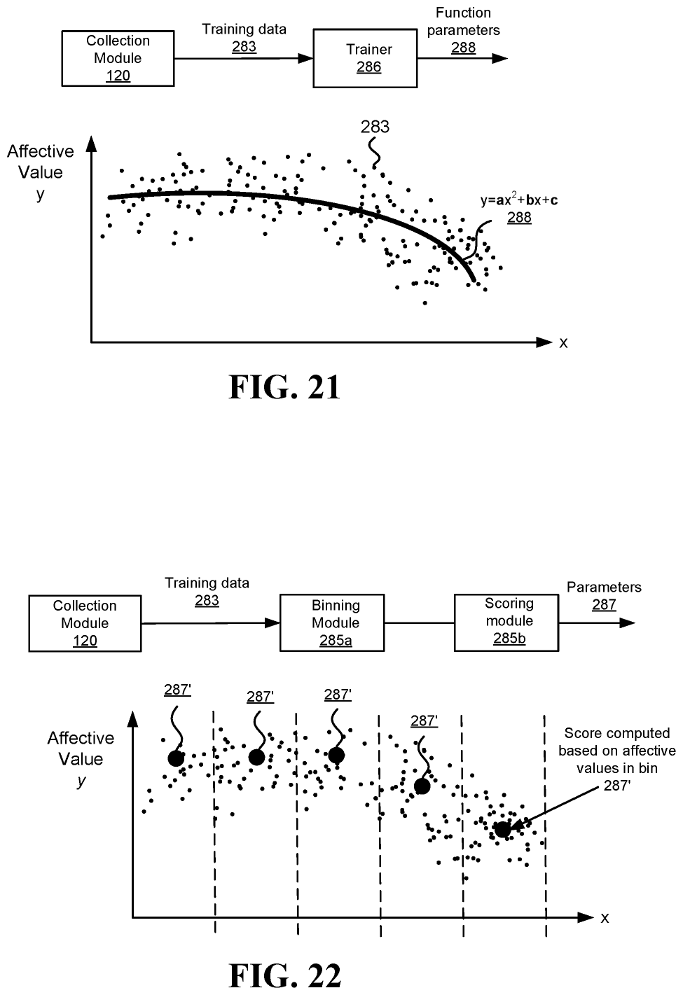

FIG. 21 illustrates one embodiment in which the machine learning-based trainer 286 is utilized to learn a function representing an expected affective response (y) that depends on a numerical value (x). For example, x may represent how long a user sits in a sauna, and y may represent how well the user is expected to feel one hour after the sauna.

The machine learning-based trainer 286 receives training data 283, which is based on events in which users have a certain experience (following the example above, each dot in between the x/y axes repents a pair of values that includes time spent by a user in the sauna (the x coordinate) and a value indicating how the user felt after an hour (the y coordinate). The training data 283 includes values derived from measurements of affective response (e.g., how a user felt after the sauna is determined by measuring the user with a sensor). The output of the machine learning-based trainer 286 includes function parameters 288 (which are illustrated by the function curve they describe). In the illustrated example, assuming the function learned by the trainer 286 is described as a quadratic function, the parameters 288 may include the values of the coefficients a, b, and c corresponding to a quadratic function used to fit the training data 283. The machine learning-based trainer 286 is utilized in a similar fashion in other embodiments in this disclosure that involve learning other types of functions (with possibly other types of input data).

It is to be noted that when other types of machine-learning training algorithms are used, the parameters 288 may be different. For example, if the trainer 286 utilizes a support vector machine training algorithm, the parameters 288 may include data that describes samples from the training data that are chosen as support vectors. In another example, if the trainer 286 utilizes a neural network training algorithm, the parameters 288 may include parameters of weightings of input values and/or parameters indicating a topology utilized by a neural network.

In some embodiments, some of the measurements of affective response used to derive the training data 283 may be weighted. Thus, the trainer 286 may utilize weighted samples to train the model. For example, a weighting of the measurements may be the result of an output by the personalization module 130, weighting due to the age of the measurements, and/or some other form of weighting. Learning a function when the training data is weighted is commonly known in the art, and the machine learning-based trainer 286 may be easily configured to handle such data if needed.

Another approach for learning functions involves binning. In some embodiments, the function learning module may place measurements (or values derived from the measurements) in bins based on their corresponding domain values. Thus, for example, each training sample of the form (x,y), the value of x is used to determine what bin to place the sample in. After the training data is placed in bins, a representative value is computed for each bin; this value is computed from the y value of the samples in the bin, and typically represents some form of score for an experience (e.g., a score or an aftereffect). This score may be computed by one or more of the various scoring modules mentioned in this disclosure such as the scoring module 150 or the aftereffect scoring module 302.

Placing measurements into bins is typically done by a binning module, which examines a value (x) associated with a measurement (y) and places it, based on the value of x, in one or more bins. Examples of binning modules in this disclosure include binning modules referred to by reference numerals 313, 324, 347, 354, and 359. It is to be noted that the use of different reference numerals is done to indicate that the x values of the data are of a certain type (e.g., one or more of the types of domain values mentioned above).

For example, a binning module may place measurements into one-hour bins representing the (rounded) hour during which they were taken. It is to be noted that, in some embodiments, multiple measurements may have the same associated domain value and be placed in a bin together. For example, a set comprising a prior and a subsequent measurement may be placed in a bin based on a single associated value (e.g., when used to compute an aftereffect the single value may be the time that had elapsed since having an experience).

The number of bins in which measurements are placed may vary between embodiments. However, typically the number of bins is at least two. Additionally, bins need not have the same size. In some embodiments, bins may have different sizes (e.g., a first bin may correspond to a period of one hour, while a second bin may correspond to a period of two hours).

In some embodiments, different bins may overlap; thus, some bins may each include measurements with similar or even identical corresponding parameters values (“x” values). In other embodiments, bins do not overlap. Optionally, the different bins in which measurements may be placed may represent a partition of the space of values of the parameters (i.e., a partitioning of possible “x” values).

FIG. 22 illustrates one embodiment in which the binning approach is utilized for learning function parameters 287. The training data 283 is provided to binning module 285a, which separates the samples into different bins. In the illustration, each of the different bins falls between two vertical lines. The scoring module 285b then computes a score 287′ for each of the bins based on the measurements that were assigned to each of the bins. In this illustration, the binning module 285a may be replaced by any one of the binning modules described in this disclosure; similarly, the scoring module 285b may be replaced by another scoring module described in this disclosure (e.g., the scoring module 150 or the aftereffect scoring module 302). Optionally, the function parameters 287 may include scores computed by the scoring module 285b (or the module that replaces it). Additionally or alternatively, the function parameters 287 may include values indicative of the boundaries of the bins to which the binning module 285a assigns samples, such as what ranges of x values cause samples to be assigned to certain bins.

In some embodiments, some of the measurements of affective response used to compute scores for bins may have associated weights (e.g., due to weighting based on the age of the measurements and/or weights from an output of the personalization module 130). Scoring modules described in this embodiment are capable of utilizing such weights when computing scores for bins.

In some embodiments, a function whose parameters are learned by a function learning module may be displayed on the display 252, which is configured to render a representation of the function and/or its parameters. For example, the function may be rendered as a graph, plot, and/or any other image that represents values given by the function and/or parameters of the function. Optionally, when presenting personalized functions ƒ₁ and ƒ₂ to different users, a rendered representation of the function ƒ₁ that is forwarded to a certain first user is different from a rendered representation of the function ƒ₂ that is forwarded to a certain second user.

In some embodiments, function comparator module 284 may receive two or more descriptions of functions and generate a comparison between the two or more functions. In one embodiment, a description of a function may include one or more values of parameters that describe the function, such as parameters of the function that were learned by the machine learning-based trainer 286. For example, the description of the function may include values of regression coefficients used by the function. In another embodiment, a description of a function may include one or more values of the function for certain input values and/or statistics regarding values the function gives to certain input values. In one example, the description of the function may include values such as pairs of the form (x,y) representing the function. In another example, the description may include statistics such as the average value y the function gives for certain ranges of values of x.

The function comparator module 284 may evaluate, and optionally report, various aspects of the functions. In one embodiment, the function comparator may indicate which function has a higher (or lower) value within a certain range and/or which function has a higher (or lower) integral value over the certain range of input values. Optionally, the certain range may include input values up to a certain x value, it may include input values from a certain value x and on, and/or include input values within specified boundaries (e.g., between certain values x₁ and x₂).

### 19—Functions of Affective Response to Experiences

When a user has an experience, the experience may have an immediate impact on the affective response of the user. However, in some cases, having the experience may also have a delayed and/or residual impact on the affective response of the user. For example, going on a vacation can influence how a user feels after returning from the vacation. After having a nice, relaxing vacation a user may feel invigorated and relaxed, even days after returning from the vacation. However, if the vacation was not enjoyable, the user may be tense, tired, and/or edgy in the days after returning. In another example, eating a certain type of meal and/or participating in a certain activity (e.g., a certain type of exercise), might impact how a user feels later on. Having knowledge about the nature of the residual and/or delayed influence associated with an experience may help to determine whether a user should have the experience. Thus, there is a need to be able to evaluate experiences to determine not only their immediate impact on a user's affective response, but also their delayed and/or residual impact.

Some aspects of this disclosure involve learning functions that represent the aftereffect of an experience at different times after having the experience. Herein, an aftereffect of an experience may be considered a residual affective response a user may have due to having the experience. In some embodiments, determining the aftereffect is done based on measurements of affective response of users who had the experience (e.g., these may include measurements of at least five users, or some other minimal number of users such as at least ten users). The measurements of affective response are typically taken with sensors coupled to the users (e.g., sensors in wearable devices and/or sensors implanted in the users). One way in which aftereffects may be determined is by measuring users before and after they finish the experience. Having these measurements may enable assessment of how having the experience changed the users' affective response. Such measurements may be referred to herein as “prior” and “subsequent” measurements. A prior measurement may be taken before finishing an experience (or even before having started it) and a subsequent measurement is taken after finishing the experience. Typically, the difference between a subsequent measurement and a prior measurement, of a user who had an experience, is indicative of an aftereffect of the experience.

In some embodiments, an aftereffect function of an experience may be considered to behave like a function of the form ƒ(Δt)=v, where Δt represents a duration that has elapsed since finishing the experience and v represents the value of the aftereffect corresponding to the time Δt. In one example, v may be a value indicative of the extent the user is expected to have a certain emotional response, such as being happy, relaxed, and/or excited at a time that is Δt after finishing the experience.

Various approaches may be utilized, in embodiments described herein, to learn parameters of the function mentioned above from the measurements of affective response. In some embodiments, the parameters of the aftereffect function may be learned utilizing an algorithm for training a predictor. For example, the algorithm may be one of various known machine learning-based training algorithms that may be used to create a model for a machine learning-based predictor that may be used to predict target values of the function (e.g., v mentioned above) for different domain values of the function (e.g., Δt mentioned above). Some examples of algorithmic approaches that may be used involve predictors that use regression models, neural networks, nearest neighbor predictors, support vector machines for regression, and/or decision trees. In other embodiments, the parameters of the aftereffect function may be learned using a binning-based approach. For example, the measurements (or values derived from the measurements) may be placed in bins based on their corresponding domain values. Thus, for example, each training sample of the form (Δt,v), the value of Δt may be used to determine in which bin to place the sample. After the training data is placed in bins, a representative value is computed for each bin; this value is computed from the v values of the samples in the bin, and typically represents some form of aftereffect score for the experience.

Some aspects of this disclosure involve learning personalized aftereffect functions for different users utilizing profiles of the different users. Given a profile of a certain user, similarities between the profile of the certain user and profiles of other users are used to select and/or weight measurements of affective response of other users, from which an aftereffect function is learned. Thus, different users may have different aftereffect functions created for them, which are learned from the same set of measurements of affective response.

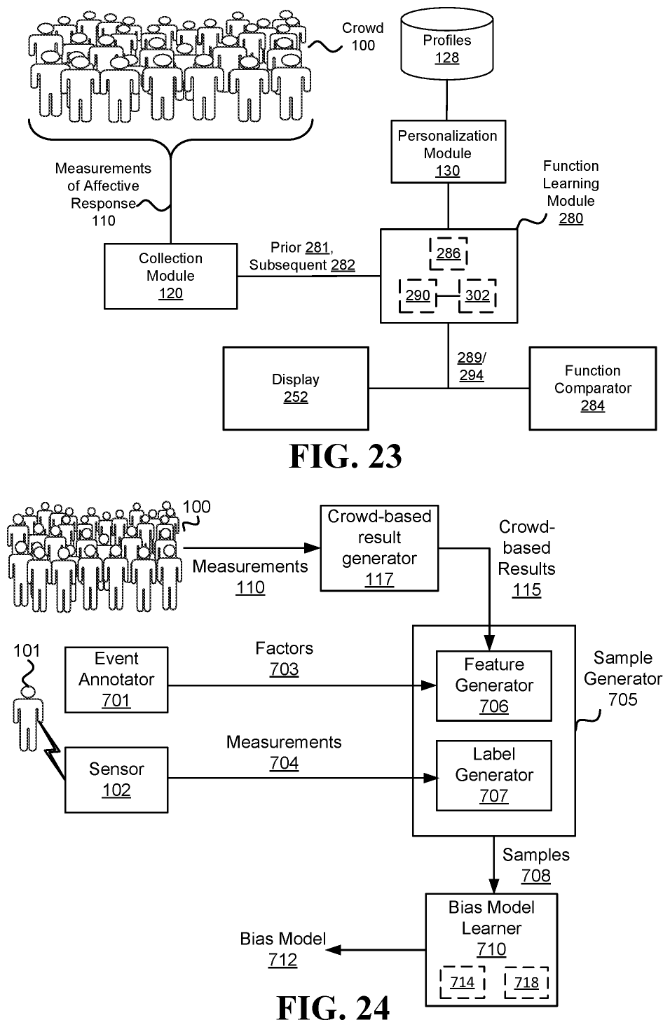

FIG. 23 illustrates a system configured to learn a function of an aftereffect of an experience. The function learned by the system (also referred to as an “aftereffect function”), describes the extent of the aftereffect of the experience at different times since the experience ended. The system includes at least collection module 120 and function learning module 280. The system may optionally include additional modules, such as the personalization module 130, function comparator 284, and/or the display 252.

The collection module 120 is configured, in one embodiment, to receive measurements 110 of affective response of users. The measurements 110 are taken utilizing sensors coupled to the users (as discussed in more detail at least in section 5—Sensors and section 6—Measurements of Affective Response). In this embodiment, the measurements 110 include prior and subsequent measurements of at least ten users who had the experience (denoted with reference numerals 281 and 282, respectively). A prior measurement of a user, from among the prior measurements 281, is taken before the user finishes having the experience. Optionally, the prior measurement of the user is taken before the user starts having the experience. A subsequent measurement of the user, from among the subsequent measurements 282, is taken after the user finishes having the experience (e.g., after the elapsing of a duration of at least ten minutes from the time the user finishes having the experience). Optionally, the subsequent measurements 282 comprise multiple subsequent measurements of a user who had the experience, taken at different times after the user had the experience. Optionally, a difference between a subsequent measurement and a prior measurement of a user who had the experience is indicative of an aftereffect of the experience on the user.

In some embodiments, the prior measurements 281 and/or the subsequent measurements 282 are taken with respect to experiences of a certain length. In one example, each user, of whom a prior measurement and subsequent measurement are taken, has the experience for a duration that falls within a certain window. In one example, the certain window may be five minutes to two hours (e.g., if the experience involves exercising). In another example the certain window may be one day to one week (e.g., in an embodiment in which the experience involves going on a vacation).

In some embodiments, the subsequent measurements 282 include measurements taken after different durations had elapsed since finishing the experience. In one example, the subsequent measurements 282 include a subsequent measurement of a first user, taken after a first duration had elapsed since the first user finished the experience. Additionally, in this example, the subsequent measurements 282 include a subsequent measurement of a second user, taken after a second duration had elapsed since the second user finished the experience. In this example, the second duration is significantly greater than the first duration. Optionally, by “significantly greater” it may mean that the second duration is at least 25% longer than the first duration. In some cases, being “significantly greater” may mean that the second duration is at least double the first duration (or even longer than that).

The function learning module 280 is configured, in one embodiment, to receive data comprising the prior and subsequent measurements, and to utilize the data to learn an aftereffect function. Optionally, the aftereffect function describes values of expected affective response after different durations since finishing the experience (the function may be represented by model comprising function parameters 289 and/or aftereffect scores 294, described below).

The prior measurements 281 may be utilized in various ways by the function learning module 280, which may slightly change what is represented by the aftereffect function. In one embodiment, a prior measurement of a user is utilized to compute a baseline affective response value for the user. In this embodiment, values computed by the aftereffect function may be indicative of differences between the subsequent measurements 282 of the at least ten users and baseline affective response values for the at least ten users. In another embodiment, values computed by the aftereffect function may be indicative of an expected difference between the subsequent measurements 282 and the prior measurements 281.

Embodiments described herein in may involve various types of experiences for which an aftereffect function may be learned using the system illustrated in FIG. 23. Following are a few examples of experiences and functions of aftereffects that may be learned. Additional details regarding the various types of experiences for which it may be possible to learn an aftereffect function may be found at least in section 7—Experiences in this disclosure.

Vacation—In one embodiment, the experience for which the aftereffect function is computed involves taking a vacation at a certain destination. For example, the certain destination may be a certain country, a certain city, a certain resort, a certain hotel, and/or a certain park. The aftereffect function in this embodiment may describe to what extent a user feels relaxed and/or happy (e.g., on a scale from 1 to 10) at a certain time after returning from the vacation; the certain time in this embodiment may be 0 to 10 days from the return from the vacation. Optionally, a prior measurement of the user may be taken before the user goes on the vacation (or while the user is on the vacation), and a subsequent measurement is taken at a time Δt after the user returns from the vacation. Optionally, in addition to the input value indicative of Δt, the aftereffect function may receive additional input values. For example, in one embodiment, the aftereffect function receives an additional input value d indicative of how long the vacation was (i.e., how many days a user spent at the vacation destination). Thus, in this example, the aftereffect function may be considered to behave like a function of the form ƒ(Δt,d)=v, and it may describe the affective response v a user is expected to feel at a time Δt after spending a duration of d at the vacation destination.

Treatment—In one embodiment, the experience for which the aftereffect function is computed involves receiving a treatment, such as a massage, physical therapy, acupuncture, aroma therapy, biofeedback therapy, etc. The aftereffect function in this embodiment may describe to what extent a user feels relaxed (e.g., on a scale from 1 to 10) at a certain time after receiving the treatment; the certain time in this embodiment may be 0 to 12 hours from when the user finished the treatment. In this embodiment, a prior measurement of the user may be taken before the user starts receiving the treatment (or while the user receives the treatment), and a subsequent measurement is taken at a time Δt after the user finishes receiving the treatment. Optionally, in addition to the input value indicative of Δt, the aftereffect function may receive additional input values. For example, in one embodiment, the aftereffect function receives an additional input value d that is indicative of the duration of the treatment. Thus, in this example, the aftereffect function may be considered to behave like a function of the form ƒ(Δt,d)=v, and it may describe the affective response v a user is expected to feel at a time Δt after receiving a treatment for a duration d.

Environment—In one embodiment, the experience for which the aftereffect function is computed involves spending time in an environment characterized by a certain environmental parameter being in a certain range. Examples of environmental parameters include temperature, humidity, altitude, air quality, and allergen levels. The aftereffect function in this example may describe how well a user feels (e.g., on a scale from 1 to 10) after spending time in an environment characterized by an environmental parameter being in a certain range (e.g., the temperature in the environment is between 10° F. and 30° F., the altitude is above 5000 ft., the air quality is good, etc.) The certain time in this embodiment may be 0 to 12 hours from the time the user left the environment. In this embodiment, a prior measurement of the user may be taken before the user enters the environment (or while the user is in the environment), and a subsequent measurement is taken at a time Δt after the user leaves the environment. Optionally, in addition to the input value indicative of Δt, the aftereffect function may receive additional input values. In one example, the aftereffect function receives an additional input value d that is indicative of a duration spent in the environment. Thus, in this example, the aftereffect function may be considered to behave like a function of the form ƒ(Δt,d)=v, and it may describe the affective response v a user is expected to feel at a time Δt after spending a duration d in the environment. In another example, an input value may represent the environmental parameter. For example, an input value q may represent the air quality index (AQI). Thus, the aftereffect function in this example may be considered to behave like a function of the form ƒ(Δt,d,q)=v, and it may describe the affective response v a user is expected to feel at a time Δt after spending a duration d in the environment that has air quality q.

In some embodiments, aftereffect functions of different experiences are compared. Optionally, such a comparison may help determine which experience is better in terms of its aftereffect on users (and/or on a certain user if the aftereffect functions are personalized for the certain user). Comparison of aftereffect functions may be done utilizing the function comparator module 284, which, in one embodiment, is configured to receive descriptions of at least first and second aftereffect functions that describe values of expected affective response at different durations after finishing respective first and second experiences. The function comparator module 284 is also configured, in this embodiment, to compare the first and second functions and to provide an indication of at least one of the following: (i) the experience, from among the first and second experiences, for which the average aftereffect, from the time of finishing the respective experience until a certain duration Δt, is greatest; (ii) the experience, from among the first and second experiences, for which the average aftereffect, from a time starting at a certain duration Δt after finishing the respective experience and onwards, is greatest; and (iii) the experience, from among the first and second experiences, for which at a time corresponding to elapsing of a certain duration Δt since finishing the respective experience, the corresponding aftereffect is greatest. Optionally, comparing aftereffect functions may involve computing integrals of the functions, as described in more detail in section 18—Learning Function Parameters.

In some embodiments, the personalization module 130 may be utilized to learn personalized aftereffect functions for different users by utilizing profiles of the different users. Given a profile of a certain user, the personalization module 130 may generate an output indicative of similarities between the profile of the certain user and the profiles from among the profiles 128 of the at least ten users. Utilizing this output, the function learning module 280 can select and/or weight measurements from among the prior measurements 281 and subsequent measurements 282, in order to learn an aftereffect function personalized for the certain user, which describes values of expected affective response that the certain user may have, at different durations after finishing the experience. Additional information regarding personalization, such as what information the profiles 128 may contain, how to determine similarity between profiles, and/or how the output may be utilized, may be found in section 15—Personalization.

### 20—Bias in Measurements of Affective Response

Affective response of a user may be viewed, in various embodiments described herein, as being a product of biases of the user. A bias, as used herein, is a tendency, attitude and/or inclination, which may influence the affective response a user has to an experience. Consequently, a bias may be viewed as responsible for a certain portion of the affective response to the experience; a bias may also be viewed as a certain change to the value of a measurement of affective response of a user to the experience, which would have not occurred had the bias not existed. When considering a bias effecting affective response corresponding to an event (i.e., the affective response of the user corresponding to the event to the experience corresponding to the event), the bias may be viewed as being caused by a reaction of a user to one or more factors characterizing the event. Such factors are referred to herein as “factors of an event”, “event factors”, or simply “factors”. Optionally, factors of an event may be determined from a description of the event (e.g., by an event annotator and/or a module that receives the description of the event). Additional details regarding factors of events are given in this disclosure at least in section 21—Factors of Events.

As typically used herein, a factor of an event corresponds to an aspect of an event. The aspect may involve the user corresponding to the event, such as a situation of the user (e.g., that the user is tired, late, or hungry). Additionally or alternatively, the aspect may involve the experience corresponding to the event (e.g., the experience is a social game, involves clowns, or costs a certain amount of money). Additionally or alternatively, the aspect may involve how the experience took place, such as a detail involving the instantiation of the event. For example, a factor may indicate that the event was thirty minutes long, that the event took place outdoors, or something more specific like that it rained lightly while the user corresponding to the event had the experience corresponding to the event, and the user did not have an umbrella.

Factors are typically objective values, often representing essentially the same thing for different users. For example, factors may be derived from analyzing descriptions of events, and as such can represent the same thing for events involving different users. For example, a factor corresponding to “an experience that takes place outdoors” will typically mean the same thing for different users and even different experiences. In another example, a factor corresponding to drinking 16 oz of a soda is typically a factual statement about what a user did.

As opposed to factors of events, which are mostly objective values, as used herein, bias represents how a user responds to a factor (i.e., bias represents the impact of the factor on affective response), and is therefore typically subjective and may vary between users. For example, a first user may like spicy food, while a second user does not. First and second events involving the first and second users may both be characterized by a factor corresponding to eating food that is spicy. However, how the users react (their individual bias) may be completely different; for the first user, the user's bias increases enjoyment from eating the spicy food, while for the second user, the user's bias decreases enjoyment from eating the spicy food.

As mentioned above, a bias may be viewed as having an impact on the value of a measurement of affective response corresponding to an event involving a user who has an experience. This may be due to an incidence in the event of a factor corresponding to the bias, which the user reacts to, and which causes the change in affective response compared to the affective response the user would have had to the experience, had there been no incidence of the factor (or were the factor less dominant in the event).

The effects of biases may be considered, in some embodiments, in the same terms as measurements of affective response (e.g., by expressing bias as the expected change to values of measured affective response). Thus, biases may be represented using units corresponding to values of physiological signals, behavioral cures, and/or emotional responses. Furthermore, biases may be expressed as one or more of the various types of affective values discussed in this disclosure. Though often herein bias is represented as a scalar value (e.g., a change to star rating or a change in happiness or satisfaction expressed on a scale from 1 to 10), similar to affective values, bias may represent a change to a multidimensional value (e.g., a vector representing change to an emotional response expressed in a multidimensional space such as the space of Valence/Arousal/Power). Additionally, herein, biases will often be referred to as being positive or negative. This typically refers to a change in affective response which is usually perceived as being better or worse from the standpoint of the user who is affected by the bias. So for example, a positive bias may lead to an increase in a star rating if measurements are expressed as star ratings for which a higher value means a better experience was had. A negative bias may correspond to a vector in a direction of sadness and/or anxiety when measurements of affective response are represented as vectors in a multidimensional space, in which different regions of the space correspond to different emotions the user may feel.

In some embodiments, biases may be represented by values (referred to herein as “bias values”), which quantify the influence of factors of an event on the affective response (e.g., a measurement corresponding to the event). For example, bias values may be random variables (e.g., the bias values may be represented via parameters of distributions). In another example, bias values may be scalar values or multidimensional values such as vectors. As typically used herein, a bias value quantifies the effect a certain factor of an event has on the affective response of the user. In some embodiments, the bias values may be determined from models generated using training data comprising samples describing factors of events and labels derived from measurements of affective response corresponding to the events. In some embodiments, the fact that different users may have a different reaction to individual factors of an event, and/or different combinations of factors of the event, may be represented by the users having different bias values corresponding to certain factors (or combinations thereof). A more detailed discussion of bias values is given at least in section 22—Bias Values.

In other embodiments, biases may be represented via a function (referred to herein as a “bias function”), which may optionally involve a predictor of affective response, such as Emotional Response Predictor (ERP). In this approach, the bias function receives as input feature values that represent factors of an event. Optionally, the factors may describe aspects of the user corresponding to an event, the experience corresponding to the event, and/or aspects of the instantiation of the event. Given an input comprising the factors (or based on the factors), the predictor generates a prediction of affective response for the user. In this approach, a user's biases (i.e., the user's “bias function”) may come to play by the way the values of factors influence the value of the predicted affective response. A more detailed discussion of bias functions is given at least in section 23—Bias Functions.

When handling measurements of affective response, such as computing a score for an experience based on the measurements, in some embodiments, measurements are considered to be the product of biases. When measurements are assumed to be affected by biases, at least some of these biases may be accounted for, e.g., by using normalization and/or transformations to correct the biases. Optionally, this may produce results that are considered unbiased, at least with respect to the biases being corrected. For example, based on repeated observations, it may be determined that the affective response of a user to eating food is, on average, one point higher than the average of all users (e.g., on a scale of satisfaction from one to ten). Therefore, when computing a score representing how users felt about eating a certain meal, the value of the measurement of the user may be corrected by deducting one point from it, in order to correct the user's positive bias towards food. With such corrections, it is hoped that the resulting score will depend more on the quality of the meal, and less on the composition of users who ate the meal and their varying attitudes towards food.

FIG. 24 illustrates a system configured to learn a bias model based on measurements of affective response. The system includes at least the following modules: sample generator 705, and bias model learner 710. The embodiment illustrated in FIG. 24, like other systems described in this disclosure, may be realized via a computer, such as the computer 400, which includes at least a memory 402 and a processor 401. The memory 402 stores computer executable modules described below, and the processor 401 executes the computer executable modules stored in the memory 402. It is to be noted that the experiences to which the embodiment illustrated in FIG. 24 relates, as well as other embodiments involving experiences in this disclosure, may be any experiences mentioned in this disclosure, or subset of experiences described in this disclosure, (e.g., one or more of the experiences mentioned in section 7—Experiences).

The sample generator 705 is configured to receive input comprising factors 703 and measurements 704, and to generate, based on the input, samples 708. The factors 703 are factors of events; each event involves a user corresponding to the event that has an experience corresponding to the event. The measurements 704, are measurements of affective response corresponding to the events; a measurement of affective response corresponding to the event is a measurement of affective response of the user corresponding to the event, taken with a sensor coupled to the user, while the user has the experience (or shortly thereafter). As such, a measurement may be considered a measurement of affective response of the user (corresponding to the event) to the experience (corresponding to the event). Optionally, a measurement of affective response of a user to an experience is based on at least one of the following values: (i) a value acquired by measuring the user, with the sensor, while the user has the experience, and (ii) a value acquired by measuring the user, with the sensor, at most one hour after the user had the experience. A measurement of affective response of a user to an experience may also be referred to herein as a “measurement of a user who had the experience”.

The measurements 704 of affective response are taken with sensors, such as sensor 102, which is coupled to the user 101. A measurement of affective response of a user is indicative of at least one of the following values: a value of a physiological signal of the user, and a value of a behavioral cue of the user. Embodiments described herein may involve various types of sensors, which may be used to collect the measurements 704 and/or other measurements of affective response mentioned in this disclosure. Additional details regarding sensors may be found at least in section 5—Sensors. Additional information regarding how measurements 704, and/or other measurements mentioned in this disclosure, may be collected and/or processed may be found at least in section 6—Measurements of Affective Response. It is to be noted that, while not illustrated in FIG. 24, the measurements 704, and/or other measurements of affective response mentioned in this disclosure, may be provided to the sample generator 705 via another aggregating module, such as collection module 120. Additional information regarding how the collection module 120 may collect, process, and/or forward measurements is given at least in section 13—Collecting Measurements. Optionally, the collection module 120 may be a component of the sample generator 705. It is to be noted that some embodiments of the system illustrated in FIG. 24 may also include one or more sensors that are used to obtain the measurements 704 of affective response, such as one or more units of the sensor 102.

In some embodiments, identifying the events, such as the events to which the factors 703 and/or the measurements 704 correspond, as well as other events mentioned in this disclosure, is done, at least in part, by event annotator 701. Optionally, the event annotator 701 generates descriptions of the events, from which the factors of the events may be determined. Optionally, the event annotator 701 may also select the factors 703 and/or set their values (e.g., assign weights to the factors 703).

Determining factors of events and/or weights of the factors of the events may involve utilization of various sources of information (e.g., cameras and other sensors, communications of a user, and/or content consumed by a user), and involve various forms of analyses (e.g., image recognition and/or semantic analysis). Optionally, each of the factors in a description of an event is indicative of at least one of the following: the user corresponding to the event, the experience corresponding to the event, and the instantiation of the event. Optionally, a description of an event may be indicative of weights of the factors, and a weight of a factor, indicated in a description of an event, is indicative of how relevant the factor is to the event.

Each of the samples 708 generated by the sample generator 705 corresponds to an event, and comprises one or more feature values determined based on a description of the event, and a label determined based on the measurement of affective response.

The term “feature values” is typically used herein to represent data that may be provided to a machine learning-based predictor. Thus, a description of an event, which is indicative of the factors 703, may be converted to feature values in order to be used to train a model of biases and/or to predict affective response corresponding to an event (e.g., by an ERP, as described in section 10—Predictors and Emotional State Estimators). Typically, but necessarily, feature values may be data that can be represented as a vector of numerical values (e.g., integer or real values), with each position in the vector corresponding to a certain feature. However, in some embodiments, feature values may include other types of data, such as text, images, and/or other digitally stored information.

In some embodiments, feature values of a sample are generated by feature generator 706, which may be a module that is comprised in the sample generator 705 and/or a module utilized by the sample generator 705. In one example, the feature generator 706 converts a description of an event into one or more values (feature values). Optionally, the feature values generated from the description of the event correspond to the factors of the event (i.e., factors characterizing the event). Optionally, each of the factors characterizing an event corresponds to at least one of the following: the user corresponding to the event, the experience corresponding to the event, and the instantiation of the event.

In some embodiments, labels for samples are values indicative of emotional response corresponding to events to which the samples correspond. For example, a label of a sample corresponding to a certain event is a value indicative of the emotional response of the user corresponding to the certain event, to having the experience corresponding to the certain event. Typically, the emotional response corresponding to an event is determined based on a measurement of affective response corresponding to the event, which is a measurement of the user corresponding to the event, taken while the user has the experience corresponding to the event, or shortly after.

Labels of the samples 708 may be considered affective values. Optionally, the labels are generated by label generator 707, which receives the measurements 704 and converts them to affective values. Optionally, to make this conversion, the label generator 707 utilizes an Emotional State Estimator (ESE), which is discussed in further detail in section 10—Predictors and Emotional State Estimators. In one example, a label of a sample corresponding to an event is indicative of a level of at least one of the following emotions: happiness, content, calmness, attentiveness, affection, tenderness, excitement, pain, anxiety, annoyance, stress, aggression, fear, sadness, drowsiness, apathy, and anger. In another example, a label of a sample corresponding to an event may be a numerical value indicating how positive or negative was the affective response to the event.

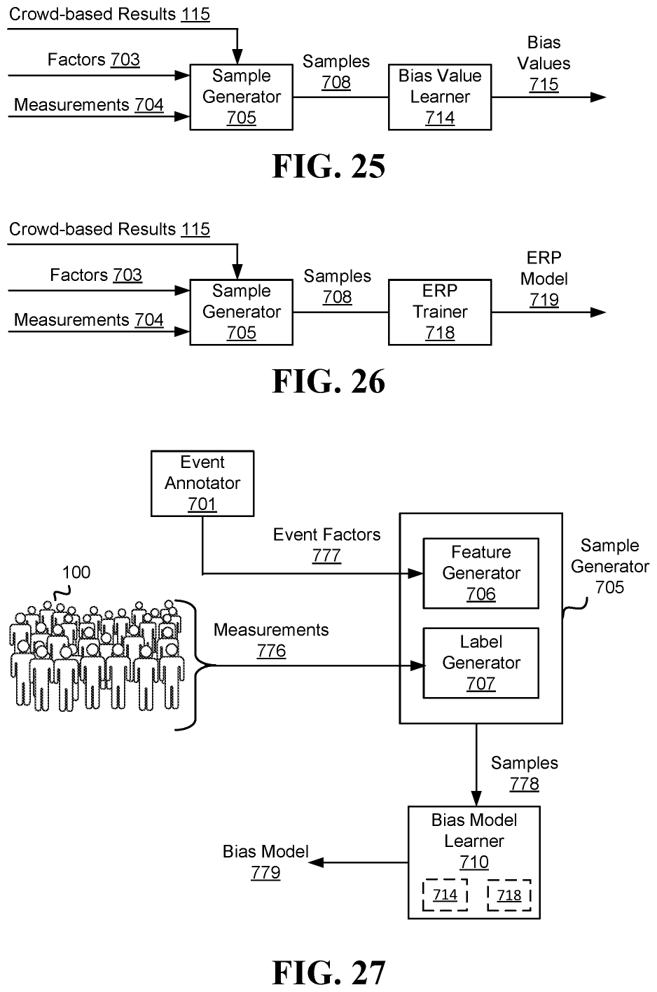

The bias model learner 710 is configured to utilize the samples 708 to generate bias model 712. Depending on the type of approach to modeling biases that is utilized, the bias model learner 710 may utilize the samples 708 in different ways, and/or the bias model 712 may comprise different values. One approach that may be used, which is illustrated in FIG. 25, involves utilizing bias value learner 714 to learn bias values 715 from the samples 708. Another approach that may be used, which is illustrated in FIG. 26, involves utilizing Emotional Response Predictor trainer (ERP trainer 718) to learn ERP model 719 from the samples 708. Following is a more detailed description of these two approaches.

It is to be noted that some embodiments of the system illustrated in FIG. 25 and/or FIG. 26 may include one or more sensors that are used to obtain the measurements 704 of affective response, such as one or more units of the sensor 102.

In some embodiments, the bias model learner 710 utilizes the bias value learner 714 to train the bias model 712, which in these embodiments, includes the bias values 715. Optionally, the bias value learner 714 is configured to utilize the samples 708 to learn the bias values 715. Optionally, each bias value corresponds to a factor that characterizes at least one of the events used to generate the samples 708 (i.e., each bias value corresponds to at least one of the factors 703). Optionally, a bias value that corresponds to a factor is indicative of a magnitude of an expected impact of the factor on a measurement corresponding to an event characterized by the factor. Optionally, a bias value may correspond to a numerical value (indicating the expected impact). Additionally or alternatively, the bias value may correspond to a distribution of values, indicating a distribution of impacts of a factor corresponding to the bias value.

Bias values are discussed in much more detail in section 22—Bias Values. That section also discusses the various ways in which bias values may be determined based on samples, e.g., by the bias value learner 714. In particular, the bias value learner may utilize various optimization approaches, discussed in the aforementioned section, in order to find an assignment of the bias values 715 which minimizes some objective function related to the samples, such as described in Eq. (2), Eq. (3), Eq. (5), and/or some general function optimization such as ƒ(\vec{B},V), described in the aforementioned section.

In one embodiment, in which at least some of the bias values are affective values, the bias value learner 714 is configured to utilize a procedure that solves an optimization problem used to find an assignment to the bias values 715 that is a local minimum of an error function (such as the functions mentioned in the equations listed above). Optionally, the value of the error function is proportional to differences between the labels of the samples 708 and estimates of the labels, which are determined utilizing the assignment to the bias values. For example, an estimate of a label of a sample corresponding to an event may be a function of the factors characterizing the event and the assignment of the bias values, such as the linear function described in Eq. (1).

In another embodiment in which at least some of the bias values correspond to distributions of affective values, the bias value learner 714 is configured to utilize a procedure that finds a maximum likelihood estimate of the bias values 715 with respect to the samples 708. Optionally, finding the maximum likelihood estimate is done by maximizing the likelihood expressed in Eq. (5) in section 22—Bias Values.

Depending on the composition of events used to generate the samples 708, the bias values 715 may include various types of values. In one embodiment, the events used to generate the samples 708 are primarily events involving a certain user; consequently, the bias values 715 may be considered bias values of the certain user. In some embodiments, one or more of the samples 708 include a certain factor that corresponds to events of different users; consequently, a bias value corresponding to the certain factor may be considered to represent bias of multiple users. For example, the same factor may represent the outside temperature, in which users have an experience; thus, a corresponding bias value learned based on samples of multiple users may indicate how the temperature affects the multiple users (on average). In some embodiments, the samples 708 may include samples involving different users, but each user may have a set of corresponding factors. Thus, the bias values 715 may be considered a matrix, in which each row includes bias values of a user to one of n possible factors, such that position i,j in the matrix includes the bias value of user i corresponding to the j^{th} factor.

In some embodiments, the bias model learner 710 utilizes the ERP trainer 718, which is configured to train, utilizing the samples 708, the bias model 712, which in these embodiments, includes the ERP model 719 for an ERP. Optionally, the ERP trainer 718 utilizes a machine learning-based training algorithm to train the ERP model 719 on training data comprising the samples 708. Utilizing an ERP may enable, in some embodiments, to model bias as a (possibly non-linear) function of factors. This approach to modeling bias is described in further detail in section 23—Bias Functions.

In one embodiment, the ERP is configured to receive feature values of a sample corresponding to an event, and to utilize the ERP model 719 to make a prediction of a label of the sample based on the feature values. Optionally, the label predicted by the ERP, based on the model and feature values of a sample corresponding to an event, represents an expected affective response of the user. Optionally, the ERP is configured to predict a label for a sample by utilizing the ERP model 719 to compute a non-linear function of feature values of the sample. ERPs and the various training procedures that may be used to learn their models are discussed in more detail in section 10—Predictors and Emotional State Estimators.

In some embodiments, an ERP that utilizes the ERP model does not predict the same values for all samples given to it as query (i.e., query samples). In particular, there are first and second query samples, which have feature values that are not identical, and for which the ERP predicts different labels. For example, if the first and second samples are represented as vectors, there is at least one position in the vectors, for which the value at that position in the vector of the first sample is different from the value at that position in the vector of the second sample. In one example, the first sample corresponds to a first event, involving a first experience, which is different from a second experience, involved in a second event, to which the second sample corresponds. In another example, the first sample corresponds to a first event, involving a first user, which is different from a second user, involved in a second event, to which the second sample corresponds. Optionally, prediction of different labels by the ERP means, e.g., in the two examples given above, that an affective response corresponding to the event to which the first sample corresponds, as predicted by the ERP, is not the same as an affective response corresponding to the event to which the second sample corresponds.

The composition of the samples 708, used to train the bias model 712, may have significant bearing, in some embodiments, on the type of modeling of biases that may be achieved with the bias model 712. Following, are some examples of how the composition of the samples 708 may vary between different embodiments of the systems modeled according to FIG. 24.

In some embodiments, the factors 703 and the measurements 704 correspond to events that primarily involve a certain experience, or a certain type of experience. Consequently, the bias model 712 learned from the samples 708 describes biases corresponding to factors that are related to the certain experience, or certain type of experiences. In other embodiments, the factors 703 and the measurements 704 correspond to events involving various experiences, and/or experiences of various types, which may enable the bias model 712 to reflect biases to a wide range of factors.

In some embodiments, the events to which the factors 703 and the measurements 704 correspond are related to a certain user (e.g., user 101). Thus, the bias model 712 learned in these embodiments may be considered a model of biases of the certain user. In other embodiments, the events to which the samples 708 correspond involve multiple users. This is illustrated in FIG. 27, in which the sample generator 705 receives measurements 776 of the users belonging to the crowd 100, and factors 777 corresponding to events involving those multiple users.

The samples 778, which are generated based on the measurements 776 and the factors 777, are utilized by the bias model learner 710 to generate bias model 779, which may be considered to model biases of multiple users. This figure is intended to illustrate a scenario in which measurements of multiple users are utilized to train a bias model, however, this does not limit other embodiments described in this disclosure to involve data from a single user. Moreover, in many of the embodiments described herein the measurements received by the sample generator 705 may be of various users (e.g., the users 100), and similarly, the factors 703 may also be factors of events involving multiple users. Thus, in some embodiments, the bias model 712 learned from such data may be considered to model biases of different users, while in other embodiments, the bias model 712 may be considered to model biases of a certain user. The descriptions of the events to which the factors 703 and the measurements 704 correspond, are not necessarily the same, even when involving the same experience. In some embodiments, a description of an event may include a factor corresponding to the user corresponding to the event. Thus, different events, even involving the same exact experience may have different descriptions, and different samples generated from those descriptions, because of different characteristics of the users corresponding to the events.

In one example, the samples 708 comprise a first sample corresponding to a first event in which a first user had a certain experience, and a second sample corresponding to a second event in which a second user had the certain experience. In this example, the feature values of the first sample are not identical to the feature values of the second sample. Optionally, this is because at least some of the factors describing the first user, in a description of the first event (from which the first sample is generated), are not the same as the factors describing the second user in a description of the second event (from which the second sample is generated).

In another example, the samples 708 comprise a first sample corresponding to a first event in which a certain user had a certain experience, and a second sample corresponding to a second event in which the certain user had the certain experience. In this example, the feature values of the first sample are not identical to the feature values of the second sample. Optionally, this is because at least some of the factors describing the instantiation of the first event, in a description of the first event (from which the first sample is generated), are not the same as the factors describing the instantiation of the second event in a description of the second event (from which the second sample is generated). For example, factors describing the length of the certain experience, the environmental conditions, and/or the situation of the certain user may be different for the different instantiations.

The fact that descriptions of events, and the samples generated from them, are not the same for all users and/or experiences, may lead to it that different factors are indicated, in the descriptions of the events, as characterizing the events. Optionally, this may also cause different features in the samples 708 to have different feature values.

In one example, the events to which the factors 703 and the measurements 704 correspond, comprise first, second, third, and fourth events, and the factors 703 comprise first and second factors. In this example, a first description of the first event indicates that the first factor characterizes the first event, and the first description does not indicate that second factor characterizes the first event. Additionally, a second description of the second event indicates that the second factor characterizes the second event, and the second description does not indicate that first factor characterizes the second event. Furthermore, a third description of the third event indicates that the first and second factors characterize the third event. And in addition, a fourth description of the fourth event does not indicate that the first factor characterizes the fourth event nor does the fourth description indicate that the second factor characterizes the fourth event.

In some embodiments, a factor describing a user corresponding to an event may come from a profile of the user, such as one of the profiles 128, utilized for personalization of crowd-based results. Optionally, the profile of the user comprises information that describes one or more of the following: an indication of an experience the user had, a demographic characteristic of the user, a genetic characteristic of the user, a static attribute describing the body of the user, a medical condition of the user, an indication of a content item consumed by the user, and a feature value derived from semantic analysis of a communication of the user.

In some embodiments, a description of and event may be indicative of at least one factor that characterizes the user corresponding to the event, which is obtained from a model of the user. Optionally, the model comprises bias values of the user, such as the bias values 715. Thus, in some embodiments, factors of an event (and/or the weights of the factors), may obtain their values from the bias model 712, and represent the results of a previous analysis of biases of the user corresponding to the event and/or of other users.

In some embodiments, the sample generator 705 (and/or the feature generator 706) is configured to generate one or more feature values of a sample corresponding to an event based on a crowd-based result relevant to the event. In these embodiments, in addition to the factors 703, and the measurements 704, the sample generator 705 may receive crowd-based results 115, which are relevant to the events to which the factors 703 and the measurements 704 correspond.

In one embodiment, measurements of affective response used to compute a crowd-based result that is relevant to an event are taken prior to the instantiation of the event. In another embodiment, the crowd-based result that is relevant to the event is computed based on at least some of the measurements 704. Optionally, a measurement corresponding to the event is utilized to compute the crowd-based result that is relevant to the event. Optionally, the crowd-based result is then used to determine at least one of the factors that characterize the event. For example, the crowd-based result may be indicative of the quality of the experience corresponding to the event, as determined based on measurements of users who had the experience in temporal proximity to the user corresponding to the event (e.g., within a few minutes, a few hours, or a few days from when the user had the experience). Optionally, the crowd-based result is computed based on at least some measurements taken before the instantiation of the event, and at least some measurements taken after the instantiation of the event.

As described above, in some embodiments, a measurement of affective response of a user may be considered to reflect various biases the user may have. Such biases may be manifested as a reaction to a corresponding factor, which causes a change (or is expected to cause a change) to the value of the measurement of affective response. In some embodiments, it may be beneficial to remove effects of certain biases from measurements before utilizing the measurements for various purposes, such as training models or computing scores, or other crowd-based results, based on the measurements. Removing the effects of certain biases may also be referred to herein as “correcting” the measurements with respect to the certain biases or “normalizing” the measurements with respect to the certain biases.

It is to be noted that the use of terms such as “correcting” or “corrected” (e.g., “correcting a bias” or a “corrected measurement”) is not intended to imply that correction completely removes the effects of the bias from a measurement. Rather, correcting a bias is an attempt, which may or may not be successful, at mitigating the effects of a bias. Thus, a corrected measurement (with respect to a bias), is a measurement that may be somewhat improved, in the sense that the effects of a bias on its value might have been mitigated. Correcting for bias is not guaranteed to remove all effects of the bias and/or to do so in an exact way. Additionally, correcting for a bias (resulting in a corrected measurement), does not mean that other biases (for which the correction was not made) are removed, nor does it mean that other forms of noise and/or error in the measurement are mitigated.

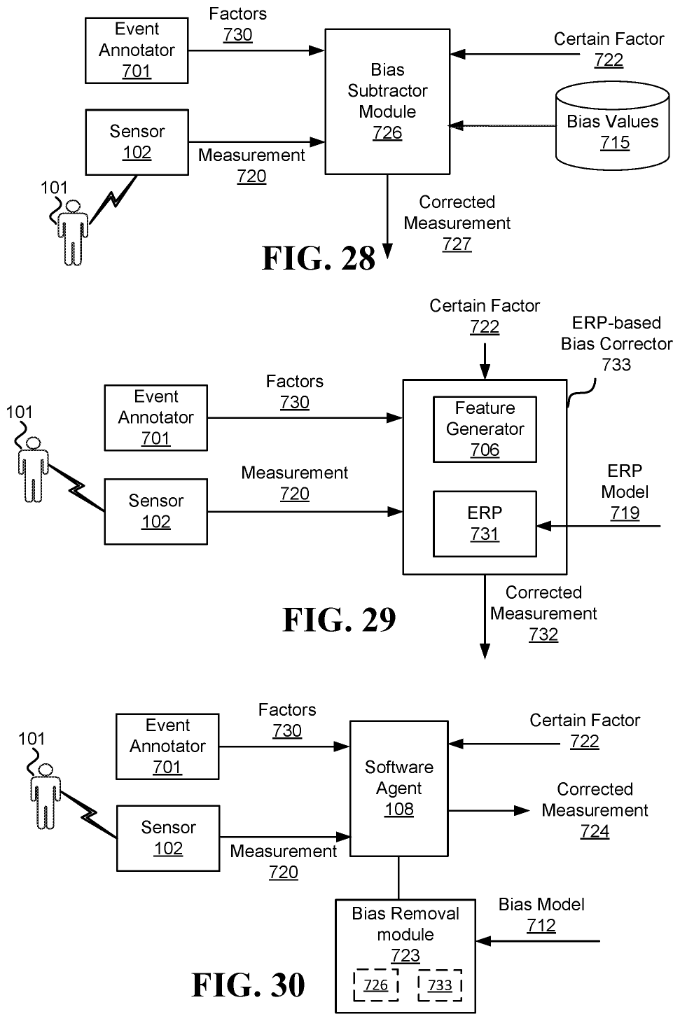

Following are a few examples of scenarios where correcting measurements with respect to certain biases may be beneficial. Some of the embodiments described below involve systems, methods, and/or computer products in which a bias is corrected in a measurement of affective response. The embodiments described below illustrate different approaches to correction of bias, which include both correction using a bias value (as illustrated in FIG. 28) and correction using an ERP (as illustrated in FIG. 29). Both approaches involve receiving a measurement of affective response of a user (e.g., measurement 720 of the user 101 taken with the sensor 102), and correcting the value of that measurement in a certain way.

FIG. 28 illustrates a system configured to correct a bias in a measurement of affective response of a user (e.g., the user 101). The system includes at least the sensor 102 and bias subtractor module 726. The system may optionally include other modules such as the event annotator 701.

The sensor 102 is coupled to the user 101 and is used to take the measurement 720 of affective response of the user 101. Optionally, the measurement 720 is indicative of at least one of the following: a physiological signal of the user 101, and a behavioral cue of the user 101. In one example, the sensor 102 may be embedded in a device of the user 101 (e.g., a wearable computing device, a smartphone, etc.) In another example, the sensor 102 may be implanted in the body of the user 101, e.g., to measure a physiological signal and/or a biochemical signal. In yet another example, the sensor 102 may be remote of the user 101, e.g., the sensor 102 may be a camera that captures images of the user 101, in order to determine facial expressions and/or posture.

It is to be noted that some portions of this disclosure discuss measurements 110 of affective response (the reference numeral 110 is used in order to denote general measurements of affective response); the measurement 720 may be considered, in some embodiments, to be one of those measurements, thus, characteristics described herein of those measurements may also be relevant to the measurement 720.

The measurement 720 corresponds to an event in which the user 101 has an experience (which is referred to as “the experience corresponding to the event”). The measurement 720 is taken while the user 101 has the experience, or shortly after that, as discussed in section 6—Measurements of Affective Response. The experience corresponding to the event may be one of the various types of experiences described in this disclosure (e.g., one of the experiences mentioned in section 7—Experiences).

The event to which the measurement 720 corresponds may be considered to be characterized by factors (e.g., factors 730). Optionally, each of the factors is indicative of at least one of the following: the user corresponding to the event, the experience corresponding to the event, and the instantiation of the event. Optionally, the factors may be described in, and/or derived from, a description of the event which is generated by the event annotator 701. Optionally, the factors have associated weights.

The bias subtractor module 726 is configured to receive an indication of certain factor 722, which corresponds to the bias that is to be corrected. Thus, the bias that is to be corrected may be considered a reaction of the user 101 to the certain factor 722 being part of the event. Additionally or alternatively, the bias subtractor module 726 is configured to receive a bias value corresponding to the certain factor 722. Optionally, the bias value is indicative of a magnitude of an expected impact of the certain factor 722 on affective response corresponding to the event.

In some embodiments, the bias value is received from a model comprising the bias values 715. Optionally, the bias values 715 are learned from data comprising measurements of affective response of the user 101 and/or other users, e.g., as described in the discussion above regarding FIG. 25 and FIG. 27. Optionally, the data from which the bias values 715 are learned includes measurements that correspond to events that are characterized by the certain factor 722. Optionally, at least some of the events involve experiences that are different from the experience corresponding to the event.

It is to be noted that the bias subtractor module 726 does not necessarily need to receive both the indication of the certain factor 722 and the bias value corresponding to the certain factor 722. In some cases, one of the two values may suffice. For example, in some embodiments, the bias subtractor module 726 receives the indication of the certain factor 722, and utilizes the indication to retrieve the appropriate bias value (e.g., from a database comprising the bias values 715). In other embodiments, the bias subtractor module 726 receives the bias value corresponding to the certain factor 722, possibly without receiving an indication of what the certain factor 722 is.

The bias subtractor module 726 is also configured to compute corrected measurement 727 of affective response by subtracting the bias value corresponding to the certain factor 722, from the measurement 720. Optionally, the value of the measurement 720 is different from the value of the corrected measurement 727. Optionally, the corrected measurement 727 is forwarded to another module, e.g., the collection module 120 in order to be utilized for computation of a crowd-based result. The corrected measurement 727 may be forwarded instead of the measurement 720, or in addition to it.

In one embodiment, the indication of the certain factor 722 is indicative of a weight of the certain factor 722, which may be utilized in order to compute the corrected measurement 727. In another embodiment, the weight of the certain factor 722 is determined from the factors 730, which may include weights of at least some of the factors characterizing the event. In still another embodiment, the certain factor 722 may not have an explicit weight (neither in the indication nor in the factors 730), and as such may have an implied weight corresponding to the certain factor 722 being a factor that characterizes the event (e.g., a weight of “1” that is given to all factors that characterize the event).

In one embodiment, correcting the bias involves subtracting the bias value corresponding to the certain factor 722 from the measurement 720. Optionally, the bias value that is subtracted is weighted according to the weight assigned to the certain factor 722. For example, if the weight of the certain factor 722 is denoted ƒ and its corresponding bias value is b, then correcting for the certain bias may be done by subtracting the term fb from the measurement. Note that doing this corresponds to removing the entire effect of the certain bias (it essentially sets the weight of the certain factor to ƒ=0). However, effects of bias may be partially corrected, for example, by changing the weight of the certain factor 722 by a certain Δƒ, in which case, the term Δƒ·b is subtracted from the measurement. Furthermore, correcting a certain bias may involve reducing the effect of multiple factors, in which case the procedure described above may be repeated for the multiple factors. It is to be noted that partial correction (e.g., Δƒ mentioned above) may be facilitated via a parameter received by the bias subtractor module 726 indicating the extent of desired correction. For example, the bias subtractor module 726 may receive a parameter a and subtract from the measurement 720 a value equal to αƒ·b.

In one embodiment, prior to correcting the bias, the bias subtractor module 726 determines whether the certain factor 722 characterizes the event. Optionally, this determination is done based on a description of the event, which is indicative of the factors 730. Optionally, for the bias to be corrected, the certain factor 722 needs to be indicated in the description as a factor that characterizes the event, and/or indicated in the description to have a corresponding weight that reaches a certain (non-zero) threshold. In one embodiment, if the certain factor 722 does not characterize the event or does not have a weight that reaches the threshold, then the corrected measurement 727 is not generated, and/or the value of the corrected measurement 727 is essentially the same as the value of the measurement 720.

In one example, measurements corresponding to first and second events, involving the same experience, are to be corrected utilizing the bias subtractor module 726. A first description of the first event indicates that the first event is characterized by the certain factor 722 and/or that the weight of the certain factor 722 as indicated in the first description reaches a certain threshold. A second description of the second event indicates that the second event is not characterized by the certain factor 722 or that the weight of the certain factor 722 indicated in the second description does not reach the certain threshold. Assuming that the bias value corresponding to the certain factor 722 is not zero, then in this example, a first corrected measurement, computed based on a first measurement corresponding to the first event, will have a different value than the first measurement. However, a second corrected measurement, computed based on a second measurement corresponding to the second event will have the same value as the second measurement.

Another approach to correcting bias is shown in FIG. 29, which illustrates another embodiment of a system configured to correct a bias in a measurement of affective response of a user (e.g., the user 101). The system includes at least the sensor 102 and an ERP-based Bias Corrector Module (ERP-BCM 733). The system may optionally include other modules such as the event annotator 701.

Similarly to the embodiment illustrated in FIG. 28, in embodiments modeled according to FIG. 29, the sensor 102 is coupled to the user 101, and is configured to take the measurement 720 of affective response of the user 101. In this embodiment too, the measurement 720 corresponds to an event in which the user 101 has an experience corresponding to the event, and the measurement 720 is taken while the user has the experience and/or shortly after that time.

In one embodiment, the system may optionally include the event annotator 701, which is configured to generate a description of the event. Optionally, the description comprises factors characterizing the event which correspond to at least one of the following: the user corresponding to the event, the experience corresponding to the event, and the instantiation of the event.

The Emotional Response Predictor-based Bias Corrector Module (ERP-BCM 733) is configured to receive an indication of the certain factor 722, which corresponds to the bias that is to be corrected. Additionally, the ERP-BCM 733 is configured to receive the measurement 720 and the factors 730, which characterize the event to which the measurement 720 corresponds (therefore, the factors 730 are also considered to correspond to the event).

The ERP-BCM 733 comprises the feature generator 706, which in this embodiment, is configured to generate a first set comprising one or more feature values based on the factors 730. The ERP-BCM 733 is configured to generate a second set of feature values, which is based on the first set. Optionally, the second set of feature values is determined based on a modified version of the factors 730, which corresponds to factors in which the weight of the certain factor 722 is reduced. In one embodiment, generating the second set is done by changing the values of one or more of the feature values in the first set, which are related to the certain factor 722. In another embodiment, generating the second set is done by altering the factors 730. For example, the certain factor 722 may be removed from the factors 730 or its weight may be decreased, possibly to zero, which may render it irrelevant to the event.

The ERP-BCM 733 also comprises ERP 731, which is utilized to generate first and second predictions for first and second samples comprising the first and second sets of features values, respectively. Optionally, to make the first and second predictions, the ERP 731 utilizes the ERP model 719. Optionally, the ERP model 719 is trained on data comprising measurements of affective response corresponding to events that are characterized by the certain factor 722. Optionally, the measurements used to train the model comprise measurements of affective response of the user 101, and at least some of the events to which the measurements correspond involve experiences that are different from the experience corresponding to the event. Optionally, the ERP 731 utilizes the ERP model 719 to compute a non-linear function of feature values. Optionally, the first and second predictions comprise affective values representing expected affective response of the user 101.

In some embodiments, the ERP-BCM 733 utilizes the first and second predictions to compute corrected measurement 732 based on the measurement 720. Optionally, the computation of the corrected measurement 732 involves subtracting a value proportional to a difference between the first and second predictions from the measurement 720. Optionally, the corrected measurement 732 has a different value than the measurement 720. For example, if the first prediction is a value v₁ and the second prediction is a value v₂, then a value of α(v₁−v₂) is subtracted from the measurement 720 to obtain the corrected measurement 732. Optionally, α=1, or has some other non-zero value (e.g., a value greater than 1 or smaller than 1). Optionally, the difference v₁−v₂ is indicative of a bias value corresponding to the certain factor 722.

In some of the embodiments described above (e.g., illustrated in FIG. 28 and FIG. 29), the indication of the certain factor 722, which corresponds to the bias that is to be corrected in the measurement 720 may originate from various sources and/or be chosen for various reasons.

In one embodiment, the certain factor 722 is provided by an entity that intends to utilize the measurement 720. For example, the entity may utilize the measurement 720 in order to compute a crowd-based result. In such a case, the entity may prefer to have the measurement 720 cleansed from certain biases which may render the crow-based result less accurate. In one example, the indication of the certain factor 720 is received from the collection module 120 and/or some other module used to compute a crowd-based result, as described in section 12—Crowd-Based Applications.

In another embodiment, the certain factor 722 is provided by an entity that wishes to protect the privacy of the user 101. For example, the entity may be a software agent operating on behalf of the user 101. In this case, the software agent may provide the indication in order to remove from the measurement 720 the effects of a bias, which may be reflected in the measurement 720 if it is released with its original value.

In yet another embodiment, the certain factor 722 may be a factor to which there is extreme bias (e.g., the bias of the user 101 towards the factor may be considered extreme or the bias of users in general towards the factor may be considered extreme). Optionally, the bias values 715 are examined in order to determine which factors have a corresponding bias value that is extreme, and measurements of affective response are corrected with respect to these biases.

When correcting bias in measurements of affective response utilizing a model, such as a model comprising the bias values 715 and/or the ERP model 719, it may be beneficial to determine whether the model is likely to be accurate in the bias correction. When applied to the correction of a certain bias, the inaccuracy of the model may stem from various reasons. In one example, the model may be trained incorrectly (e.g., they are trained with a training set that is too small and/or contains inaccurate data). Thus, bias values and/or predictions of affective response obtained utilizing the model may be inaccurate. In another example, the model may be provided with inaccurate factors of the event at hand. Thus, correction of bias in the event based on those inaccurate factors may consequently be inaccurate.

In some embodiments, determining whether model is accurate to a desired degree with respect to a certain event is done by comparing the measurement of affective response corresponding to the certain event to a predicted measurement of affective response corresponding to the certain event. Optionally, the predicted measurement of affective response is generated utilizing factors of the certain event and the model. If the difference between the measurement of affective response and the predicted measurement is below a threshold, then the model may be considered accurate (at least with respect to the certain event). Optionally, if the difference is not below the threshold, the model may not be considered accurate.

In the discussion above, the threshold may correspond to various values in different embodiments. For example, in one embodiment where the difference between the measurement and the predicted measurement can be expressed as a percentage, then the threshold may correspond to a certain percentage of difference in values, such as being at most 1%, 5%, 10%, 25%, or 50% different.

In one embodiment, if a model utilized for correcting bias is not considered accurate with respect to a certain event, then it is not utilized for bias correction or is utilized to a lesser extent (e.g., by making a smaller correction than would be done were the model considered accurate). In one example, in a case in which the bias values 715 are not considered accurate with respect to the event to which the measurement 720 corresponds, the correction of the bias corresponding to the certain factor 722 may be less extensive. For example, the corrected measurement 727 may have the same value as the measurement 720, or the difference between the corrected measurement 727 and the measurement 720 is smaller than the difference that would have existed had the model been considered accurate with respect to the event. In another example, in a case in which the ERP model 719 not considered accurate with respect to the event to which the measurement 720 corresponds, the correction of the bias corresponding to the certain factor 722 may be less extensive. For example, the corrected measurement 732 may have the same value as the measurement 720, or the difference between the corrected measurement 732 and the measurement 720 is smaller than the difference that would have existed had the ERP model 719 been considered accurate with respect to the event.

The embodiments described above (e.g., illustrated in FIG. 28 and FIG. 29) may be utilized to correct various forms of biases. The following are a couple of examples in which it may be beneficial to correct bias in measurements of affective response.

In one example, a user may have a positive bias towards the music of a certain band. Consider a case where a commercial (e.g., a car commercial) has as in its soundtrack music by the band that the user recognizes. In this case, a measurement of affective response of the user may reflect the positive bias to the certain band. If the measurement of the user is to be used, e.g., in order to decide how the user feels about the car or to compute a score reflecting how people feel about the car, it may be desirable to correct the measurement for the bias towards the band. By removing this bias, the corrected measurement is likely a better reflection of how the user feels about the car, compared to the uncorrected measurement that included a component related to the band.

In another example, a user may have a bias against people from a certain ethnic group. When an event involves a person of the certain ethnic group the user is likely to have an affective response to the event. For example, a server of a meal the user has at a restaurant belongs to the certain ethnic group. When computing a score for the restaurant it may be beneficial to normalize the measurement corresponding to the event by removing the unwanted bias towards the server's ethnicity. Having a measurement without such bias better reflects how the user felt towards the meal. It is likely that other people do not share the user's bias towards the server's ethnicity, and therefore, a measurement of the user that is corrected for such a bias better describes the experience those users might have (which will typically not involve a bias towards the server's ethnicity).

The examples given above demonstrate some scenarios in which bias may be corrected. The following are additional examples of what the certain factor 722 may be, and what experiences may be involved in events whose corresponding measurements are corrected with respect to a bias corresponding to the certain factor 722.

In one embodiment, the certain factor 722 is indicative of a value of a certain environmental condition prevailing in the environment in which the user 101 has the experience. In this embodiment, a bias value corresponding to the certain factor 722 may be indicative of an expected impact, on affective response of the user 101, of having an experience in an environment in which the environmental condition prevails. In one example, the certain environmental condition corresponds to an environmental parameter, describing the environment, being in a certain range. Optionally, the parameter is indicative of the temperature of the environment, and the certain range represents temperatures of a certain season of the year (e.g., the winter season).

In another embodiment, the certain factor 722 is indicative of the user 101 being alone while having an experience. In this embodiment, a bias value corresponding to the certain factor 722 may be indicative of an expected impact that having the experience, while the user 101 is alone, has on the affective response of the user 101. Similarly, the certain factor 722 may be indicative of the user 101 being in the presence of a certain person while having the experience. In this case, the bias value corresponding to the certain factor 722 may be indicative of an expected impact that having the experience, while the user 101 is in the presence of the certain person, has on the affective response of the user 101.

In still another embodiment, the event to which the measurement 720 corresponds involves an experience that comprises receiving a service from a person, and the certain factor 722 is indicative of at least one of the following: a demographic characteristic of the person, and a characteristic of the person's appearance. Optionally, the bias value corresponding to the certain factor 722 is indicative of an expected impact that the certain factor 722 has on the affective response of the user 101 when receiving service from a person characterized by the certain factor. In one example, the certain factor 722 is indicative of at least one of the following properties related to the person: the age of the person, the gender of the person, the ethnicity of the person, the religious affiliation of the person, the occupation of the person, the place of residence of the person, and the income of the person. In another example, the certain factor 722 is indicative of at least one of the following properties related to the person: the height of the person, the weight of the person, attractiveness of the person, facial hair of the person, and a type of clothing element worn by the person.

In one embodiment, a correction of a measurement with respect to a certain bias is done by a software agent operating on behalf of the user of whom the measurement is taken. Optionally, the software agent has access to a model of the user that includes bias values of the user (e.g., the bias values 715) and/or to a model of an ERP that was trained, at least in part, with samples derived from events involving the user and corresponding measurements of affective response of the user (e.g., the ERP model 719 may be such a model). Optionally, the software agent receives a list of one or more biases that should be corrected. Optionally, the software agent provides a measurement of affective response of the user that is corrected with respect to the one or more biases to an entity that computes a score from measurements of affective response of multiple users, such as a scoring module.

FIG. 30 illustrates a system configured to correct a bias in a measurement of affective response of a user (e.g., the user 101). The illustrated system is one in which software agent 108 is involved in the correction of the bias. Optionally, the software agent 108 operates on behalf of the user 101. The system includes at least the sensor 102 and bias removal module 723. Optionally, the system includes additional modules such as the event annotator 701. It is to be noted that though, as illustrated in the figure, modules such as the bias removal module 723 and/or the event annotator 701 are separate from the software agent 108. However, in some embodiments, these modules may be considered part of the software agent 108 (e.g., modules that are comprised in the software agent 108).

Similarly to the embodiments illustrated above (e.g., FIG. 28 and FIG. 29), the sensor 102 is coupled to the user 101, and is configured to take the measurement 720 of affective response of the user 101. In this embodiment too, the measurement 720 corresponds to an event in which the user 101 has an experience corresponding to the event, and the measurement 720 is taken while the user has the experience and/or shortly after that time. Optionally, the experience corresponding to the event may be one of the experiences described in section 7—Experiences.

In one embodiment, the system may optionally include the event annotator 701, which is configured to generate a description of the event. Optionally, the description comprises factors characterizing the event which correspond to at least one of the following: the user corresponding to the event, the experience corresponding to the event, and the instantiation of the event.

The bias removal module 723 is configured to identify, based on the description, whether the certain factor 722 characterizes the event. The bias removal module 723 is also configured to compute corrected measurement 724 by modifying the value of the measurement 720 based on at least some values in the bias model 712. Optionally, in this embodiment, the bias model 712 is trained based on data comprising: measurements of affective response of the user 101, corresponding to events involving the user 101 having various experiences, and descriptions of the events. Optionally, the value of the corrected measurement 724 is different from the value of the measurement 720.

In some embodiments, the bias model 712 may be considered private information of the user 101. Optionally, the bias model 712 may not be accessible to entities that receive the measurement 720. Thus, by having the software agent 108 mediate the correction of the bias, there is less risk to the privacy of the user 101, since there is no need to provide the other entities with detailed information about the user 101, such as the information comprised in the bias model 712.

There may be different implementations for the bias removal module 723. In one embodiment, the bias removal module 723 comprises the bias subtractor module 726, which is described in more detail above (e.g., in the discussion regarding FIG. 28). In this embodiment, the bias model 712 may include the bias values 715, and the corrected measurement 724 may be the same as the corrected measurement 727. In another embodiment, the bias removal module 723 comprises the ERP-BCM 733. In this embodiment, the bias model 712 may comprise the ERP model 719, and the corrected measurement 724 may be the same as the corrected measurement 732.

In one embodiment, the software agent 108 receives an indication of the certain factor 722 from an external entity, such as an entity that intends to utilize the corrected measurement 724 to compute to a crowd-based result utilizing the corrected measurement 724 (and other measurements). Optionally, the software agent 108 receives the indication of the certain factor 722 from the collection module 120 or a module that computes a score for experiences, such as the scoring module 150.

In another embodiment, the software agent 108 may have a list of factors corresponding to various biases that it is to correct in measurements of affective response of the user 101. For example, these biases may correspond to tendencies, attitudes, and/or a world view of the user 101 which should preferably not to be reflected in measurements of affective response of the user 101 which are disclosed to other entities. Optionally, the software agent 108 receives such a list of factors from an external entity. Additionally or alternatively, the software agent 108 may examine a model of the user 101 (e.g., the bias model 712) in order to detect factors to which the bias of the user 101 may be considered extreme.

The software agent 108 may, in some embodiments, serve as a repository which has memory (e.g., on a device of the user 101 or remote storage on a cloud-based platform). In these embodiments, the software agent 108 may store various measurements of affective response of the user 101 and/or details regarding the events to which the measurements correspond. For example, the details may be descriptions of the events generated by the event annotator 701 and/or factors of the events (e.g., determined by the event annotator 701). Optionally, storage of such information is done as part of “life logging” of the user 101.

In one embodiment, the software agent 108 may receive a request for a measurement of affective response of the user 101. The request includes an indication of the type of a type of an experience, and/or other details regarding an instantiation of an event (e.g., a certain time frame, environmental conditions, etc.) Additionally, the request may include an indication of one or more factors (which may include the certain factor 722). In this embodiment, responsive to receiving such a request, the software agent 108 may retrieve the measurement 720 from a memory storing the measurements of the user 101 and/or descriptions of events corresponding to the measurements. In one example, the description of the event to which the measurement 720 corresponds may indicate that it fits the request (e.g., it involves an experience of the requested type). The software agent 108 may then utilize the bias removal module 723 to correct the measurement 720 with respect to a bias of the user 101 to the one or more factors, and provide the requesting entity with the corrected measurement 724.

Whether correction of a measurement is performed may depend on whether or not the certain factor 722 characterizes the event to which the measurement corresponds. Thus, given two different measurements, corresponding to two different events, correction of bias may involve execution of different steps for the different measurements, as the following embodiment illustrates.

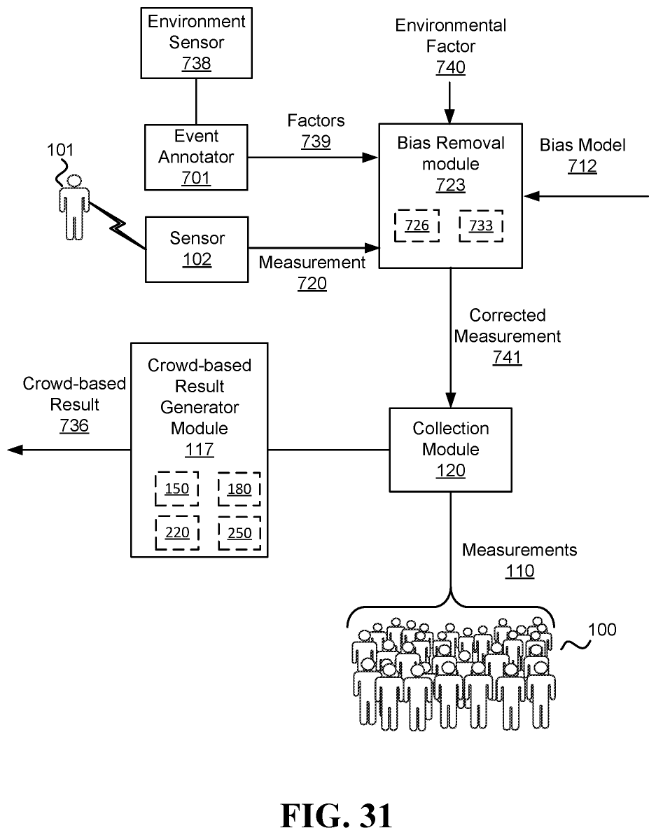

The following figures (FIG. 31 to FIG. 33) describe various embodiments, each involving a specific type of bias that is corrected in the measurement 720. In the embodiments described below, correction of the specific types of biases is done utilizing the bias removal module 723. The bias removal module 723 is provided with the measurement 720 of affective response of the user 101. The measurement 720 is taken with the sensor 102, which is coupled to the user 101. Additionally, the systems described below include the event annotator 701 that generates a description of the event to which the measurement 720 corresponds. Optionally, the description of the event is indicative of one or more factors characterizing the event, each of which corresponds to at least one of the following: the user corresponding to the event, the experience corresponding to the event, and the instantiation of the event.

In some embodiments, the bias removal module 723 and/or the event annotator 701 may be part of the software agent 108. In some embodiments, the bias removal module 723 and/or the event annotator 701 may be utilized to provide corrected measurements to modules such as collection module 120 and/or modules that generate crowd-based results (e.g., crowd-based result generator module 117 described herein).

In some embodiments, the bias removal module 723 may be utilized in different ways, as described, for example, in the discussion involving FIG. 28 and FIG. 29. In one example, the bias removal module 723 may perform a correction utilizing the bias subtractor module 726 (in this example, the bias model 712 may include the bias values 715). In another example, the bias removal module 723 may perform a correction utilizing the ERP-BCM 733 (in this example, the bias model 712 may include the ERP model 719).

In some embodiments, at least some of the data used to train the bias model 712 is data that involves the user 101; for example, the data includes measurements of affective response of the user 101, corresponding to events in which the user 101 had experiences. In other embodiments, at least some of the data used to train the bias model 712 is data that involves users other than the user 101; for example, the data includes measurements of affective response of users who are not the user 101, and these measurements correspond to events in which those users had experiences.

In some embodiments described below, the bias removal module 723 may receive indications of certain factors corresponding to the bias that is to be corrected. These certain factors may be referred by different reference numerals in order to indicate that they correspond to a certain type of factor (corresponding to the specific type of bias corrected in each embodiment). Nonetheless, these factors may all be considered similar to the certain factor 722 (e.g., they may be considered to have similar characteristics and/or a similar role in the systems as the certain factor 722 has). In a similar fashion, the corrected measurements in the embodiments below are referred to with various reference numerals to indicate that they each are corrected for a different type of bias. Additionally, the embodiments described below include the event annotator 701, which generates, in the different embodiments, descriptions of events indicating factors of the events. These factors may be referred to, in the different embodiments, with different reference numerals in order to indicate that the factors include a specific type of factor (corresponding to the specific type of bias corrected in each embodiment). Nonetheless, their characteristics and roles in the system are similar to the characteristics and role of the factors 703 described above.

FIG. 31 illustrates a system configured to correct a bias towards an environment in which a user has an experience. The system includes at least the event annotator 701 and the bias removal module 723.

The event annotator 701 is configured to generate a description of the event to which the measurement 720 corresponds. In one embodiment, the description is indicative of the factors 739, which include at least one factor characterizing the environment in which the user has the experience corresponding to the event. In one example, the factor characterizing the environment represents the season of the year during which the user has the experience. In another example, the factor characterizing the environment is indicative of an environmental condition in which a certain parameter that describes the environment has a certain value and/or has a value that falls within a certain range. Optionally, the certain parameter is indicative of one of the following: the temperature in the environment, the humidity level in the environment, extent of precipitation in the environment, the air quality in the environment, a concentration of an allergen in the environment, the noise level in the environment, and level of natural sun light in the environment.

In one embodiment, the event annotator 701 may receive information from environment sensor 738 that measures the value of an environmental parameter during the instantiation of the event. Optionally, the environment sensor 738 is not the sensor 102. Optionally, the environment sensor 738 is in a device of the user 101 (e.g., a sensor in a smartphone or a wearable device). Optionally, the environment sensor 738 is a sensor that provides information to a service that provides environmental data, such as a service that posts environmental data on the Internet.

The bias removal module 723 is configured, in one embodiment, to receive the measurement 720 of affective response corresponding to the event. The bias removal module 723 is also configured to determine whether the description of the event, generated by the event annotator 701, indicates that the instantiation of the event involves the user having the experience corresponding to the event in an environment characterized by a certain environmental condition. Optionally, the environmental factor 740, which may be considered a certain type of the certain factor 722, corresponds to the certain environmental condition. Responsive to determining, based on the description of the event, that the user 101 had the experience corresponding to the event in an environment characterized by the environmental factor 740, the bias removal module 723 computes corrected measurement 741. Optionally, the corrected measurement 741 reflects a correction, at least to a certain extent, of a bias of the user 101 towards the certain environmental condition. Optionally, the value of the corrected measurement 741 is different from the value of the measurement 720.

In one embodiment, the bias model 712 utilized by the bias removal module 723 is trained on certain data comprising: measurements of affective response corresponding to events involving having experiences in environments characterized by various environmental conditions. Optionally, the certain data comprises measurements of affective response of the user 101, corresponding to events involving the user having experiences in environments characterized by different environmental conditions (i.e., some of the events that are represented in the certain data are not characterized by the environmental factor 740).

It is to be noted that not all the events, to which the measurements in the certain data correspond, necessarily involve the user corresponding to the event having an experience in an environment characterized by the certain environmental condition corresponding to the environmental factor 740. In one example, the certain data used to train the bias model 712 comprises: (i) measurements of affective response corresponding to first and second events that involve a certain experience, and (ii) descriptions of the first and second events. In this example, the description of the first event indicates that the user corresponding to the first event had the experience in an environment characterized by the certain environmental condition, and the description of the second event does not indicate that the user corresponding to the second event had the experience in an environment characterized by the certain environmental condition.

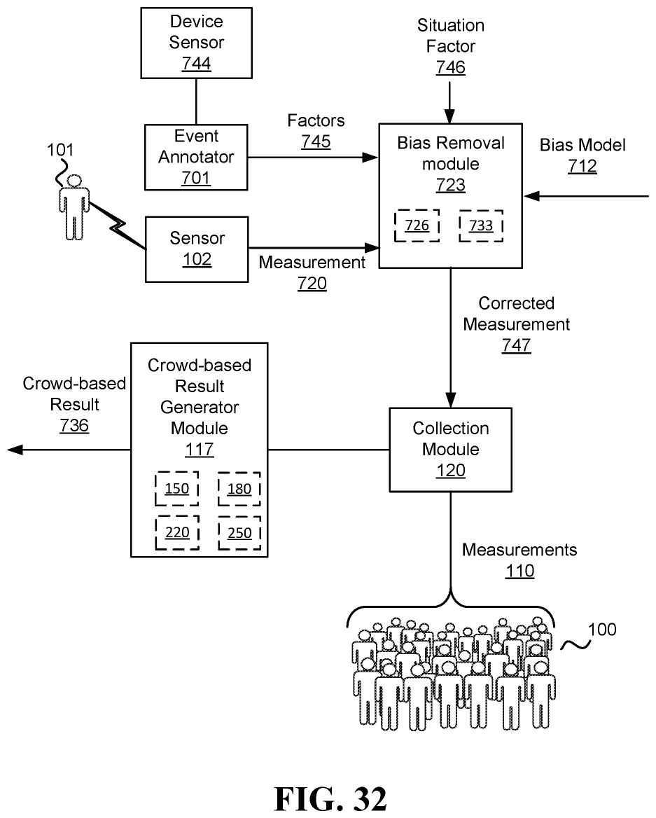

FIG. 32 illustrates a system configured to correct a bias towards a companion to an experience. For example, the companion may be a person with which the user 101 has an experience. The system includes at least the event annotator 701 and the bias removal module 723.

In one embodiment, a description of the event to which the measurement 720 corresponds, generated by the event annotator 701, is indicative of factors 745. In this embodiment, the factors 745 include at least one factor that indicates with whom the user corresponding to the event had the experience corresponding to the event. Optionally, the factors 745 include at least one factor that indicates that the user corresponding to the event had the experience corresponding to the event alone. Optionally, the experience may involve any of the experiences described in section 3—Experiences.

In one embodiment, the event annotator 701 may receive information from device sensor 744. Optionally, the device sensor 744 is not the sensor 102, which is used to take the measurement 720. Optionally, the device sensor 744 provides images and/or sound that may be utilized to identify people in the vicinity of the user. Optionally, the device sensor 744 detects devices in the vicinity of the user 101 based on the transmissions of the devices (e.g., Wi-Fi or Bluetooth transmissions). By identifying which devices are in the vicinity of the user 101, the event annotator 701 may determine who had the experience with a user during the instantiation of the event.

The bias removal module 723 is configured, in one embodiment, to receive the measurement 720 of affective response corresponding to the event, and to determine whether the description of the event, generated by the event annotator 701, indicates that the instantiation of the event involves the user having the experience along with a certain person. Optionally, the bias removal module 723 receives an indication of situation factor 746, which corresponds to the certain person (e.g., the situation factor identifies the certain person). Responsive to determining, based on the description of the event, that the user 101 had the experience corresponding to the event along with the certain person, the bias removal module 723 computes corrected measurement 747. Optionally, the corrected measurement 747 reflects a correction, at least to a certain extent, of a bias of the user 101 towards the certain person. Optionally, the value of the corrected measurement 747 is different from the value of the measurement 720.

In one embodiment, the bias model 712 utilized by the bias removal module 723 is trained on certain data comprising: measurements of affective response corresponding to events involving having experiences with the certain person, and measurements of affective response corresponding to events involving having experiences without the certain person. Optionally, at least some of the measurements are measurements of affective response of the user 101.

It is to be noted that not all the events, to which the measurements in the certain data correspond, necessarily involve the user corresponding to the event having an experience with the certain person. In one example, the certain data used to train the bias model 712 comprises: (i) measurements of affective response corresponding to first and second events that involve a certain experience, and (ii) descriptions of the first and second events. In this example, the description of the first event indicates that the user corresponding to the first event had the experience with the certain person, and the description of the second event does not indicate that the user corresponding to the second event had the experience with the certain person.

In one embodiment, the bias removal module 723 is configured to determine whether the description of the event indicates that the user 101 had the experience alone, and responsive to the description indicating thereof, to compute a corrected measurement. Optionally, the corrected measurement is obtained by modifying the value of the measurement 720 with respect to a bias of the user towards having the experience alone. Optionally, the bias model 712 in this embodiment is trained on data comprising: measurements of affective response corresponding to events involving having experiences alone, and measurements of affective response corresponding to events involving having experiences along with other people.

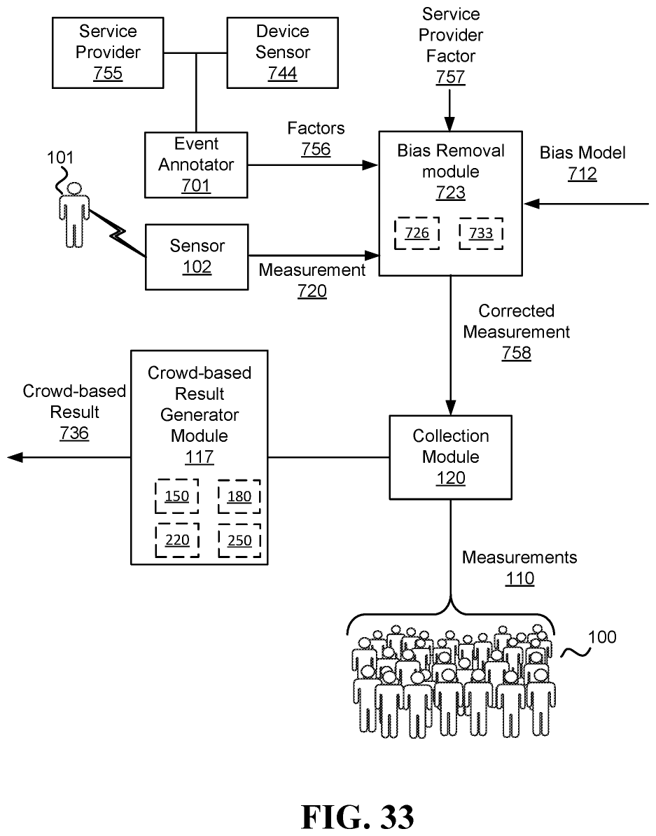

FIG. 33 illustrates a system configured to correct a bias of a user towards a characteristic of a service provider. The system includes at least the event annotator 701 and the bias removal module 723.

In one embodiment, a description of the event to which the measurement 720 corresponds, generated by the event annotator 701, is indicative of factors 756. In this embodiment, the event involves the user 101 having an experience that involves receiving a service from a service provider. Optionally, the factors 756 include at least one factor that is indicative of a characteristic of the service provider.

There are various types of service providers and characteristics to which users may have bias. In one example, the service provider is a robotic service provider, and the characteristic relates to at least one of the following aspects: a type of the robotic service provider, a behavior of the robotic service provider, and a degree of similarity of the robotic service provider to a human. In another example, the service provider is a person, and the characteristic corresponds to at least one of the following properties: gender, age, ethnicity, religious affiliation, sexual orientation, occupation, spoken language, and education. In yet another example, the service provider is a person, and the characteristic corresponds to at least one of the following properties: the person's height, the person's weight, the person's attractiveness, the person's build, hair style, clothing style, and eye color.

In one embodiment, the event annotator 701 may receive information from device sensor 744. Optionally, the device sensor 744 is not the sensor 102, which is used to take the measurement 720 of affective response. Optionally, the device sensor 744 provides images and/or sound that may be utilized to identify the service provider and/or the characteristic of the service provider.

The bias removal module 723 is configured, in one embodiment, to receive the measurement 720 of affective response corresponding to the event, and to determine whether the description of the event, generated by the event annotator 701, indicates that, as part of the experience, the user 101 received a service from a service provider having the characteristic. Optionally, the bias removal module 723 receives an indication of service provider factor 757, which corresponds to the characteristic. Responsive to determining, based on the description of the event, that the user 101, as part of the experience corresponding to the event, received service from a service provider that has the characteristic, the bias removal module 723 computes corrected measurement 758. Optionally, the corrected measurement 758 reflects a correction, at least to a certain extent, of a bias of the user 101 towards the characteristic. Optionally, the value of the corrected measurement 758 is different from the value of the measurement 720.

In one embodiment, the bias model 712 utilized by the bias removal module 723 is trained on certain data comprising: measurements of affective response corresponding to events involving a service provider having the characteristic, and measurements of affective response corresponding to events that do not involve a service provider having the characteristic. Optionally, at least some of the measurements are measurements of affective response of the user 101.

It is to be noted that not all the events, to which the measurements in the certain data correspond, necessarily involve the user corresponding to the event receiving service from a service provider having the characteristic. In one example, the certain data used to train the bias model 712 comprises: (i) measurements of affective response corresponding to first and second events involving a certain experience in which the user receives a service from a service provider, and (ii) descriptions of the first and second events. In this example, the description of the first event indicates that the user corresponding to the first event received service from a service provider having the characteristic, and the description of the second event does not indicate that the user corresponding to the second event received service from a service provider having the characteristic.

When a score for an experience is computed based on measurements of multiple users, it likely reflects properties that correspond to the quality of the experience as perceived by the multiple users. Additionally, the measurements may reflect various biases of the users who contributed measurements to the score, which may not be desired to be reflected in the score. Thus, in some embodiments, certain biases may be corrected in the measurements and/or when the score is computed, in order to obtain a more accurate score.

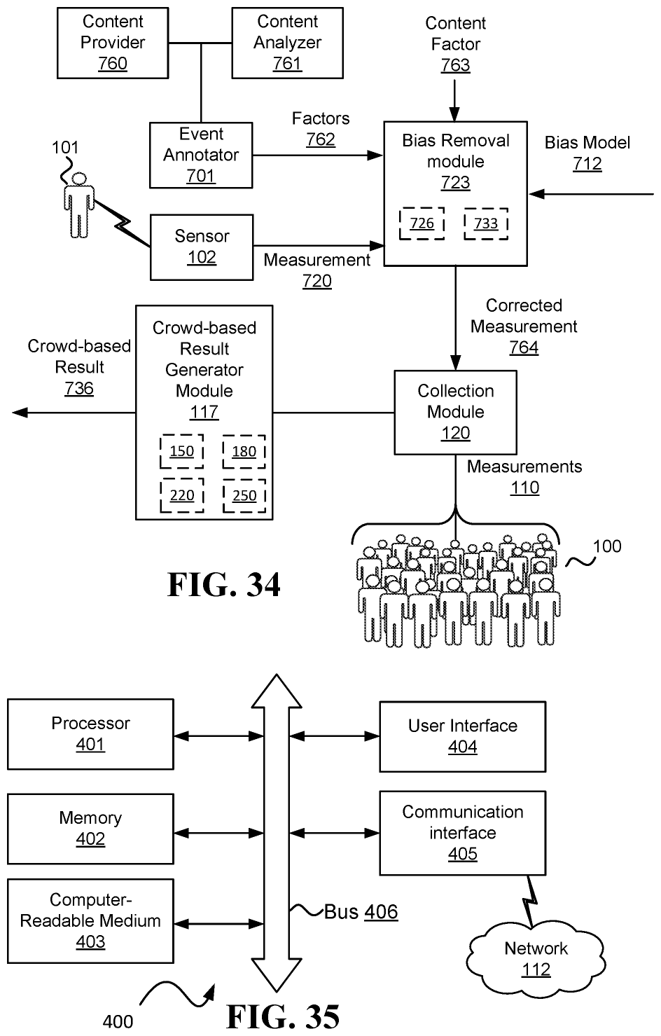

FIG. 34 illustrates a system configured to compute a crowd-based result based on measurements of affective response that are corrected with respect to a bias. The system includes at least the collection module 120, the bias removal module 723, and the crowd-based result generator module 117.

The collection module 120 is configured to receive measurements 110, which comprise measurements of affective response of at least five users. Optionally, each measurement of a user, from among the measurements of the at least five users, corresponds to an event in which the user has an experience, and is taken with a sensor coupled to the user. For example, the sensor may be the sensor 102.

It is to be noted that some embodiments of the system illustrated in FIG. 34 may include one or more sensors that are used to obtain the measurements 110 of affective response, such as one or more units of the sensor 102.

The bias removal module 723 is configured, in this embodiment, to receive an indication of the certain factor 722 corresponding to a bias to be corrected in a measurement corresponding to the event. Optionally, the certain factor 722 corresponds to at least one of the following: the user corresponding to the event, the experience corresponding to the event, and the instantiation of the event. Examples of the certain factor 722 may include the various factors mentioned in this disclosure as factors corresponding to bias that is to be corrected by the bias removal module 723, such as the environmental factor 740, the situation factor 746, the service provider factor 757, and/or the content factor 763.

The bias removal module 723 is also configured to compute, for each measurement from among the measurements of the at least five users, a corrected measurement by modifying the value of the measurement based on at least some values in a model. Optionally, to compute the corrected measurements for the at least five users (corrected measurements 735 in FIG. 34), the bias removal module 723 utilizes descriptions of the events to which the measurements of the at least five users correspond, which are generated by the event annotator 701. Optionally, each of the measurements of the at least five users is corrected, at least to a certain extent, with respect to the bias corresponding to the certain factor 722. Thus, the corrected measurements 735 are not identical to the measurements of affective response of the at least five users.

In one embodiment, the model utilized by the bias removal module 723 is trained based on data comprising measurements of affective response corresponding to events involving various experiences and descriptions of the events. In one example, the model may be the bias model 712. In another example, the model may be selected from one or more bias models 734. Optionally, the bias models belong to a database of bias models corresponding to the users belonging to the crowd 100 (e.g., they were trained on measurements of the users belonging to the crowd 100).

In one embodiment, when correcting a measurement of affective response of a certain user with respect to a bias corresponding to the factor 720, the bias removal module 723 utilizes a model from among the bias models 734, which corresponds to the certain user. For example, the model may be trained on data corresponding to a set of events, each of which involves the certain user having an experience. In this example, the data may include descriptions of events belonging to the set and measurements corresponding to the set.

The indication of the certain factor 722 may originate from various sources. In one example, the certain factor 722 is received from one of the users who provide the measurements 110, e.g., as an indication sent by a software agent operating on behalf of one of the users. In another example, the certain factor 722 is received from the collection module 120. And in yet another example, the certain factor 722 is received from the crowd-based result generator module 117.

There may be different implementations for the bias removal module 723 that may be used to compute the corrected measurements 735. In one embodiment, the bias removal module 723 comprises the bias subtractor module 726, which is described in more detail above (e.g., in the discussion regarding FIG. 28). In this embodiment, the bias model utilized by the bias removal module 723 may include bias values. In another embodiment, the bias removal module 723 comprises the ERP-BCM 733. In this embodiment, the bias model utilized by the bias removal module 723 may include one or more models for an ERP.

The crowd-based result generator module 117 is configured to compute crowd-based result 736 based on the corrected measurements 735. The crowd-based result generator module 117, may generate various types of crowd-based results that are mentioned in this disclosure. To this end, the crowd-based result generator module 117 may comprise and/or utilize various modules described in this disclosure. In one example, the crowd-based result 736 is a score for an experience, such as a score computed by the scoring module 150 or the dynamic scoring module 180. In another example, the crowd-based result 736 is a ranking of a plurality of experiences computed by the ranking module 220 or the dynamic ranking module 250.

Due to the correction of the bias corresponding to the certain factor 722, in some embodiments, the crowd-based result 736 is expected to be more accurate than the equivalent result computed based on the (uncorrected) measurements of the at least five users. This is because, the crowd-based result 736 may be assumed to be a more objective value of the quality of the experiences the at least five users had than the uncorrected measurements, and due to the correction, less of a reflection of biases the at least five users have.

An alternative to correction of biases in measurements of affective response, which may be utilized in some embodiments, is filtration of the measurements in order to remove measurements that likely contain an unwanted bias. After the filtration, the remaining measurements may be utilized for various purposes, such as computing a crowd-based result.

FIG. 58 illustrates a system configured to filter measurements that contain bias to a certain factor. The system includes at least the collection module 120, the event annotator 701, and bias-based filtering module 768.

It is to be noted that some embodiments of the system illustrated in FIG. 58 may include one or more sensors that are used to obtain the measurements 110 of affective response, such as one or more units of the sensor 102.

The collection module 120 is configured, in one embodiment, to receive the measurements 110 of affective response, which in this embodiment comprise measurements of at least eight users. Each measurement of a user, from among the measurements of the at least eight users, corresponds to an event in which the user (referred to as the user corresponding to the event) had an experience (referred to as the experience corresponding to the event). Optionally, the measurement is taken utilizing a sensor coupled to the user, such as the sensor 102, during the instantiation of the event or shortly thereafter.

The event annotator 701 is configured, in this embodiment, to generate descriptions of the events to which the measurements of the at least eight users correspond. Optionally, the description of each event is indicative of factors that characterize the event, and each factor corresponds to at least one of the following: the user corresponding to the event, the experience corresponding to the event, and the instantiation of the event. Optionally, the event annotator 701 used to create a description of an event is a module utilized by, or is part of, a software agent operating on behalf of the user.

The bias-based filtering module 768 is configured to create a subset of the measurements by excluding at least some of the measurements of the at least eight users from the subset. Optionally, the excluded measurements are measurements for which it is determined that the bias corresponding to a certain factor (the certain factor 769 in FIG. 58) reaches a threshold 771. That is, for each excluded measurement the following is true: (i) a description, generated by the event annotator 701, of a certain event, to which the excluded measurement corresponds, indicates that the certain factor 769 characterizes the certain event, and (ii) a bias value, representing the bias of the user corresponding to the certain event towards the certain factor 769, reaches the threshold 771. Optionally, the bias value, representing the bias of the user corresponding to the certain event towards the certain factor 769, is received from a repository comprising bias models 770, which holds the bias values of each of the at least eight users. Optionally, the bias value, representing the bias of the user corresponding to the certain event towards the certain factor 769, is received from a software agent operating on behalf of the user, which has access to a model comprising bias values of the user and/or a model for an ERP that may be utilized to compute the bias value.

In one embodiment, factors of the certain event may have corresponding weights indicative of their expected dominance and/or impact on the affective response of the user corresponding to the certain event. In such a case, a measurement may be filtered based on the expected (weighted) impact of the certain factor 769. That is, the measurement corresponding to the certain event is excluded from the subset if the product of the weight of the certain factor 769, as indicated in a description of the certain event, and a bias value corresponding to the certain factor 769, reaches the threshold 771.

In one embodiment, the bias value, representing the bias of the user corresponding to the event towards the certain factor 769, is computed based on measurements of affective response of the user corresponding to the event. For example, the bias value may be taken from a model comprising bias values of the user, such as the bias values 715. To obtain the bias values 715, in one embodiment, the sample generator 705 is utilized to generate samples based on data comprising: (i) measurements of affective response corresponding to events that are characterized by the certain factor 769, and (ii) descriptions of the events. The sample generator 705 may generate, based on the data, samples corresponding to the events. Optionally, each sample corresponding to an event comprises: feature values determined based on the description of the event, and a label determined based on a measurement corresponding to the event. The bias value learner 714 may utilize the samples to learn bias values that comprise the bias value corresponding to the certain factor 769.

In another embodiment, the bias value corresponding to the certain factor 769 is obtained utilizing an ERP-based approach. The feature generator 706 receives factors characterizing an event, which are determined based on a description of the event. The feature generator 706 generates first and second sets of feature values, where the first set of feature values is determined based on the factors, and the second set of feature values is determined based on a modified version of the factors, in which the weight of the certain factor 769 is reduced. The ERP 731 receives a model and utilizes the model to make first and second predictions for first and a second samples comprising the first and second sets of features values, respectively. Optionally, each of the first and second predictions comprises an affective value representing expected affective response. The bias value corresponding to the certain factor 769 is set to a value that is proportional to a difference between the second prediction and the first prediction (e.g., it may be the difference itself and/or the difference normalized based on the weight of the certain factor 769 indicated in the description of the event). Optionally, the model utilized to obtain a bias value of a certain user is trained on data comprising measurements of affective response of the certain user, and at least some of those measurements correspond to events that are characterized by the certain factor 769.

The certain factor 769 may correspond to one or more aspects of an event, such as the user corresponding to the event, the experience corresponding to the event, and the instantiation of the event. Examples of the certain factor 769 may include the various factors mentioned in this disclosure as factors corresponding to bias that is to be corrected by the bias removal module 723, such as the environmental factor 740, the situation factor 746, the service provider factor 757, and/or the content factor 763.

The indication of the certain factor 769 and/or the threshold 771 may be received by various entities. In one embodiment, the indication and/or the threshold 771 are sent by the collection module 120. In another embodiment, the indication and/or the threshold 771 are sent by a user from among the at least eight users. For example the indication and/or the threshold 771 may be sent by a software agent operating on behalf of the user. In still another embodiment, the indication and/or the threshold 771 may be sent by an entity that receives and/or computes the crowd-based result 772.

In some embodiments, the threshold 771 is computed based on bias values of users, which correspond to the certain factor 769. Optionally, the threshold 771 is greater than the median of the bias values which correspond to the certain factor 769.

The crowd-based result generator module 117 is configured to compute crowd-based result 772 based on the subset of the measurements. The subset, includes some, but not all, of the measurements of the at least eight users. Optionally, the subset includes measurements of at least five, of the at least eight users. Optionally, the crowd-based result 772 is a score computed for an experience, a ranking of a plurality of experiences, or some other result computed based on the subset of the measurements.

### 21—Factors of Events

As typically used herein, a factor of an event (also called an “event factor”) represents an aspect of an event (also referred to as an attribute related to the event). When the context is clear, a factor of an event may be referred to as simply a “factor”. The user corresponding to the event may have bias to the aspect represented by the factor, such that when the user is exposed to, and/or aware of, the factor, this may influence the affective response corresponding to the event (e.g., as determined from a measurement of the user corresponding to the event). Optionally, in a case in which an aspect of an event is expected (e.g., according to a model) to influence the affective response to the event, the factor corresponding to the aspect may be considered relevant to the event. Similarly, if an aspect of an event is not expected to influence the affective response to the event, the factor corresponding to the aspect may be considered irrelevant to the event. Herein, when a factor is considered relevant to an event, it may also be considered to “characterize” the event, and in a similar fashion, the event may be considered to be “characterized” by the factor.

An aspect of an event may relate to the user corresponding to the event, the experience corresponding to the event, and/or to the instantiation of the event. In addition to referring to a factor of an event as “representing an aspect of an event”, a factor of an event may also be referred to as “describing the aspect of the event”, and/or “corresponding to the aspect of the event”. Additionally, by corresponding to certain aspects of an event, it may also be said that factors describe the event and/or correspond to it. In such a case, a factor may said to be “a factor of a certain event”.

The terms “factor”, “factor of an event”, and the like, are to be interpreted similar to how the term “variable” may be used in the arts of programming and/or statistics. That is a factor may have an attribute it describes (i.e., the aspect of the event). For example, the attribute may describe the height of the user, the difficulty of the experience, and/or the temperature outside when the user had the experience. In some embodiments, factors may also have values, which are also referred to as weights. These values can describe a quantitative properties of the aspects to which the factors correspond. For example, values corresponding to the latter examples may be: 6′2″, 8 on a scale from 1 to 10, and 87° F. Additionally or alternatively, a value associated to a factor of an event may be indicative of the importance and/or dominance of an aspect to which the factor corresponds (in this case the value is often referred to as a weight). Optionally, the weight associated with a factor of an event is indicative of the extent of influence the factor is likely to have on the affective response of the user corresponding to the event. Optionally, the weight associated with a factor of an event is indicative of how relevant that factor is to the event. For example, the higher the weight, the more relevant the factor is considered. Optionally, a factor that is irrelevant to an event receives a weight that is below a threshold. Optionally, a factor that is irrelevant to an event receives a weight of zero. Setting a value and/or weight of a factor may also be referred to herein as assigning the factor with a value and/or weight.

In some embodiments, a factor of an event may have an associated value that is an indicator of whether a certain aspect of the event happened. Optionally, the indicator may be a binary weight, which is zero if the aspect didn't happen and one if it did. For example, a factor of an event may correspond to the user missing a train (it either happened or not), to the user having slept at least eight hours the night before, or to the user having taken prescribed medicine for the day. Depending on the embodiment, some factors corresponding to indicators may instead, or in addition, be represented by a weight describing quantitative properties of the aspects to which the factors correspond. For example, instead of having an indicator on the hours of sleep as described in the example above, the weight of such a factor may be the value representing the actual number of hours of sleep the user had.

In some embodiments, factors of events are derived from descriptions of the events (descriptions of events are discussed further at least in section 8—Events). Optionally, descriptions of events are produced by an event annotator (e.g., event annotator 701) and/or utilize data from various sources, as described further in section 9—Identifying Events.

### 22—Bias Values

There are various ways in which the effects of user biases on affective response may be modeled and/or represented in embodiments described herein. In particular, in some embodiments, biases may be considered to have values that are referred to as “bias values”. In some embodiments, the bias values are determined from parameters of models trained data that includes measurements of affective response corresponding to events. Below are descriptions of bias values and various ways they may be used in some embodiments, including notations and ways in which data may be utilized in order to learn bias values and/or correct measurements of affective response with respect to bias values. The description is provided for illustrative purposes; those skilled in the art will recognize that there may be other methods of notation that may be used, and other ways of handling, learning, and/or correcting biases that may be employed to achieve similar results.

Bias values may be expressed in various ways. In some embodiments, bias values are expressed in the same units as measurements of affective response and/or scores for experiences are expressed. For example, bias values may be expressed as affective values. Optionally, a bias value may represent a positive or negative value that is added to a measurement and may change the value of the measurement. In one example, a bias value represents a number of heart beats per minute (or a change in the number of heartbeats), e.g., a first bias may equal +5 beats per minute (PBM), while a second bias equal −10 BPM. In another example, a bias value represents a change in emotional response. In this example, emotional responses are expressed as points in the two-dimensional Valence/Arousal plane. A bias value may be expressed as an offset to points on this plane, such as an adding +2 to the Valence and +1 to the Arousal. In yet another example, a measurement of affective response may be a time series, such as a brainwave pattern of a certain frequency (band) that is recorded over a period of time. In this example, a bias value may also be expressed as a pattern which may be superposed on the measurement in order to change the pattern (i.e., incorporate the effect of the bias). And in still another example, a bias value may be a value added to a score, such as a value of −0.5 added to the score which may be a value on a scale from 1 to 10 that expresses a level of user satisfaction.

In some embodiments, measurements of affective response of users who had experiences are used to train a model that includes biases expressed via bias values; each of the experiences may correspond to something akin to visiting a location, participation in an activity, or utilizing a product. In the embodiments, each of those measurements of affective response may correspond to an event in which a certain user had a certain experience. Additionally, in some embodiments, for the purpose of analysis and/or model training, events may be assumed to belong to sets of events. Sets of events are denoted Vᵢ, for some 1≤i≤k, and the set of all events is denoted V, such that V=Uᵢ₌₁^{k}Vᵢ.

Following is a description of an embodiment in which a user's biases are modeled as bias values that correspond to factors. Thus, the effect of each factor on the affective response of the user is represented by its corresponding bias value. Given an event τ, the user corresponding to the event is denoted below u_{τ}, the experience corresponding to the event is denoted e_{τ}, and the measurement of affective response corresponding to the event is denoted m_{τ}. The set of factors of the event τ is represented below by the vector \vec{F}_{τ}=(ƒ₁, ƒ₂, . . . , ƒₙ). Optionally, \vec{F}_{τ} represents a vector of weights associated with factors of the event τ, such that weight of factor i is ƒᵢ (with some of the weights possibly being zero). As described in section 21—Factors of Events, \vec{F}_{τ} may contain various types of values, such as binary values or real values. If factors of an event are given as a set of factors, they may be still represented via a vector of factors, e.g., by having \vec{F}_{τ} be a vector with weights of one at positions corresponding to factors in the set, and a weight of zero in other positions.

The full set of bias values of a user u are represented below by a vector \vec{B}, with each value in a position in the vector \vec{B} corresponding to a certain factor. When referring to a certain event τ, the vector of bias values corresponding to the factors that characterize τ may be denoted \vec{B}_{τ}=(b₁, b₂, . . . , bₙ). Both the vectors \vec{F}_{τ} and \vec{B}_{τ} are assumed to be of the same length n. If \vec{F}_{τ} contains only a subset of all possible factors (e.g., it include only factors that are relevant to τ, at least to a certain degree), it is assumed that the vector \vec{B}_{τ} includes the corresponding bias values to the factors in \vec{F}_{τ}, and not the full set of bias values \vec{B}ᵤ (assuming the user u is the user corresponding to the event τ). Therefore, in Eq. (1) to Eq. (5), the same dimensionality is maintained for both vectors \vec{F}_{τ} and \vec{B}_{τ} corresponding to each event τ.

In some embodiments, a measurement corresponding to an event τ, denoted m_{τ}, may be expressed as function that takes into account the accumulated effect of factors represented by \vec{F}_{τ} with respect to the bias values represented by \vec{B}_{τ}, according to the following equation:

$${m}_{τ} = {μ}_{τ} + {\vec{F}}_{τ} \cdot {\vec{B}}_{τ} + ε = {μ}_{τ} + ( {\sum }_{i = 1}^{n} {f}_{i} \cdot {b}_{i} ) + ε \qquad ( 1 )$$

where μ_{τ} is a value representing an expected measurement value (e.g., a baseline), and ε is a noise factor drawn from a certain distribution that typically has a mean of zero, and is often, but not necessarily, a zero-mean Gaussian distribution such that ε˜N(0,σ²), for some σ>0.

Depending on the embodiment, μ_{τ} may represent different values. For example, in some embodiments μ_{τ} may be set to zero; this may indicate that the measurement of affective response m_{τ} is modeled as being dependent on the bias reaction of the user to factors representing the event. In other embodiments, μ_{τ} may be given values that may be non-zero; for example, μ_{τ} may represent a baseline value. In one embodiment, μ_{τ} is the same for all events (e.g., a baseline value for a certain user or of a group of users). In other embodiments, μ_{τ} may be different for different events. For example, μ_{τ} may be a baseline computed for the user u_{τ} based on measurements of affective response of u_{τ} taken a certain time before the instantiation of μ_{τ}. In another example, μ_{τ} may represent an expected measurement value for the experience e_{τ}. For example, μ_{τ} may be a baseline computed based on prior measurements of the user u_{τ} and/or other users to having the experience e_{τ}.

In some embodiments, ε from Eq. (1) may represent a sum of multiple noise factors that may be relevant to a certain event τ. Optionally, each of the multiple noise factors is represented by a zero-mean distribution, possibly each having a different standard deviation.

It is to be noted that discussions herein regarding bias values, such as the discussions about Eq. (1) to Eq. (5), are not meant to be limited to measurements and bias values that are scalar values. Measurements of affective response, as well as biases, may be expressed as affective values, which can represent various types of values, such as scalars, vectors, and/or time series. In one example, measurements and bias values may be represented as vectors, and thus Eq. (1) may express vector summation (and E in this case may be a vector of noise values). In another example, measurements and biases may represent time-series, wave functions, and/or patterns, and therefore, Eq. (1) may be interpreted as a summation or superposition of the time-series, wave functions, and/or patterns.

It is also to be noted that though Eq. (1) describes the measurement m_{τ} corresponding to an event τ as being the results of a linear combination of factors \vec{F}_{τ} and their corresponding bias values \vec{B}_{τ}, other relationships between factors of events and bias values may exist. In particular, various exponents c≠1 and/or d≠1 may be used to form an equation that is a generalization of Eq. (1) having the form m_{τ}=μ_{τ}+(Σᵢ₌₁ⁿƒᵢ^{c}^{ᵢ}·bᵢ^{d}^{ᵢ})+ε.

Furthermore, linear expressions such as Eq. (1) describe a simple relationship between a factor of an event and a bias value: the higher the weight of the factor, the more pronounce is the effect of the corresponding bias (since this effect may be quantified as ƒᵢ·bᵢ). However, in reality the actual bias is not always linear in the weight of the corresponding factor. For example, a person may like food to be salty, but only to a certain extent. In this case, modeling the effect of the user's generally positive bias to salt with a term of the form ƒᵢ·bᵢ where ƒᵢ represents an amount of salt and bᵢ represents a positive bias value, may not work well in practice. This is because, for large values of ƒᵢ, the linear effect described above gives a large positive bias when in reality it should be negative for large values of ƒᵢ (e.g., corresponding to tablespoons of salt in one's soup).

In one embodiment, a factor of an event may be processed using a feature generation function in order to obtain a value that better describes a range where the user's effect may be considered to be linear. Optionally, the feature generation function may transform a first value to another value describing how much the first value corresponds to the user's “comfort zone”.

In another embodiment, a factor may be split into separate factors, each covering a range of values and each having its own corresponding bias value. For example, in the scenario described above involving the salt, instead of having a single factor ƒᵢ=s, a feature generation function may create three factors, each having a weight “1” when s is in a certain range and a weight “0” otherwise. For example, given the amount of salt s, ƒ₁=1 if s<150 (and ƒ₁=0 otherwise), ƒ₂=1 if 150≤s≤300 (and ƒ₂=0 otherwise), and ƒ₃=1 if s>300 (and ƒ₃=0 otherwise). Note that in addition to indicators, the feature generation function may also provide features representing the magnitude of a value when it is in a certain region. Thus in the above example, the feature generation function may also provide factors ƒ₄, ƒ₅, and ƒ₆, such that ƒ₄=s if ƒ₁=1 (and ƒ₄=0 otherwise), ƒ₅=s if ƒ₂=1 (and ƒ₅₌₀ otherwise), and ƒ₆=s if ƒ₃=1 (and ƒ₆=0 otherwise). Note that utilizing additional factors that correspond to whether a value is in a certain region and others that describe the value when in a certain region can help, in some embodiments, to more accurately model effects of bias.

In some embodiments, in which measurements of affective response corresponding to events are modeled as additive functions of factors of the events and corresponding bias values, as described in Eq. (1), the bias values may be learned from training data. For example, the bias values for a certain user u, represented by the vector \vec{B}ᵤ (or simply \vec{B} when the context of the user is known) may be learned from a large set of events v involving the user u, with each event τ∈V having a corresponding vector of factors \vec{F}_{τ} and a corresponding measurement of affective response m_{τ}. Often such a learning process involves finding bias values that optimize a certain objective. In some embodiments, this amounts to a model selection problem of finding an optimal model in the space of possible assignments of values to the set of bias values \vec{B}.

There are various objectives, which may be used in embodiments described herein, according to which the merits of a model that includes bias values may be evaluated with respect to training data. One example of an objective that may be used is the squared error between the measurements corresponding to events in v and the values determined by adding bias values to the expected value μ_{τ}, as follows:

$$\begin{matrix}arg min \\ \vec{B}\end{matrix} \{ {\sum }_{τ ∈ V} {( {m}_{τ} - {μ}_{τ} - {\vec{F}}_{τ} \cdot {\vec{B}}_{τ} )}^{2} + λ {‖ \vec{B} ‖}^{2} \} \qquad ( 2 )$$

Eq. (2) describes an optimization problem in which the full set of bias values \vec{B} needs to be found, such that it minimizes the squared error, which is expressed as the sum of squared differences between the measurements of affective response corresponding to events in v and the values obtained by correcting the expected measurement value μ based on the bias values and factors of each event τ∈V. Note that similar to Eq. (1), μ_{τ} in Eq. (2) may be zero or some other value such as a baseline, as explained above.

Additionally, In Eq. (2), the term λ∥\vec{B}∥² is a regularization term, in which ∥\vec{B}∥ represents a norm of the vector \vec{B}, such as the L₂-norm. Regularization may be used in some embodiments in order to restrict the magnitude of the bias values, which can help reduce the extent of overfitting. The degree of regularization is set by the value of the parameter λ, which may be chosen a priori or set according to cross validation when training a predictive model (as explained in more detail below). It is to be noted that with λ=0, regularization is not employed in the model selection process. Additionally, in some embodiment regularization may be expanded to include multiple terms; for example, by providing different regularization parameters for different types of bias values.

There are various computational approaches known in the art that may be used to find bias values that minimize the squared error in Eq. (2), such as various linear regression techniques, gradient-based approaches, and/or randomized explorations of the search space of possible assignments of values to \vec{B}. Note that in a case in which no regularization is used and the noise ε from Eq. (1) is assumed to be normally distributed with the same standard deviation in all measurements, then minimizing Eq. (2) amounts to solving a set of linear equations. The solution found in this case is a maximum likelihood estimate of the bias values.

Another example of an objective for optimization, which may be used to find bias values based on the training data, is the sum of absolute errors, as follows:

$$\begin{matrix}arg min \\ \vec{B}\end{matrix} {\sum }_{τ ∈ V} \vert {m}_{τ} - {μ}_{τ} - {\vec{F}}_{τ} \cdot {\vec{B}}_{τ} \vert \qquad ( 3 )$$

With the optimization of Eq. (3), it may be assumed that the noise E of Eq. (1) comes from a Laplace distribution (in such a case, the solution to Eq. (3) may be considered a maximum likelihood estimate). Note that similar to Eq. (1), μ_{τ} in Eq. (3) may be zero or some other value such as a baseline, as explained above. Additionally, in a similar fashion to Eq. (2), a regularization factor may be added to Eq. (3) as well.

There are various computational methods known in the art that may be used to find a set of bias values that optimize the sum in Eq. (3), such as iteratively re-weighted least squares, Simplex-based methods, and/or various approaches for finding maximum likelihood solutions. Additionally, Eq. (3) can be extended to include linear constraints on the bias values. Optionally, the optimization may be framed as a problem of optimizing a set of linear constraints and be solved using linear programming.

The likelihood of the data is another example of an objective that may be optimized in order to determine bias values for a user. In some embodiments, each of the bias values in \vec{B} may be assumed to be a random variable, drawn from a distribution that has a certain set of parameters. Depending on the type of distributions used to represent the bias values, a closed-form expression may be obtained for the distribution of a weighted sum of a subset of the bias values. Thus, with a given set of training data that includes events with their corresponding factors and measurements of affective response, it is possible to find values of the parameters of the bias values which maximize the likelihood of the training data.

In one embodiment, each bias value is assumed to be a random variable B that is distributed according to a normal distribution with certain corresponding mean μ_{B} and variance σ_{B}², i.e., B˜N(μ_{B},σ_{B}²). Thus, given an event τ, it may be assumed that the vector \vec{B}=(B₁, B₂, . . . , Bₙ) is a vector with n random variables B₁, . . . , Bₙ, with each Bᵢ having a mean μ_{B}_{ᵢ} and a variance σ_{B}_{ᵢ}², such that Bᵢ˜N(μ_{B}_{ᵢ},σ_{B}_{ᵢ}²). Additionally, r has a corresponding vector of factors \vec{F}_{τ}=(ƒ₁, . . . , ƒₙ). Note that the values ƒᵢ are scalars and not random variables. The weighted sum of independent normally-distributed random variables is also a normally-distributed random variable. For example, if Xᵢ˜N(μᵢ,σᵢ²), for i=1, . . . , n, are n normally-distributed random variables, then Σᵢ₌₁ⁿ aᵢXᵢ˜N(Σᵢ₌₁ⁿ aᵢμᵢ, Σᵢ₌₁ⁿ(aᵢσᵢ)²). Thus, the probability of observing a certain measurement of affective response corresponding to an event given the parameters of the distributions of bias values, may be expressed as:

$$P ( μ + {\vec{F}}_{τ} \cdot \vec{B} = {m}_{τ} ) = P ( {μ}_{τ} + {\sum }_{i = 1}^{n} {f}_{i} \cdot {B}_{i} = {m}_{τ} ) \qquad ( 4 )$$

Where similar to Eq. (1), μ_{τ} may be zero or some other value such as a baseline, and σ_{ε}² is the variance of noise in the measurement m_{τ} (σ_{ε}² may be zero or some other value greater than zero). The expression of the form N(x|a,b²) represents the probability of x under a normal probability distribution with mean a and variance b², i.e.,

$$N ( x \vert a , {b}^{2} ) = \frac{1}{\sqrt{2 π {b}^{2}}} {e}^{- \frac{{( x - a )}^{2}}{2 {b}^{2}}} .$$

Let θ to denote all the parameter values (i.e., θ includes the parameters of the mean and variance of each bias value represented as a random variable). And let v be a set comprising k events τ₁, . . . , τₖ, with each event τᵢ, i=1 . . . k, having a corresponding measurement m_{τ}_{ᵢ} and a corresponding vector of factors \vec{F}_{τ}_{ᵢ}. The likelihood of the data v given the parameters θ, is denoted P(V|θ). Thus in this example, learning parameters of bias values amounts to following an assignment to θ that maximizes the likelihood:

$$P ( V \vert θ ) = {\prod }_{i = 1}^{k} P ( {μ}_{{τ}_{i}} + {\vec{F}}_{{τ}_{i}} \cdot {\vec{B}}_{{τ}_{i}} = {m}_{{τ}_{i}} \vert θ ) \qquad ( 5 )$$

Finding the set of parameters θ for which P(V|θ) is at least locally maximal (a maximum likelihood estimate for θ) may be done utilizing various approaches for finding a maximum likelihood estimate, such as analytical, heuristic, and/or randomized approaches for searching the space of possible assignments to θ.

In some embodiments, which involve bias values as described in Eq. (1) to Eq. (3), the bias values may be assumed to be independent of each other. Similarly, in some embodiments, the random variables in Eq. (4) and Eq. (5), may be assumed to be i.i.d random variables. There may be embodiments in which such independence assumptions do not hold in practice, but rather are only violated to a certain (acceptable) degree. Thus, the bias modeling approaches described above are still applicable and useful in embodiments where the independence assumptions may not always hold. Optionally, in some embodiments, dependencies between bias values may be modeled utilizing joint distributions of bias values. For example, the likelihood in Eq. (5) may be modeled utilizing a graphical model (e.g., a Bayesian network) having a structure that takes into account at least some of the dependencies between biases. In another example, certain factors may be generated by combining other factors; thus a bias value corresponding to the combination of factors will take into account dependencies between bias values.

In some embodiments, finding the values of bias values in \vec{B} may be done utilizing a general function of the form ƒ(\vec{B},V), which returns a value indicative of the merit of the bias values of \vec{B} given the measurement data corresponding to the events in V. Depending on the nature of the function ƒ(\vec{B},V) various numerical optimization approaches may be used. Additionally, an assignment of bias values for \vec{B} may be searched utilizing various random and/or heuristic approaches (e.g., simulated annealing or genetic algorithms), regardless of the exact form of ƒ, which may even not be known in some cases (e.g., when ƒ is computed externally and is a “black box” as far as the system is concerned).

Training parameters of models, e.g., according to Eq. (2), Eq. (3), Eq. (5), and/or some general function optimization such as ƒ(B,V) described above, involves setting model parameters based on samples derived from a set of events V. Optionally, each sample derived from an event τ∈V includes the values of the factors of the event (\vec{F}_{τ}) and the measurement corresponding to the event (m_{τ}). The accuracy of a parameter in a model learned from such data may depend on the number of different samples used to set the parameter's value. Depending on the type of model being trained, a parameter may refer to various types of values. In one example, the parameter may be a certain bias value, such as a value in one of the positions in the vector \vec{B} in Eq. (1), and/or a certain distribution parameter, such as one of the μ_{B}_{ᵢ} or σ_{B}_{ᵢ} in Eq. (4). As described above, each parameter in the model has a corresponding factor, such that when training the model, the value of the factor in various samples may influence the value assigned to the parameter. Thus, a sample that is used for training a parameter involves an event for which the factor corresponding to the parameter is a relevant factor (e.g., it belongs to a set of relevant factors or it has a non-zero weight that is larger than a threshold). Additionally, stating that a sample is used to set the value of a parameter implies that in the sample, the factor corresponding to the parameter is a relevant factor (e.g., the factor has a non-zero weight that is greater than the weight assigned to most of the factors in that sample).

Typically, the more different samples are used to set a parameter, the more accurate is the value of the parameter. In particular, it may be beneficial to have each parameter set according to at least a certain number of samples. When the certain number is low, e.g., one, or close to one, the values parameters receive in training may be inaccurate, in the sense that they may be a result of overfitting. Overfitting is a phenomenon known in the art that is caused when too few samples are used to set a value of a parameter, such that value tends to conform to the values from the samples and not necessarily represent the value corresponding to the actual “true” parameter value that would have been computed were a larger number of samples been used. Therefore, in some embodiments, when computing parameters, e.g., according to Eq. (2), Eq. (3), Eq. (5), and/or some general function optimization such as ƒ(\vec{B},V) described above, a minimal number of training samples used to set the value a parameter is observed, at least for most of the parameters (e.g., at least 50%, 75%, 90%, 95%, 99%, or more than 99% of the parameters in the model). Alternatively, the minimal number of training samples used to set each parameter is observed for all the parameters (i.e., each parameter in the model is set by samples derived from at least the certain number of different events). Optionally, the minimal number is at least 2, 5, 10, 25, 100, 1000, or more, different events.

In some embodiments, certain factors of an event, and/or their corresponding bias values, may be filtered out (e.g., by explicitly setting them to zero) if they are below a certain threshold. Optionally, when the values are below the certain threshold, they are considered noise, which when included in a model, e.g., when predicting affective response according to Eq. (1) are suspected of decreasing the accuracy, rather than increasing it. In one example, a factor ƒᵢ is filtered out (or ƒᵢ is explicitly set to zero) if |ƒᵢ|<t₁, where t₁ is a threshold greater than zero. In another example, a bias value bᵢ is filtered out (or bᵢ is explicitly set to zero) if |bᵢ|<t₂, where t₂ is a threshold greater than zero. And in another example, a term ƒᵢ·bᵢ, e.g., as used in Eq. (1), is filtered out or explicitly set to zero if |ƒᵢ·bᵢ|<t₃, where t₃ is a threshold greater than zero. Optionally, in the examples above, the thresholds t₁, t₂, and t₃ are set to such values that correspond to a noise level (e.g., as determined from multiple events). Filtering of the factors, bias values, and/or terms that are below their respective thresholds may, in some embodiments, reduce the number of factors and bias values that are considered, to a large extent. For example, such filtration may leave only a small number of terms when utilized by a model, possibly even only one or two factors and bias values. In some cases, the above filtration may remove all factors and bias values from consideration, essentially resorting to modeling a measurement of affective response by using a baseline value. For example, extensive filtration of possibly noisy factors and/or bias values may reduce Eq. (1) to something of the form m_{τ}=μ_{τ}+ε.

The discussion regarding training models according to Eq. (2), Eq. (3), Eq. (5), and/or some general function optimization such as ƒ(\vec{B},V) described above, refers to training models involving bias values for individual users. Thus, the events in a set v may involve events of an individual user. However, those skilled in the art will recognize that the discussion and results mentioned above may be extended to training models of multiple users, such that biases of multiple users may be learned in the same training procedure. In this case, the set v may include events involving multiple users.

In particular, in some embodiments, values of certain bias parameters (e.g., certain bias values or distribution parameters described above), may be shared by multiple users. For example, a certain bias may involve multiple users belonging to a certain group (e.g., a certain ethnic group, gender, age group, etc.), who are assumed to have a similar reaction to a certain factor of an event. For example, this may model an assumption (which may not necessarily be correct) that all elderly people react similarly to rap music, or all politicians react similarly to golf. In some embodiments, setting parameters according to multiple users may be advisable if each user is involved in only a small number of events (e.g., smaller than the minimal number mentioned above). In such a case, setting parameters according to samples from multiple users may increase accuracy and reduce instances of overfitting the parameters to the training data.

### 23—Bias Functions

The previous section described an approach in which biases are represented through bias values that correspond to factors of an event. A common characteristic of some embodiments using such an approach is that the effect of the biases is modeled as being governed by a structured, relatively simple, closed-form formula, such as Eq. (1). The formula typically reflects an assumption of independence between factors and between bias values, and is often linear in the values of the relevant bias values and weights of factors. However, in some embodiments, the effects of biases may be modeled without such assumptions about the independence of factors, and a formula involving factors and bias values that is additive and/or linear. In particular, in some embodiments, the effects of biases may be complex and reflect various dependencies between factors that may influence affective response of users in a non-linear way.

In some embodiments, bias functions, described in this section, model effects of biases while making less restricted assumptions (e.g., of independency and/or linearity of effects), compared to linear functions of bias values and factors described in the previous section. Optionally, bias functions are implemented using machine learning—based predictors, such as emotional response predictors like ERPs, which are described in more detail at least in section 10—Predictors and Emotional State Estimators.

In some embodiments, implementing a bias function is done utilizing an ERP that receives as input a sample comprising feature values that represent factors related to an event τ=(u,e). For example, a sample may comprise values of factors, such as values from \vec{F}_{τ} described in previous sections, and/or values derived from the factors. Additionally or alternatively, the sample may include various other values derived from a description of the event r, as discussed in section 8—Events. These other values may include values describing the user u, the experience e, and/or values corresponding to attributes involved in the instantiation of the event τ (e.g., the location where it happened, how long it took, who participated, etc.). The ERP may then utilize the sample to predict an affective response corresponding to the event, which represents the value m of a measurement of affective response of the user u to having the experience e (had such a measurement been taken).

Bias functions may be utilized, in some embodiments, to learn bias values corresponding to individual factors and/or combinations of factors. For example, once an ERP that implements a bias function is trained, it can be used to make various predictions that may teach the bias values a user likely has.

In one embodiment, the bias value corresponding to a certain factor is determined utilizing an ERP. Let ƒ′ denote the weight of the certain factor. In this embodiment, the ERP is utilized to compute the corresponding bias value b′. Computing b′ is done as follows. Given an event, two related samples are generated for the ERP. The first sample is a sample that contains all factors and their corresponding weights, which would typically be included in a sample corresponding to the event. The second sample is a sample identical to the first, except for the certain factor, whose values is set to zero (i.e., in the second sample ƒ′=0). After providing both samples to the ERP, the difference between the first sample (which includes the certain factor) and the second sample (which does not include the certain factor) represents the effect of the certain factor, from which an estimate of b′ may be derived. That is, the difference between the prediction of emotional response to the first sample and the prediction of emotional response to the second sample is the term ƒ′·b′. By dividing the difference by the weight of ƒ′, an estimate of the value of b′ may be obtained.

### 24—Additional Considerations

FIG. 35 is a schematic illustration of a computer 400 that is able to realize one or more of the embodiments discussed herein. The computer 400 may be implemented in various ways, such as, but not limited to, a server, a client, a personal computer, a set-top box (STB), a network device, a handheld device (e.g., a smartphone), computing devices embedded in wearable devices (e.g., a smartwatch or a computer embedded in clothing), computing devices implanted in the human body, and/or any other computer form capable of executing a set of computer instructions. Further, references to a computer include any collection of one or more computers that individually or jointly execute one or more sets of computer instructions to perform any one or more of the disclosed embodiments.

The computer 400 includes one or more of the following components: processor 401, memory 402, computer readable medium 403, user interface 404, communication interface 405, and bus 406. In one example, the processor 401 may include one or more of the following components: a general-purpose processing device, a microprocessor, a central processing unit, a complex instruction set computing (CISC) microprocessor, a reduced instruction set computing (RISC) microprocessor, a very long instruction word (VLIW) microprocessor, a special-purpose processing device, an application specific integrated circuit (ASIC), a field programmable gate array (FPGA), a digital signal processor (DSP), a distributed processing entity, and/or a network processor. Continuing the example, the memory 402 may include one or more of the following memory components: CPU cache, main memory, read-only memory (ROM), dynamic random access memory (DRAM) such as synchronous DRAM (SDRAM), flash memory, static random access memory (SRAM), and/or a data storage device. The processor 401 and the one or more memory components may communicate with each other via a bus, such as bus 406.

Still continuing the example, the communication interface 405 may include one or more components for connecting to one or more of the following: LAN, Ethernet, intranet, the Internet, a fiber communication network, a wired communication network, and/or a wireless communication network. Optionally, the communication interface 405 is used to connect with the network 112. Additionally or alternatively, the communication interface 405 may be used to connect to other networks and/or other communication interfaces. Still continuing the example, the user interface 404 may include one or more of the following components: (i) an image generation device, such as a video display, an augmented reality system, a virtual reality system, and/or a mixed reality system, (ii) an audio generation device, such as one or more speakers, (iii) an input device, such as a keyboard, a mouse, a gesture-based input device that may be active or passive, and/or a brain-computer interface.

Functionality of various embodiments may be implemented in hardware, software, firmware, or any combination thereof. If implemented at least in part in software, implementing the functionality may involve a computer program that includes one or more instructions or code stored or transmitted on a computer-readable medium and executed by one or more processors. Computer-readable media may include computer-readable storage media, which corresponds to a tangible medium such as data storage media, or communication media including any medium that facilitates transfer of a computer program from one place to another. Computer-readable medium may be any media that can be accessed by one or more computers to retrieve instructions, code and/or data structures for implementation of the described embodiments. A computer program product may include a computer-readable medium.

In one example, the computer-readable medium 403 may include one or more of the following: RAM, ROM, EEPROM, optical storage, magnetic storage, biologic storage, flash memory, or any other medium that can store computer readable data. Additionally, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of a medium. It should be understood, however, that computer-readable medium does not include connections, carrier waves, signals, or other transient media, but are instead directed to non-transient, tangible storage media.

A computer program (also known as a program, software, software application, script, program code, or code) can be written in any form of programming language, including compiled or interpreted languages, declarative or procedural languages. The program can be deployed in any form, including as a standalone program or as a module, component, subroutine, object, or another unit suitable for use in a computing environment. A computer program may correspond to a file in a file system, may be stored in a portion of a file that holds other programs or data, and/or may be stored in one or more files that may be dedicated to the program. A computer program may be deployed to be executed on one or more computers that are located at one or more sites that may be interconnected by a communication network.

Computer-readable medium may include a single medium and/or multiple media (e.g., a centralized or distributed database, and/or associated caches and servers) that store the one or more sets of instructions. In various embodiments, a computer program, and/or portions of a computer program, may be stored on a non-transitory computer-readable medium. The non-transitory computer-readable medium may be implemented, for example, via one or more of a volatile computer memory, a non-volatile memory, a hard drive, a flash drive, a magnetic data storage, an optical data storage, and/or any other type of tangible computer memory to be invented that is not transitory signals per se. The computer program may be updated on the non-transitory computer-readable medium and/or downloaded to the non-transitory computer-readable medium via a communication network such as the Internet. Optionally, the computer program may be downloaded from a central repository such as Apple App Store and/or Google Play. Optionally, the computer program may be downloaded from a repository such as an open source and/or community run repository (e.g., GitHub).

At least some of the methods described in this disclosure, which may also be referred to as “computer-implemented methods”, are implemented on a computer, such as the computer 400. When implementing a method from among the at least some of the methods, at least some of the steps belonging to the method are performed by the processor 401 by executing instructions. Additionally, at least some of the instructions for running methods described in this disclosure and/or for implementing systems described in this disclosure may be stored on a non-transitory computer-readable medium.

Some of the embodiments described herein include a number of modules. Modules may also be referred to herein as “components” or “functional units”. Additionally, modules and/or components may be referred to as being “computer executed” and/or “computer implemented”; this is indicative of the modules being implemented within the context of a computer system that typically includes a processor and memory. Generally, a module is a component of a system that performs certain operations towards the implementation of a certain functionality. Examples of functionalities include receiving measurements (e.g., by a collector module), computing a score for an experience (e.g., by a scoring module), and various other functionalities described in embodiments in this disclosure. Though the name of many of the modules described herein includes the word “module” in the name (e.g., the scoring module 150), this is not the case with all modules; some names of modules described herein do not include the word “module” in their name (e.g., the profile comparator 133).

The following is a general comment about the use of reference numerals in this disclosure. It is to be noted that in this disclosure, as a general practice, the same reference numeral is used in different embodiments for a module when the module performs the same functionality (e.g., when given essentially the same type/format of data). Thus, as typically used herein, the same reference numeral may be used for a module that processes data even though the data may be collected in different ways and/or represent different things in different embodiments. For example, the reference numeral 150 is used to denote the scoring module in various embodiments described herein. The functionality may be the essentially the same in each of the different embodiments—the scoring module 150 computes a score from measurements of multiple users; however, in each embodiment, the measurements used to compute the score may be different. For example, in one embodiment, the measurements may be of users who had an experience (in general), and in another embodiment, the measurements may be of users who had a more specific experience (e.g., users who were at a hotel or users who had an experience during a certain period of time). In all the examples above, the different types of measurements may be provided to the same module (possibly referred to by the same reference numeral) in order to produce a similar type of value (i.e., a score, a ranking, function parameters, a recommendation, etc.).

It is to be further noted that though the use of the convention described above that involves using the same reference numeral for modules is a general practice in this disclosure, it is not necessarily implemented with respect to all embodiments described herein. Modules referred to by a different reference numeral may perform the same (or similar) functionality, and the fact they are referred to in this disclosure by a different reference numeral does not mean that they might not have the same functionality.

Executing modules included in embodiments described in this disclosure typically involves hardware. For example, a module may comprise dedicated circuitry or logic that is permanently configured (e.g., as a special-purpose processor, such as a field programmable gate array (FPGA) or an application-specific integrated circuit (ASIC) to perform certain operations. Additionally or alternatively, a module may comprise programmable logic or circuitry (e.g., as encompassed within a general-purpose processor or another programmable processor) that is temporarily configured by software to perform certain operations. For example, a computer system such as the computer system illustrated in FIG. 35 may be used to implement one or more modules. In some instances, a module may be implemented using both dedicated circuitry and programmable circuitry. For example, a collection module may be implemented using dedicated circuitry that preprocesses signals obtained with a sensor (e.g., circuitry belonging to a device of the user) and in addition the collection module may be implemented with a general-purpose processor that organizes and coalesces data received from multiple users.

It will be appreciated that the decision to implement a module in dedicated permanently configured circuitry and/or in temporarily configured circuitry (e.g., configured by software) may be driven by various considerations such as considerations of cost, time, and ease of manufacturing and/or distribution. In any case, the term “module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which modules are temporarily configured (e.g., programmed), not every module has to be configured or instantiated at every point in time. For example, a general-purpose processor may be configured to run different modules at different times.

In some embodiments, a processor implements a module by executing instructions that implement at least some of the functionality of the module. Optionally, a memory may store the instructions (e.g., as computer code), which are read and processed by the processor, causing the processor to perform at least some operations involved in implementing the functionality of the module. Additionally or alternatively, the memory may store data (e.g., measurements of affective response), which is read and processed by the processor in order to implement at least some of the functionality of the module. The memory may include one or more hardware elements that can store information that is accessible to a processor. In some cases, at least some of the memory may be considered part of the processor or on the same chip as the processor, while in other cases, the memory may be considered a separate physical element than the processor. Referring to FIG. 35 for example, one or more processors 401, may execute instructions stored in memory 402 (that may include one or more memory devices), which perform operations involved in implementing the functionality of a certain module.

The one or more processors may also operate to support performance of the relevant operations in a “cloud computing” environment or as a “software as a service” (SaaS). For example, at least some of the operations involved in implementing a module, may be performed by a group of computers accessible via a network (e.g., the Internet) and/or via one or more appropriate interfaces (e.g., application program interfaces (APIs)). Optionally, some of the modules may be executed in a distributed manner among multiple processors. The one or more processors may be located in a single geographic location (e.g., within a home environment, an office environment, or a server farm), and/or distributed across a number of geographic locations. Optionally, some modules may involve execution of instructions on devices that belong to the users and/or are adjacent to the users. For example, procedures that involve data preprocessing and/or presentation of results may run, in part or in full, on processors belonging to devices of the users (e.g., smartphones and/or wearable computers). In this example, preprocessed data may further be uploaded to cloud-based servers for additional processing. Additionally, preprocessing and/or presentation of results for a user may be performed by a software agent that operates on behalf of the user.

In some embodiments, modules may provide information to other modules, and/or receive information from other modules. Accordingly, such modules may be regarded as being communicatively coupled. Where multiple of such modules exist contemporaneously, communications may be achieved through signal transmission (e.g., over appropriate circuits and buses). In embodiments in which modules are configured or instantiated at different times, communications between such modules may be achieved, for example, through the storage and retrieval of information in memory structures to which the multiple modules have access. For example, one module may perform an operation and store the output of that operation in a memory device to which it is communicatively coupled. A different module may then, at a later time, access the memory device to retrieve and process the stored output.

It is to be noted that in the claims, when a dependent system claim is formulated according to a structure similar to the following: “further comprising module X configured to do Y”, it is to be interpreted as: “the memory is also configured to store module X, the processor is also configured to execute module X, and module X is configured to do Y”.

Modules and other system elements (e.g., databases or models) are typically illustrated in figures in this disclosure as geometric shapes (e.g., rectangles) that may be connected via lines. A line between two shapes typically indicates a relationship between the two elements the shapes represent, such as a communication that involves an exchange of information and/or control signals between the two elements. This does not imply that in every embodiment there is such a relationship between the two elements, rather, it serves to illustrate that in some embodiments such a relationship may exist. Similarly, a directional connection (e.g., an arrow) between two shapes may indicate that, in some embodiments, the relationship between the two elements represented by the shapes is directional, according the direction of the arrow (e.g., one element provides the other with information). However, the use of an arrow does not indicate that the exchange of information between the elements cannot be in the reverse direction too.

The illustrations in this disclosure depict some, but not necessarily all, the connections between modules and/or other system element. Thus, for example, a lack of a line connecting between two elements does not necessarily imply that there is no relationship between the two elements, e.g., involving some form of communication between the two. Additionally, the depiction in an illustration of modules as separate entities is done to emphasize different functionalities of the modules. In some embodiments, modules that are illustrated and/or described as separate entities may in fact be implemented via the same software program, and in other embodiments, a module that is illustrates and/or described as being a single element may in fact be implemented via multiple programs and/or involve multiple hardware elements possibly in different locations.

As used herein, any reference to “one embodiment” or “an embodiment” means that a particular element, feature, structure, or characteristic described in connection with the embodiment is included in at least one embodiment. Moreover, separate references to “one embodiment” or “some embodiments” in this description do not necessarily refer to the same embodiment. Additionally, references to “one embodiment” and “another embodiment” may not necessarily refer to different embodiments, but may be terms used, at times, to illustrate different aspects of an embodiment. Similarly, references to “some embodiments” and “other embodiments” may refer, at times, to the same embodiments.

Herein, a predetermined value, such as a threshold, a predetermined rank, or a predetermined level, is a fixed value and/or a value determined any time before performing a calculation that compares a certain value with the predetermined value. Optionally, a first value may be considered a predetermined value when the logic (e.g., circuitry, computer code, and/or algorithm), used to compare a second value to the first value, is known before the computations used to perform the comparison are started.

Some embodiments may be described using the expression “coupled” and/or “connected”, along with their derivatives. For example, some embodiments may be described using the term “coupled” to indicate that two or more elements are in direct physical or electrical contact. The term “coupled,” however, may also mean that two or more elements are not in direct contact with each other, but yet still cooperate or interact with each other. The embodiments are not limited in this context.

Some embodiments may be described using the verb “indicating”, the adjective “indicative”, and/or using variations thereof. For example, a value may be described as being “indicative” of something. When a value is indicative of something, this means that the value directly describes the something and/or is likely to be interpreted as meaning that something (e.g., by a person and/or software that processes the value). Verbs of the form “indicating” or “indicate” may have an active and/or passive meaning, depending on the context. For example, when a module indicates something, that meaning may correspond to providing information by directly stating the something and/or providing information that is likely to be interpreted (e.g., by a human or software) to mean the something. In another example, a value may be referred to as indicating something (e.g., a determination indicates that a risk reaches a threshold), in this case, the verb “indicate” has a passive meaning; examination of the value would lead to the conclusion to which it indicates (e.g., analyzing the determination would lead one to the conclusion that the risk reaches the threshold).

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

In addition, use of the “a” or “an” is employed to describe one or more elements/components/steps/modules/things of the embodiments herein. This description should be read to include one or at least one, and the singular also includes the plural unless it is obvious that it is meant otherwise. Additionally, the phrase “based on” is intended to mean “based, at least in part, on”. For example, stating that a score is computed “based on measurements” means that the computation may use, in addition to the measurements, additional data that are not measurements, such as models, billing statements, and/or demographic information of users.

Though this disclosure in divided into sections having various titles, this partitioning is done just for the purpose of assisting the reader and is not meant to be limiting in any way. In particular, embodiments described in this disclosure may include elements, features, components, steps, and/or modules that may appear in various sections of this disclosure that have different titles. Furthermore, section numbering and/or location in the disclosure of subject matter are not to be interpreted as indicating order and/or importance. For example, a method may include steps described in sections having various numbers. These numbers and/or the relative location of the section in the disclosure are not to be interpreted in any way as indicating an order according to which the steps are to be performed when executing the method.

With respect to computer systems described herein, various possibilities may exist regarding how to describe systems implementing a similar functionality as a collection of modules. For example, what is described as a single module in one embodiment may be described in another embodiment utilizing more than one module. Such a decision on separation of a system into modules and/or on the nature of an interaction between modules may be guided by various considerations. One consideration, which may be relevant to some embodiments, involves how to clearly and logically partition a system into several components, each performing a certain functionality. Thus, for example, hardware and/or software elements that are related to a certain functionality may belong to a single module. Another consideration that may be relevant for some embodiments, involves grouping hardware elements and/or software elements that are utilized in a certain location together. For example, elements that operate at the user end may belong to a single module, while other elements that operate on a server side may belong to a different module. Still another consideration, which may be relevant to some embodiments, involves grouping together hardware and/or software elements that operate together at a certain time and/or stage in the lifecycle of data. For example, elements that operate on measurements of affective response may belong to a first module, elements that operate on a product of the measurements may belong to a second module, while elements that are involved in presenting a result based on the product, may belong to a third module.

It is to be noted that essentially the same embodiments may be described in different ways. In one example, a first description of a computer system may include descriptions of modules used to implement it. A second description of essentially the same computer system may include a description of operations that a processor is configured to execute (which implement the functionality of the modules belonging to the first description). The operations recited in the second description may be viewed, in some cases, as corresponding to steps of a method that performs the functionality of the computer system. In another example, a first description of a computer-readable medium may include a description of computer code, which when executed on a processor performs operations corresponding to certain steps of a method. A second description of essentially the same computer-readable medium may include a description of modules that are to be implemented by a computer system having a processor that executes code stored on the computer-implemented medium. The modules described in the second description may be viewed, in some cases, as producing the same functionality as executing the operations corresponding to the certain steps of the method.

While the methods disclosed herein may be described and shown with reference to particular steps performed in a particular order, it is understood that these steps may be combined, sub-divided, and/or reordered to form an equivalent method without departing from the teachings of the embodiments. Accordingly, unless specifically indicated herein, the order and grouping of the steps is not a limitation of the embodiments. Furthermore, methods and mechanisms of the embodiments will sometimes be described in singular form for clarity. However, some embodiments may include multiple iterations of a method or multiple instantiations of a mechanism unless noted otherwise. For example, when a processor is disclosed in one embodiment, the scope of the embodiment is intended to also cover the use of multiple processors. Certain features of the embodiments, which may have been, for clarity, described in the context of separate embodiments, may also be provided in various combinations in a single embodiment. Conversely, various features of the embodiments, which may have been, for brevity, described in the context of a single embodiment, may also be provided separately or in any suitable sub-combination.

Some embodiments described herein may be practiced with various computer system configurations, such as cloud computing, a client-server model, grid computing, peer-to-peer, hand-held devices, multiprocessor systems, microprocessor-based systems, programmable consumer electronics, minicomputers, and/or mainframe computers. Additionally or alternatively, some of the embodiments may be practiced in a distributed computing environment where tasks are performed by remote processing devices that are linked through a communication network. In a distributed computing environment, program components may be located in both local and remote computing and/or storage devices. Additionally or alternatively, some of the embodiments may be practiced in the form of a service, such as infrastructure as a service (IaaS), platform as a service (PaaS), software as a service (SaaS), and/or network as a service (NaaS).

Embodiments described in conjunction with specific examples are presented by way of example, and not limitation. Moreover, it is evident that many alternatives, modifications, and variations will be apparent to those skilled in the art. It is to be understood that other embodiments may be utilized and structural changes may be made without departing from the scope of the appended claims and their equivalents.

We claim:

1. A system for operating a software agent to correct a bias in a measurement of affective response of a user, comprising:
a sensor, coupled to the user, configured to take the measurement of affective response of the user;
wherein the measurement corresponds to an event in which the user has an experience corresponding to the event; and
a computer configured to:
generate a description of the event; wherein the description comprises factors characterizing the event which correspond to at least one of the following: the user corresponding to the event, the experience corresponding to the event, and an instantiation of the event;
identify, based on the description, whether a certain factor characterizes the event; and
compute a corrected measurement by modifying value of the measurement based on at least some values in a model that was trained on data comprising: measurements of affective response of the user corresponding to events involving the user having various experiences, and descriptions of the events; wherein value of the corrected measurement is different from the value of the measurement.

2. The system of claim 1, wherein the experience involves doing at least one of the following: spending time at a certain location, consuming certain digital content, having a social interaction with a certain entity in the physical world, having a social interaction with a certain entity in a virtual world, viewing a certain live performance, performing a certain exercise, traveling a certain route, and consuming a certain product.

3. The system of claim 1, wherein the computer is further configured to receive an indication of the certain factor and to forward the corrected measurement, to be utilized, along with measurements of other users, to compute a score for the experience.

4. The system of claim 1, wherein the model of the user comprises bias values of the user computed based on the data; wherein the computer is further configured to receive: (i) an indication of the certain factor; and (ii) a bias value, from the model, corresponding to the certain factor; and wherein the computer is further configured to compute the corrected measurement by subtracting the bias value from the measurement of affective response; wherein the bias value is indicative of a magnitude of an expected impact of the certain factor on a value of a measurement corresponding to the event.

5. The system of claim 1, wherein the model of the user is a model for an Emotional Response Predictor (ERP) trained on the data; and wherein the computer is further configured to:
receive factors characterizing the event, and generate first and second sets of feature values; wherein the first set of feature values is determined based on the factors, and the second set of feature values is determined based on a modified version of the factors, in which the weight of the certain factor is reduced;
utilize the model to make first and second predictions for first and a second samples comprising the first and second sets of features values, respectively; wherein each of the first and second predictions comprises an affective value representing expected affective response of the user; and
compute the corrected measurement by subtracting from the measurement a value proportional to a difference between the second prediction and the first prediction.

6. The system of claim 1, wherein the computer is further configured to:
determine whether the description of the event indicates that the instantiation of the event involves the user having the experience corresponding to the event in an environment characterized by a certain environmental condition, and responsive to the description indicating thereof, to compute a corrected measurement by modifying the value of the received measurement, with respect to bias of the user towards the certain environmental condition; wherein the value of the corrected measurement is different from the value of the received measurement, and computing the corrected measurement is done utilizing a model trained on data comprising: measurements of affective response corresponding to events involving having experiences in environments characterized by different environmental conditions.

7. The system of claim 6, wherein the environmental condition corresponds to a certain season of year during which the user has the experience.

8. The system of claim 6, wherein the environmental condition involves a certain parameter describing the environment being in a certain range of values; and wherein the certain parameter is one of the following: temperature in the environment, humidity level in the environment, extent of precipitation in the environment, air quality in the environment, concentration of an allergen in the environment, noise level in the environment, and level of natural sun light in the environment.

9. The system of claim 1, wherein the event involves the user consuming content, and the description is indicative of the content comprising an element, and the model was trained on data comprising: measurements of affective response corresponding to events involving consumption of content that comprises the element, and measurements of affective response corresponding to events involving consumption of content that does not comprise the element; and wherein the computer is further configured to compute the corrected measurement by modifying the value of the received measurement with respect to a bias of the user towards the element.

10. The system of claim 9, wherein the content comprises at least one of: (i) digital content comprising images presented via one or more of the following displays: a display for video images, an augmented reality display, a mixed reality display, and a virtual reality display, (ii) auditory content comprising one or more of the following: speech, music, and digital sound effects.

11. The system of claim 9, wherein the element relates to a genre of the content; and wherein the genre involves depiction of at least one of the following: violence, sexual acts, profanity, and sports activity.

12. The system of claim 9, wherein the element represents one of the following: a certain character, a character of a certain type; wherein characters of a certain type are characterized as possessing at least one of the following characteristics in common: the same gender, the same ethnicity, the same age group, the same physical trait, the same type of being.

13. A method for operating a software agent to correct a bias in a measurement of affective response of a user, comprising:
receiving the measurement of affective response of the user; wherein the measurement corresponds to an event in which the user has an experience corresponding to the event;
generating a description of the event; wherein the description comprises factors characterizing the event which correspond to at least one of the following: the user corresponding to the event, the experience corresponding to the event, and an instantiation of the event;
identifying, based on the description, whether a certain factor characterizes the event; and
computing a corrected measurement by modifying value of the measurement based on at least some values in a model that was trained on data comprising: measurements of affective response of the user corresponding to events involving the user having various experiences, and descriptions of the events; wherein value of the corrected measurement is different from the value of the measurement.

14. The method of claim 13, wherein the model of the user comprises bias values of the user computed based on the data; further comprising:
receiving: (i) an indication of the certain factor; and (ii) a bias value, from the model, corresponding to the certain factor; and
computing the corrected measurement by subtracting the bias value from the measurement of affective response;
wherein the bias value is indicative of a magnitude of an expected impact of the certain factor on a value of a measurement corresponding to the event.

15. The method of claim 13, wherein the model of the user is a model for an Emotional Response Predictor (ERP) trained on the data; and further comprising:
receiving factors characterizing the event, and generating first and second sets of feature values; wherein the first set of feature values is determined based on the factors, and the second set of feature values is determined based on a modified version of the factors, in which the weight of the certain factor is reduced;
utilizing the model to make first and second predictions for first and a second samples comprising the first and second sets of features values, respectively; wherein each of the first and second predictions comprises an affective value representing expected affective response of the user; and
computing the corrected measurement by subtracting from the measurement a value proportional to a difference between the second prediction and the first prediction.

16. The method of claim 13, further comprising:
determining whether the description of the event indicates that the instantiation of the event involves the user having the experience corresponding to the event in an environment characterized by a certain environmental condition, and responsive to the description indicating thereof, computing a corrected measurement by modifying the value of the received measurement, with respect to bias of the user towards the certain environmental condition; wherein the value of the corrected measurement is different from the value of the received measurement, and computing the corrected measurement is done utilizing a model trained on data comprising: measurements of affective response corresponding to events involving having experiences in environments characterized by different environmental conditions.

17. The method of claim 13, wherein the event involves the user consuming content, and the description is indicative of the content comprising an element, and the model was trained on data comprising: measurements of affective response corresponding to events involving consumption of content that comprises the element, and measurements of affective response corresponding to events involving consumption of content that does not comprise the element; and further comprising: computing the corrected measurement by modifying the value of the received measurement with respect to a bias of the user towards the element.

18. A non-transitory computer-readable medium having instructions stored thereon that, in response to execution by a system including a processor and memory, causes the system to perform operations comprising:
receiving measurement of affective response of a user; wherein the measurement corresponds to an event in which the user has an experience corresponding to the event;
generating a description of the event; wherein the description comprises factors characterizing the event which correspond to at least one of the following: the user corresponding to the event, the experience corresponding to the event, and an instantiation of the event;
identifying, based on the description, whether a certain factor characterizes the event; and
computing a corrected measurement by modifying value of the measurement based on at least some values in a model that was trained on data comprising: measurements of affective response of the user corresponding to events involving the user having various experiences, and descriptions of the events; wherein value of the corrected measurement is different from the value of the measurement.

19. The non-transitory computer-readable medium of claim 18, further comprising instructions stored to perform the following steps:
receiving: (i) an indication of the certain factor; and (ii) a bias value, from the model, corresponding to the certain factor; and
computing the corrected measurement by subtracting the bias value from the measurement of affective response;
wherein the bias value is indicative of a magnitude of an expected impact of the certain factor on a value of a measurement corresponding to the event.

20. The non-transitory computer-readable medium of claim 18, wherein the model of the user is a model for an Emotional Response Predictor (ERP) trained on the data, and further comprising instructions stored to perform the following steps:
receiving factors characterizing the event, and generating first and second sets of feature values; wherein the first set of feature values is determined based on the factors, and the second set of feature values is determined based on a modified version of the factors, in which the weight of the certain factor is reduced;
utilizing the model to make first and second predictions for first and a second samples comprising the first and second sets of features values, respectively; wherein each of the first and second predictions comprises an affective value representing expected affective response of the user; and
computing the corrected measurement by subtracting from the measurement a value proportional to a difference between the second prediction and the first prediction.
